(19) United States
(12) Patent Application Publication
(10) Pub. No.: US 2026/0239339 A1
(43) Pub. Date: Aug. 13, 2026

(54) TERMINAL APPARATUS AND BASE STATION APPARATUS

(71) Applicant: SHARP KABUSHIKI KAISHA, Sakai City, Osaka (JP)

(72) Inventors: Takahisa FUKUI, Sakai City, Osaka (JP); KAZUNARI YOKOMAKURA, Sakai City, Osaka (JP); Ryota MORIMOTO, Sakai City, Osaka (JP)

(21) Appl. No.: 19/471,082

(22) PCT Filed: Apr. 4, 2024
(86) PCT No.: PCT/JP2024/013977

§ 371 Date: Sep. 30, 2025

(30) Foreign Application Priority Data
Apr. 5, 2023 (JP) 2023-061288

(51) Int. Cl. H04W 72/1268; H04W 72/232

(52) U.S. Cl. CPC H04W 72/1268; H04W 72/232

(57) ABSTRACT

A receiver configured to receive a first PDCCH to which first DCI is mapped, a second PDCCH to which second DCI is mapped, and a PDSCH scheduled by the first DCI, and a transmitter configured to transmit an uplink channel scheduled by the second DCI are included. First beam information is indicated by a TCI field in the first DCI. The first beam information is applied for the uplink channel. The first PDCCH and the second PDCCH are associated with a first CORESET pool index. A first uplink timing for the uplink channel is determined by a first TAG ID. The first TAG ID is determined based on the TCI field. A codepoint of the TCI field corresponds to the first TAG ID.

### TECHNICAL FIELD

The present invention relates to a terminal apparatus and a base station apparatus.

This application claims priority to JP 2023-061288 filed on Apr. 5, 2023, the contents of which are incorporated herein by reference.

### BACKGROUND ART

In the 3^{rd} Generation Partnership Project (3GPP), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is to satisfy requirements for three scenarios including enhanced Mobile BroadBand (eMBB), massive Machine Type Communication (mMTC), and Ultra Reliable and Low Latency Communication (URLLC) in a single technology framework.

In the 3GPP, extension of services supported by NR has been studied (NPL 2 and NPL 3).

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7th to 10th March, 2016.

NPL 2: “Release 17 package for RAN”, RP-193216, RAN chairman, RAN1 chairman, RAN2 chairman, RAN3 chairman, 3GPP TSG RAN Meeting #86, Sitges, Spain, 9th to 12th December, 2019

NPL 3: “Release 18 package summary”, RP-213469, RAN chairman, RAN1 chairman, RAN2 chairman, RAN3 chairman, 3GPP TSG RAN Meeting #94-e, 6th to 17th December, 2021

### SUMMARY OF INVENTION

### Technical Problem

An aspect of the present invention provides a terminal apparatus that efficiently performs communication, a communication method used in the terminal apparatus, a base station apparatus that efficiently performs communication, and a communication method used in the base station apparatus.

### Solution to Problem

(1) A first aspect of the present invention is a terminal apparatus. The terminal apparatus includes a receiver configured to receive a first PDCCH to which first DCI is mapped, a second PDCCH to which second DCI is mapped, and a PDSCH scheduled by the first DCI, and a transmitter configured to transmit an uplink channel scheduled by the second DCI. First beam information is indicated by a TCI field in the first DCI. The first beam information is applied for the uplink channel. The first PDCCH and the second PDCCH are associated with a first CORESET pool index. A first uplink timing for the uplink channel is determined by a first TAG ID. The first TAG ID is determined based on the TCI field. A codepoint of the TCI field corresponds to the first TAG ID.

(2) A second aspect of the present invention is a base station apparatus. The base station apparatus includes a transmitter configured to transmit a first PDCCH to which first DCI is mapped, a second PDCCH to which second DCI is mapped, and a PDSCH scheduled by the first DCI, and a receiver configured to receive an uplink channel scheduled by the second DCI. First beam information is indicated by a TCI field in the first DCI. The first beam information is applied for the uplink channel. The first PDCCH and the second PDCCH are associated with a first CORESET pool index. A first uplink timing for the uplink channel is determined by a first TAG ID. The first TAG ID is determined based on the TCI field. A codepoint of the TCI field corresponds to the first TAG ID.

### Advantageous Effects of Invention

According to an aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between a subcarrier spacing configuration μ, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of an activation command A according to an aspect of the present embodiment.

FIG. 10 is a diagram illustrating an example of an activation command B according to an aspect of the present embodiment.

FIG. 11 is a diagram illustrating an example of an activation command C according to an aspect of the present embodiment.

FIG. 12 is a diagram illustrating an example of an activation command D according to an aspect of the present embodiment.

FIG. 13 is a diagram illustrating an example of an activation command E according to an aspect of the present embodiment.

FIG. 14 is a diagram illustrating an example of management of a TCI state according to an aspect of the present embodiment.

FIG. 15 is a diagram illustrating an example of a timeline management for a TCI state according to an aspect of the present embodiment.

FIG. 16 is a diagram illustrating an example of uplink channel transmission according to an aspect of the present embodiment.

### DESCRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In downlink, at least Cyclic Prefix-Orthogonal Frequency Division Multiplexing (CP-OFDM) is used. In uplink, either CP-OFDM or Discrete Fourier Transform-spread-Orthogonal Frequency Division Multiplex (DFT-s-OFDM) is used. DFT-s-OFDM may be given by applying Transform precoding to the CP-OFDM.

The OFDM symbol may be a term including a CP added to the OFDM symbol. That is, a certain OFDM symbol may include the certain OFDM symbol and the CP added to the certain OFDM symbol.

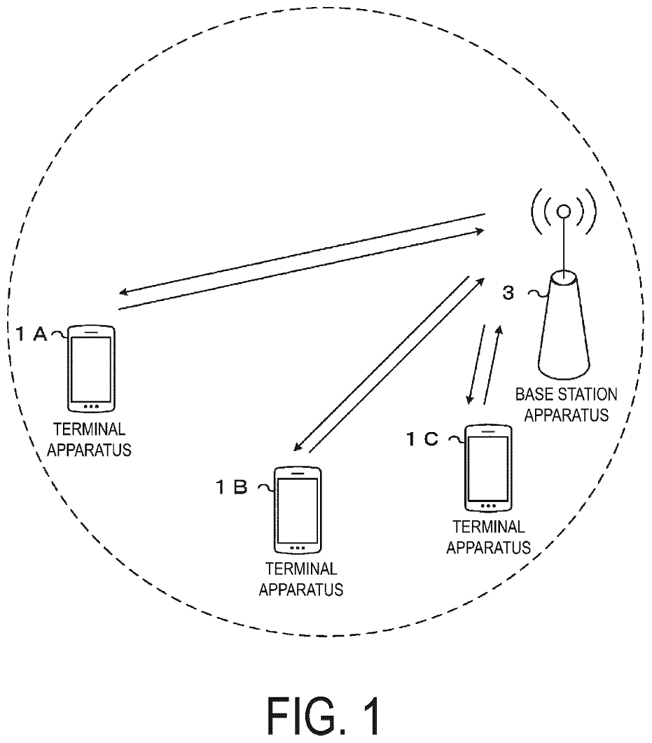

FIG. 1 is a conceptual diagram of a radio communication system according to an aspect of the present embodiment. In FIG. 1, the radio communication system includes at least terminal apparatuses 1A to 1C and a base station apparatus 3 (Base station #3 (BS #3)). Hereinafter, the terminal apparatuses 1A to 1C are also referred to as a terminal apparatus 1 (User Equipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions.

The base station apparatus 3 may provide one or multiple serving cells. Each serving cell may be defined as a set of resources used for radio communication. In addition, the serving cell is also referred to as a cell.

The serving cell may include one or both of one downlink component carrier (downlink carrier) and one uplink component carrier (uplink carrier). The serving cell may include either or both of two or more downlink component carriers, and/or two or more uplink component carriers. The downlink component carrier and the uplink component carrier are also collectively referred to as a component carrier (carrier).

For example, for each component carrier, one resource grid may be given. In addition, for each set of one component carrier and a certain subcarrier spacing configuration μ, one resource grid may be given. Here, the subcarrier spacing configuration μ is also referred to as numerology. For example, for a set of a certain antenna port p, a certain subcarrier spacing configuration μ, and a certain transmission direction x, one resource grid may be given.

The resource grid includes N^{size,μ}_{grid,x}N^{RB}_{sc} subcarriers. Here, the resource grid starts from a common resource block N^{start,μ}_{grid,x}. In addition, the common resource block N^{start,μ}_{grid,x} is also referred to as a reference point of the resource grid.

The resource grid includes N^{subframe,μ}_{symb} OFDM symbols.

The subscript x added to the parameter associated with the resource grid indicates the transmission direction. For example, the subscript x may be used to indicate either of downlink or uplink.

N^{size,μ}_{grid,x} is an offset configuration indicated by a parameter provided by the RRC layer (e.g., parameter CarrierBandwidth). N^{start,μ}_{grid,x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration μ may be Δf satisfying Δf=2^{μ}·15 kHz. Here, the subcarrier spacing configuration μ may indicate one of 0, 1, 2, 3, or 4.

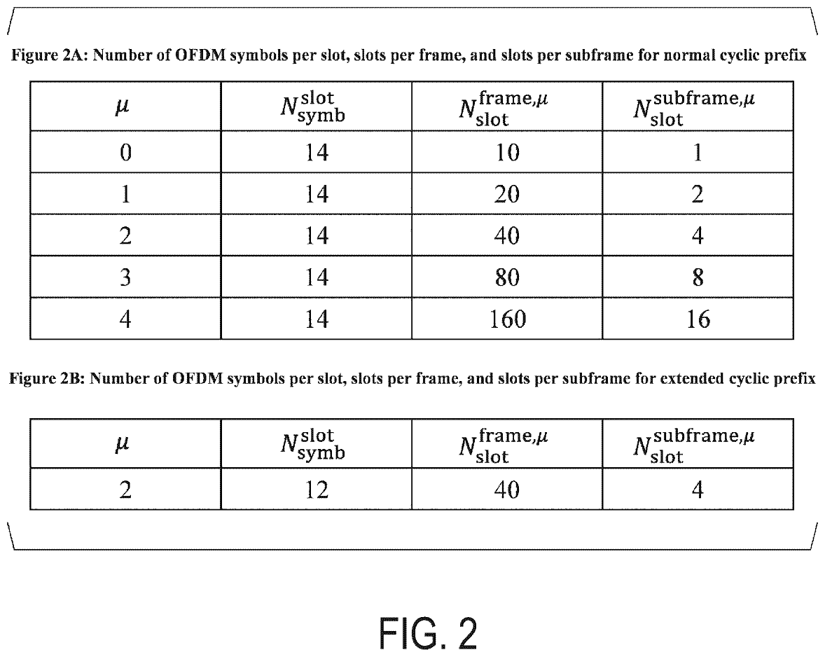

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment. In FIG. 2A, for example, in a case that the subcarrier spacing configuration μ is 2 and the CP configuration is a normal cyclic prefix (normal CP), N^{slot}_{symb}=14, N^{frame,μ}ₛₗₒₜ=40, and N^{subframe,μ}ₛₗₒₜ=4. In addition, in FIG. 2B, for example, in a case that the subcarrier spacing configuration μ is 2 and the CP configuration is an extended cyclic prefix (extended CP), N^{slot}_{symb}=12, N^{frame,μ}ₛₗₒₜ=40, and N^{subframe,μ}ₛₗₒₜ=4.

The time unit To may be used to represent the length of the time domain. The time unit T_{c} is T_{c}=1/(Δfₘₐₓ·N_{f}). Δfₘₐₓ=480 kHz. N_{f}=4096. A constant κ is κ=Δfₘₐₓ·N_{f}/(Δf_{ref}N_{f,ref})=64. Δf_{ref} is 15 kHz. N_{f,ref} is 2048.

Transmission of a signal in the downlink and/or transmission of a signal in the uplink may be organized into a radio frame (system frame, frame) having the length T_{f}. T_{f}=(ΔfₘₐₓN_{f}/100). Tₛ=10 ms. The radio frame includes 10 subframes. The length T_{sf} of the subframe is (ΔfₘₐₓN_{f}/1000)·Tₛ=1 ms. The number of OFDM symbols per subframe is N^{subframe,μ}_{symb}=N^{slot}_{symb}N^{subframe,μ}ₛₗₒₜ.

The OFDM symbol is a time domain unit of one communication scheme. For example, the OFDM symbol may be a time domain unit of CP-OFDM. In addition, the OFDM symbol may be a time domain unit of DFT-s-OFDM.

The slot may include multiple OFDM symbols. For example, N^{slot}_{symb} continuous OFDM symbols may constitute one slot. For example, in a normal CP configuration, N^{slot}_{symb} may be 14. In addition, in an extended CP configuration, N^{slot}_{symb} may be 12.

For a certain subcarrier spacing configuration μ, the number and index of a slot included in the subframe may be given. For example, slot indices n^{μ}ₛ may be given in ascending order in the subframe with integer values within a range of 0 to N^{subframe,μ}ₛₗₒₜ-1. For the subcarrier spacing configuration μ, the number and index of a slot included in the radio frame may be given. In addition, slot indices n^{μ}_{s,f} may be given in ascending order in the radio frame with integer values within a range of 0 to N^{frame,μ}ₛₗₒₜ-1.

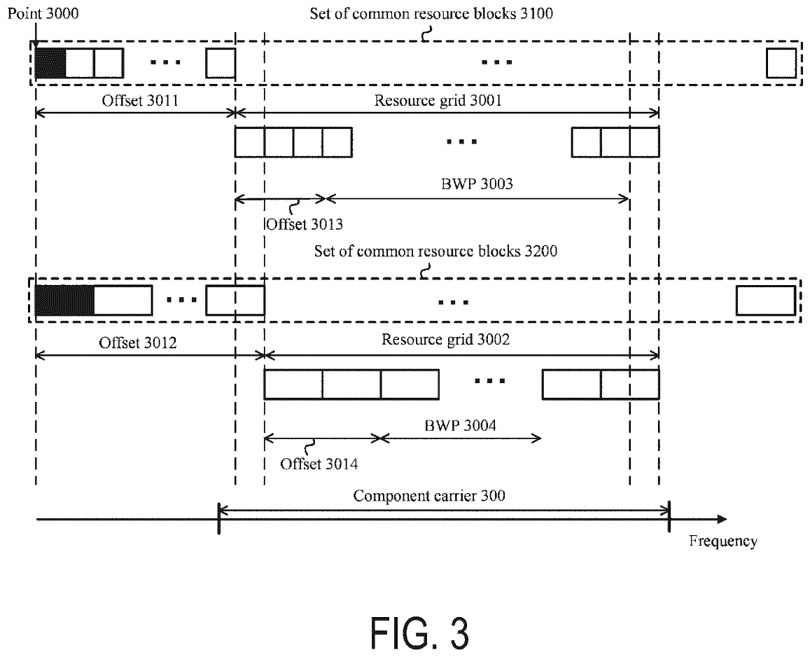

FIG. 3 is a diagram illustrating an example of a configuration method of a resource grid according to an aspect of the present embodiment. The horizontal axis of FIG. 3 represents a frequency domain. FIG. 3 illustrates a configuration example of a resource grid of a subcarrier spacing μ₁ in a component carrier 300, and a configuration example of a resource grid of a subcarrier spacing μ₂ in the certain component carrier. As described above, for a certain component carrier, one or multiple subcarrier spacings may be configured. In FIG. 3, it is assumed that μ₁=μ₂-1, but various aspects of the present embodiment are not limited to the condition of μ₁=μ₂-1.

The component carrier 300 is a band having a predetermined width in the frequency domain.

A point 3000 is an identifier for identifying a certain subcarrier. The point 3000 is also referred to as a point A. A common resource block (CRB) set 3100 is a set of common resource blocks for the configuration of the subcarrier spacing μ₁.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index 0 in the common resource block set 3100.

An offset 3011 is an offset from the reference point of the common resource block set 3100 to a reference point of a resource grid 3001. The offset 3011 is represented by the number of common resource blocks for the configuration of the subcarrier spacing μ₁. The resource grid 3001 includes N^{size,μ}_{grid1,x} common resource blocks starting from the reference point of the resource grid 3001.

An offset 3013 is an offset from the reference point of the resource grid 3001 to a reference point (N^{start,μ}_{BWP,il}) of a bandwidth part (BWP) 3003 having an index il.

A common resource block set 3200 is a set of common resource blocks for the configuration of the subcarrier spacing μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size,μ}_{grid2,x} common resource blocks starting from the reference point of the resource grid 3002.

An offset 3014 is an offset from the reference point of the resource grid 3002 to a reference point (N^{start,μ}_{BWP,i2}) of a BWP 3004 having an index i2.

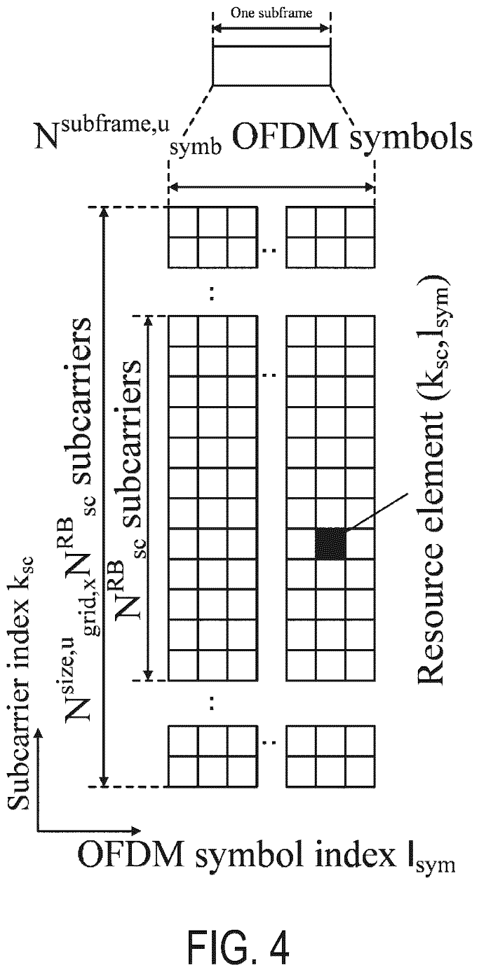

FIG. 4 is a diagram illustrating a configuration example of the resource grid 3001 according to an aspect of the present embodiment. In the resource grid of FIG. 4, the horizontal axis corresponds to an OFDM symbol index I_{sym}, and the vertical axis corresponds to a subcarrier index k_{sc}. The resource grid 3001 includes N^{size,μ}_{grid1,x}N^{RB}_{sc} subcarriers, and N^{subframe,μ}_{symb} OFDM symbols. In the resource grid, a resource identified by the subcarrier index k_{sc} and the OFDM symbol index I_{sym} is also referred to as a resource element (RE).

The resource block (RB) includes N^{RB}_{sc} continuous subcarriers. The resource block is a general term for a common resource block, a physical resource block (PRB), and a virtual resource block (VRB). Here, N^{RB}_{sc} is 12.

A resource block unit is a set of resources corresponding to one OFDM symbol in one resource block. That is, one resource block unit includes 12 resource elements corresponding to one OFDM symbol in one resource block.

The common resource blocks for the configuration of a certain subcarrier spacing μ are assigned indices (indexing) in ascending order from 0 in the frequency domain in a certain common resource block set. The common resource block having the index 0 for the configuration of a certain subcarrier spacing μ includes (collides with or matches) the point 3000. An index n^{μ}_{CRB} of the common resource block for the configuration of the certain subcarrier spacing μ satisfies the relationship of n^{μ}_{CRB}=ceil(k_{sc}/N^{RB}_{sc}). Here, a subcarrier with K_{sc}=0 is a subcarrier having the same center frequency as the center frequency of a subcarrier corresponding to the point 3000.

Physical resource blocks for the configuration of the certain subcarrier spacing μ are assigned indices in ascending order from 0 in the frequency domain in a certain BWP. An index n^{μ}_{PRB} of the physical resource block for the configuration of the certain subcarrier spacing cμ satisfies the relationship of n^{μ}_{CRB}=n^{μ}_{PRB}+N^{start,μ}_{BWP,i}. Here, N^{start,μ}_{BWP,i} indicates a reference point of the BWP having an index i.

The BWP is defined as a subset of common resource blocks included in the resource grid. The BWP includes N^{size,μ}_{BWP,i} common resource blocks starting from the reference point N^{start,μ}_{BWP,i} of the BWP. A BWP configured for a downlink carrier is also referred to as a downlink BWP. A BWP configured for an uplink component carrier is also referred to as an uplink BWP.

An antenna port may be defined such that the channel over which a symbol on the antenna port is conveyed can be inferred from the channel over which another symbol on the same antenna port is conveyed. For example, the channel may correspond to a physical channel. In addition, the symbol may correspond to an OFDM symbol. In addition, the symbol may correspond to a resource block unit. In addition, the symbol may correspond to a resource element.

The fact that a large scale property of a channel over which a symbol on one antenna port is conveyed can be inferred from a channel over which a symbol on another antenna port is conveyed is referred to as the two antenna ports being quasi co-located (QCL). Here, the large scale property may include at least long term property of a channel. The large scale property may include at least a part or all of delay spread, Doppler spread, Doppler shift, an average gain, an average delay, and a beam parameter (spatial Rx parameters). The fact that the first antenna port and the second antenna port are QCLed with respect to a beam parameter may mean that a reception beam assumed by a reception side for the first antenna port and a reception beam assumed by the reception unit side for the second antenna port are the same (or the reception beams correspond to each other). The fact that the first antenna port and the second antenna port are QCLed with respect to a beam parameter may mean that a transmission beam assumed by a reception side for the first antenna port and a transmission beam assumed by the reception side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL. The large scale property may be referred to as a QCL parameter.

The QCL type may be any one of typeA, typeB, typeC, and typeD.

The fact that two antenna ports are QCLed with typeA may mean that a first large scale property of a channel over which a symbol on one antenna port is conveyed can be inferred from a channel over which a symbol on another antenna port is conveyed. The fact that two antenna ports are QCLed with typeB may mean that a second large scale property of a channel over which a symbol on one antenna port is conveyed can be inferred from a channel over which a symbol on another antenna port is conveyed. The fact that two antenna ports are QCLed with typeC may mean that a third large scale property of a channel over which a symbol on one antenna port is conveyed can be inferred from a channel over which a symbol on another antenna port is conveyed. The fact that two antenna ports are QCLed with typeD may mean that a fourth large scale property of a channel over which a symbol on one antenna port is conveyed can be inferred from a channel over which a symbol on another antenna port is conveyed. The first large scale property may include all of a Doppler shift, a Doppler spread, an average delay, and a delay spread. The second large scale property may include all of a Doppler shift and a Doppler spread. The third large scale property may include all of a Doppler shift and an average delay. The fourth large scale property may include spatial reception parameters (information of a spatial direction, information of a beam). An antenna port of a DMRS may be a DMRS port. For example, an antenna port of a PTRS may be a PTRS antenna port. An antenna port associated with a PTRS may be a PTRS port. An antenna port for an SRS may be an SRS port. An antenna port for a DMRS may be a DMRS port. An antenna port associated with a DMRS may be a DMRS port.

Carrier aggregation may mean that communication is performed by using multiple serving cells being aggregated. In addition, carrier aggregation may mean that communication is performed by using multiple component carriers being aggregated. In addition, carrier aggregation may mean that communication is performed by using multiple downlink component carriers being aggregated. In addition, carrier aggregation may mean that communication is performed by using multiple uplink component carriers being aggregated.

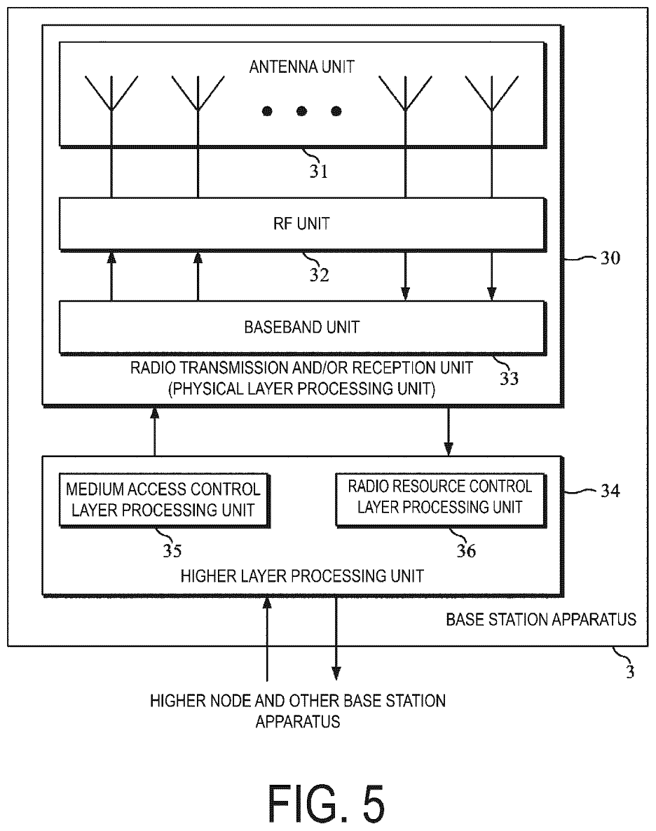

FIG. 5 is a schematic block diagram illustrating a configuration example of the base station apparatus 3 according to an aspect of the present embodiment. As illustrated in FIG. 5, the base station apparatus 3 includes at least a part or all of a radio transmission and/or reception unit (physical layer processing unit) 30 and/or a higher layer processing unit 34. The radio transmission and/or reception unit 30 includes at least a part or all of an antenna unit 31, a radio frequency (RF) unit 32, and a baseband unit 33. The higher layer processing unit 34 includes at least a part or all of a medium access control layer processing unit 35 and a radio resource control (RRC) layer processing unit 36.

The radio transmission and/or reception unit 30 includes at least a part or all of a radio transmission unit 30a and a radio reception unit 30b. Here, apparatus configurations of the baseband unit included in the radio transmission unit 30a and the baseband unit included in the radio reception unit 30b may be the same or different from each other. In addition, apparatus configurations of the RF unit included in the radio transmission unit 30a and the RF unit included in the radio reception unit 30b may be the same or different from each other. In addition, apparatus configurations of the antenna unit included in the radio transmission unit 30a and the antenna unit included in the radio reception unit 30b may be the same or different from each other.

For example, the radio transmission unit 30a may generate and transmit a baseband signal of a PDSCH. For example, the radio transmission unit 30a may generate and transmit a baseband signal of a PDCCH. For example, the radio transmission unit 30a may generate and transmit a baseband signal of a PBCH. For example, the radio transmission unit 30a may generate and transmit a baseband signal of a synchronization signal. For example, the radio transmission unit 30a may generate and transmit a baseband signal of a PDSCH DMRS. For example, the radio transmission unit 30a may generate and transmit a baseband signal of a PDCCH DMRS. For example, the radio transmission unit 30a may generate and transmit a baseband signal of a CSI-RS. For example, the radio transmission unit 30a may generate and transmit a baseband signal of a DL PTRS.

For example, the radio reception unit 30b may receive a PRACH. For example, the radio reception unit 30b may receive and demodulate a PUCCH. The radio reception unit 30b may receive and demodulate a PUSCH. For example, the radio reception unit 30b may receive a PUCCH DMRS. For example, the radio reception unit 30b may receive a PUSCH DMRS. For example, the radio reception unit 30b may receive a UL PTRS. For example, the radio reception unit 30b may receive an SRS.

The higher layer processing unit 34 outputs downlink data (a transport block) to the radio transmission and/or reception unit 30 (or the radio transmission unit 30a). The higher layer processing unit 34 performs processing operations of a Medium Access Control (MAC) layer, a Packet Data Convergence Protocol (PDCP) layer, a Radio Link Control (RLC) layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 sets the parameter based on an RRC message received from the terminal apparatus 1.

The radio transmission and/or reception unit 30 (or the radio transmission unit 30a) performs processing such as modulation and encoding. The radio transmission and/or reception unit 30 (or the radio transmission unit 30a) generates a physical signal through modulation, encoding, and baseband signal generation (conversion into the time-continuous signal) on downlink data, and transmits the physical signal to the terminal apparatus 1. The radio transmission and/or reception unit 30 (or the radio transmission unit 30a) may map the physical signal to a certain component carrier and transmit the physical signal to the terminal apparatus 1.

The radio transmission and/or reception unit 30 (or the radio reception unit 30b) performs processing such as demodulation and decoding. The radio transmission and/or reception unit 30 (or the radio reception unit 30b) separates, demodulates, and decodes the received physical signal, and outputs the decoded information to the higher layer processing unit 34. The radio transmission and/or reception unit 30 (or the radio reception unit 30b) may perform a channel access procedure prior to transmission of the physical signal.

The RF unit 32 converts (down-converts) a signal received via the antenna unit 31 into a baseband signal by means of orthogonal demodulation and removes unnecessary frequency components. The RF unit 32 outputs a processed analog signal to the baseband unit.

The baseband unit 33 converts an analog signal input from the RF unit 32 into a digital signal. The baseband unit 33 removes a portion corresponding to a cyclic prefix (CP) from the converted digital signal, performs a Fast Fourier Transform (FFT) on the signal from which the CP has been removed, and extracts a signal in the frequency domain.

The baseband unit 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33 by using a low-pass filter, upconverts the analog signal into a signal having a carrier frequency, and transmits the signal via the antenna unit 31. In addition, the RF unit 32 may have a function of controlling transmission power. The RF unit 32 is also referred to as a transmission power control unit.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. The active downlink BWP and the active uplink BWP are also collectively referred to as active BWPs.

The PDSCH, the PDCCH, and the CSI-RS need not be received in downlink BWPs (inactive downlink BWPs) other than the active downlink BWP. The terminal apparatus 1 need not attempt to receive the PDSCH, the PDCCH, and the CSI-RS in downlink BWPs that are not active downlink BWPs. The PUCCH and the PUSCH need not be transmitted in uplink BWPs (inactive uplink BWPs) that are not active uplink BWPs. The terminal apparatus 1 need not transmit the PUCCH and the PUSCH in uplink BWPs that are not active uplink BWPs. The inactive downlink BWPs and the inactive uplink BWPs are also collectively referred to as inactive BWPs.

Downlink BWP switch is a procedure for deactivating one active downlink BWP of a certain serving cell and activating any one of the inactive downlink BWPs of the certain serving cell. The downlink BWP switch may be controlled by a BWP field included in downlink control information. The downlink BWP switch may be controlled based on a higher layer parameter.

Uplink BWP switch is used for deactivating one active uplink BWP and activating any one of the inactive uplink BWPs that are not the one active uplink BWP. The uplink BWP switch may be controlled by a BWP field included in downlink control information. The uplink BWP switch may be controlled based on a higher layer parameter.

Among one or multiple downlink BWPs configured for the serving cell, two or more downlink BWPs need not be configured for an active downlink BWP. For the serving cell, at certain times, one downlink BWP may be active.

Among one or multiple uplink BWPs configured for the serving cell, two or more uplink BWPs need not be configured for an active uplink BWP. For the serving cell, at certain times, one uplink BWP may be active.

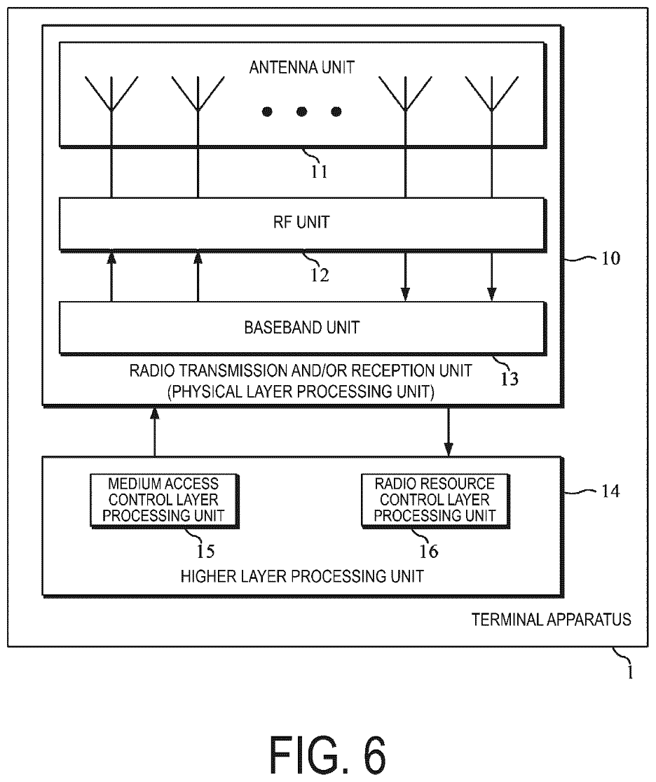

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception unit (physical layer processing unit) 10 and a higher layer processing unit 14. The radio transmission and/or reception unit 10 includes at least a part or all of an antenna unit 11, an RF unit 12, and a baseband unit 13. The higher layer processing unit 14 includes at least a part or all of a medium access control layer processing unit 15 and a radio resource control layer processing unit 16.

The radio transmission and/or reception unit 10 includes at least a part or all of a radio transmission unit 10a and a radio reception unit 10b. Here, apparatus configurations of the baseband unit 13 included in the radio transmission unit 10a and the baseband unit 13 included in the radio reception unit 10b may be the same or different from each other. In addition, apparatus configurations of the RF unit 12 included in the radio transmission unit 10a and the RF unit 12 included in the radio reception unit 10b may be the same or different from each other. In addition, apparatus configurations of the antenna unit 11 included in the radio transmission unit 10a and the antenna unit 11 included in the radio reception unit 10b may be the same or different from each other.

For example, the radio transmission unit 10a may generate and transmit a baseband signal of a PRACH. For example, the radio transmission unit 10a may generate and transmit a baseband signal of a PUCCH. The radio transmission unit 10a may generate and transmit a baseband signal of a PUSCH. For example, the radio transmission unit 10a may generate and transmit a baseband signal of a PUCCH DMRS. For example, the radio transmission unit 10a may generate and transmit a baseband signal of a PUSCH DMRS. For example, the radio transmission unit 10a may generate and transmit a baseband signal of a UL PTRS. For example, the radio transmission unit 10a may generate and transmit a baseband signal of an SRS.

For example, the radio reception unit 10b may receive and demodulate a PDSCH. For example, the radio reception unit 10b may receive and demodulate a PDCCH. For example, the radio reception unit 10b may receive and demodulate a PBCH. For example, the radio reception unit 10b may receive a synchronization signal. For example, the radio reception unit 10b may receive a PDSCH DMRS. For example, the radio reception unit 10b may receive a PDCCH DMRS. For example, the radio reception unit 10b may receive a CSI-RS. For example, the radio reception unit 10b may receive a DL PTRS.

The higher layer processing unit 14 outputs uplink data (a transport block) to the radio transmission and/or reception unit 10 (or the radio transmission unit 10a). The higher layer processing unit 14 performs processing operations of the MAC layer, a packet data convergence protocol layer, a radio link control layer, and the RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various pieces of configuration information/parameters (RRC parameters) of the terminal apparatus 1. The radio resource control layer processing unit 16 sets the RRC parameters based on an RRC message received from the base station apparatus 3.

The radio transmission and/or reception unit 10 (or the radio transmission unit 10a) performs processing such as modulation and encoding. The radio transmission and/or reception unit 10 (or the radio transmission unit 10a) generates a physical signal through modulation, encoding, and baseband signal generation (conversion into a time-continuous signal) on uplink data and transmits the physical signal to the base station apparatus 3. The radio transmission and/or reception unit 10 (or the radio transmission unit 10a) may map the physical signal to a certain BWP (an active uplink BWP) and transmit the physical signal to the base station apparatus 3.

The radio transmission and/or reception unit 10 (or the radio reception unit 10b) performs processing such as demodulation and decoding. The radio transmission and/or reception unit 10 (or the radio reception unit 30b) may receive a physical signal in a certain BWP (active downlink BWP) of a certain serving cell. The radio transmission and/or reception unit 10 (or the radio reception unit 10b) separates, demodulates, and decodes the received physical signal and outputs the decoded information to the higher layer processing unit 14. The radio transmission and/or reception unit 10 (radio reception unit 10b) may perform the channel access procedure prior to the transmission of the physical signal.

The RF unit 12 converts (down-converts) a signal received via the antenna unit 11 into a baseband signal by means of orthogonal demodulation and removes unnecessary frequency components. The RF unit 12 outputs a processed analog signal to the baseband unit 13.

The baseband unit 13 converts the analog signal input from the RF unit 12 into a digital signal. The baseband unit 13 removes a portion corresponding to a cyclic prefix (CP) from the converted digital signal, performs a Fast Fourier Transform (FFT) on the signal from which the CP has been removed, and extracts a signal of the frequency domain.

The baseband unit 13 performs an Inverse Fast Fourier Transform (IFFT) on the uplink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, upconverts the analog signal into a signal having a carrier frequency, and transmits the signal via the antenna unit 11. In addition, the RF unit 12 may have a function of controlling transmission power. The RF unit 12 is also referred to as a transmission power control unit.

A physical signal (signal) will be described below.

A physical signal is a general term for a downlink physical channel, a downlink physical signal, an uplink physical channel, and an uplink physical channel. A physical channel is a general term for a downlink physical channel and an uplink physical channel. A physical signal is a general term for a downlink physical signal and an uplink physical signal. The physical signal may be referred to as a reference signal.

An uplink physical channel may correspond to a set of resource elements for conveying information that is generated in a higher layer. An uplink physical channel may be a physical channel used in an uplink component carrier. An uplink physical channel may be transmitted by the terminal apparatus 1. The uplink physical channel may be received by the base station apparatus 3. In the radio communication system according to an aspect of the present embodiment, at least a part or all of the following uplink physical channels may be used:
Physical Uplink Control CHannel (PUCCH);
Physical Uplink Shared CHannel (PUSCH); and
Physical Random Access CHannel (PRACH).

The PUCCH may be used to transmit Uplink Control Information (UCI). The PUCCH may be transmitted for conveying (delivering or transmitting) uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, or uplink control information type) includes at least a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK corresponding to a transport block (TB). The HARQ-ACK may indicate an acknowledgement (ACK) or a negative-acknowledgement (NACK) corresponding to the transport block. The ACK may indicate that decoding of the transport block has been decoded successfully. The NACK may indicate that decoding of the transport block has not been decoded successfully. The HARQ-ACK information may include a HARQ-ACK codebook including one or multiple HARQ-ACK bits.

The transport block is a sequence of information bits delivered from a higher layer. Here, the sequence of information bits is also referred to as a bit sequence. Here, the transport block may be delivered through an UpLink-Shared CHannel (UL-SCH) of a Transport layer.

A HARQ-ACK for the transport block may be referred to as a HARQ-ACK for a PDSCH. In this case, the “HARQ-ACK for the PDSCH” indicates a HARQ-ACK for a transport block included in a PDSCH.

The HARQ-ACK may indicate an ACK or a NACK corresponding to one code block group (CBG) included in the transport block.

A scheduling request may be at least used for requesting a resource of the UL-SCH for new transmission. A scheduling request bit may be used for indicating either of a positive SR or a negative SR. The scheduling request bit indicating the positive SR is also referred to as a “positive SR being conveyed”. The positive SR may indicate that the terminal apparatus 1 requests resources of the UL-SCH for new transmission. The positive SR may indicate that a scheduling request is triggered by a higher layer. The positive SR may be conveyed in a case that the higher layer indicates the scheduling request. The scheduling request bit indicating the negative SR is also referred to as a “negative SR being transmitted”. The negative SR may indicate that the terminal apparatus 1 requests no resources of the UL-SCH for new transmission. The negative SR may indicate that the scheduling request is not triggered by a higher layer. The negative SR may be conveyed in a case that the higher layer indicates no scheduling request.

Channel state information may include at least a part or all of a Channel Quality Indicator (CQI), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) at least used for channel measurement. A value of the channel state information may be determined by the terminal apparatus 1 based on the reception state assumed by a physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH may be transmitted in a certain PUCCH format. Note that the PUCCH format may be interpreted as a form of information. In addition, the PUCCH format may be interpreted as a set of information set in a certain form of information.

The PUSCH may be used for conveying one or both of a transport block and uplink control information. The transport block may be mapped to the PUSCH. The transport block delivered on the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u,v}(n) is defined by x_{u,v}(n)=xᵤ(mod(n+Cᵥ, L_{RA})). Here, xᵤ is a Zadoff Chu (ZC) sequence. In addition, xᵤ may be defined by xᵤ=exp(-jπui(i+1)/L_{RA}). j is an imaginary unit. In addition, π is the ratio of the circumference of a circle to its diameter. In addition, Cᵥ corresponds to a cyclic shift of the PRACH sequence. In addition, L_{RA} corresponds to the length of the PRACH sequence. In addition, L_{RA} is 839, or 139. In addition, i is an integer in the range from 0 to L_{RA}-1. In addition, u is a sequence index for the PRACH sequence.

For each PRACH occasion, 64 random access preambles are defined. The random access preambles are identified based on the cyclic shift Cy of the PRACH sequence and the sequence index u for the PRACH sequence. Each of the 64 identified random access preambles may be assigned an index.

Uplink physical signals may correspond to a set of resource elements. The uplink physical signals need not be used to convey information generated in a higher layer. Note that the uplink physical signals may be used to convey information generated in the physical layer.

The uplink physical signals may be physical signals used in an uplink component carrier. The terminal apparatus 1 may transmit the uplink physical signals. The base station apparatus 3 may receive the uplink physical signals. In the radio communication system according to an aspect of the present embodiment, at least a part or all of the following uplink physical signals may be used:
UpLink Demodulation Reference Signal (UL DMRS);
Sounding Reference Signal (SRS); and
UpLink Phase Tracking Reference Signal (UL PTRS).

A UL DMRS is a general term for a DMRS for a PUSCH and a DMRS for a PUCCH.

A set of antenna ports of the DMRS for the PUSCH (the DMRS related to the PUSCH, the DMRS included in the PUSCH, or the DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) in one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (a DMRS related to the PUCCH, a DMRS included in the PUCCH, or a DMRS corresponding to the PUCCH) may be the same as a set of antenna ports of the PUCCH.

Transmission of the PUCCH and transmission of the DMRS for the PUCCH may be indicated (or may be triggered) in one DCI format. One or both of resource element mapping of the PUCCH and resource element mapping of the DMRS for the PUCCH may be given in one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

A downlink physical channel may correspond to a set of resource elements for conveying information generated in a higher layer. A downlink physical channel may be a physical channel used in a downlink component carrier. The base station apparatus 3 may transmit a downlink physical channel. The terminal apparatus 1 may receive a downlink physical channel. In the radio communication system according to an aspect of the present embodiment, at least a part or all of the following downlink physical channels may be used:
Physical Broadcast Channel (PBCH);
Physical Downlink Control Channel (PDCCH); and
Physical Downlink Shared Channel (PDSCH).

The PBCH may be transmitted for conveying one or both of a Master Information Block (MIB) and physical layer control information. Here, the physical layer control information is information generated in the physical layer. The MIB is a set of parameters mapped to a Broadcast Control CHannel (BCCH) that is a logical channel of the MAC layer. The BCCH is mapped to a BCH that is a channel of a transport layer. The BCH may be mapped to the PBCH. The terminal apparatus 1 may receive the PBCH to which one or both of the MIB and the physical layer control information are mapped. The base station apparatus 3 may transmit the PBCH to which one or both of the MIB and/or the physical layer control information are mapped.

For example, the physical layer control information may include 8 bits. The physical layer control information may include at least a part or all of the following 0A to 0D.
0A) Radio frame bits
0B) Half radio frame (half system frame or half frame) bits
0C) SS/PBCH block index bits
0D) Subcarrier offset bits

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. In addition, the half radio frame may include the first five subframes out of the 10 subframes included in the radio frame. In addition, the half radio frame may include the last five subframes out of the 10 subframes included in the radio frame.

An SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks of the index 0 to index 63.

A subcarrier offset bit is used for indicating a subcarrier offset. The subcarrier offset may be used for indicating a difference between the leading subcarrier to which the PBCH is mapped and the leading subcarrier to which the control resource set having the index 0 is mapped.

The PDCCH may be transmitted for conveying Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted in a DCI format. Note that the DCI format may also be interpreted as the format of downlink control information. In addition, the DCI format may be interpreted as a set of downlink control information set to the format of certain downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least a part or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

An identifier field for DCI formats may indicate whether the DCI format including the identifier field for DCI formats is an uplink DCI format or a downlink DCI format. In other words, an identifier field for DCI formats may be included in each of the uplink DCI format and the downlink DCI format. Here, the identifier field for DCI formats included in the DCI format 0_0 may indicate 0.

A frequency domain resource assignment field included in the DCI format 0_0 may be used for indicating assignment of frequency resources for the PUSCH.

A time domain resource assignment field included in the DCI format 0_0 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target encoding rate. The target encoding rate may be a target encoding rate for the transport block mapped to the PUSCH. A transport block size (TBS) mapped to the PUSCH may be determined based on one or both of the target encoding rate and the modulation scheme for the PUSCH.

The Dci format 0_0 need not include a field used for a CSI request.

The DCI format 0_0 need not include a carrier indicator field. In other words, the serving cell to which the uplink component carrier to which the PUSCH scheduled in the DCI format 0_0 is mapped belongs may be the same as the serving cell of the uplink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled in the DCI format 0_0 is mapped to the uplink component carrier of the certain serving cell.

The DCI format 0-0 need not include a BWP field (BWP indicator field). Here, the DCI format 0_0 may be a DCI format for scheduling the PUSCH without changing an active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH mapped to a certain cell. The DCI format 0_1 includes at least a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 0_1 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating a part or all of a modulation scheme for the PUSCH and/or a target encoding rate.

The BWP field of the DCI format 0_1 may be used for indicating an uplink BWP to which the PUSCH scheduled in the DCI format 0_1 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may disregard the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

The CSI request field is used for indicating a report of CSI.

In a case that a carrier indicator field is included in the DCI format 0_1, the carrier indicator field may be used for indicating the uplink component carrier to which the PUSCH is mapped. In a case that a carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (a case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (a case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field may not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a part or all of 3A to 3F:
3A) Identifier field for DCI formats;
3B) Frequency domain resource assignment field; 3C) Time domain resource assignment field;
3D) MCS field;
3E) PDSCH_HARQ feedback timing indicator field (PDSCH to HARQ feedback timing indicator field); and
3F) PUCCH resource indicator field.

The identifier field for DCI formats included in the DCI format 1_0 may indicate 1.

The frequency domain resource assignment field included in the DCI format 1_0 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target encoding rate. The target encoding rate may be a target encoding rate for a transport block mapped to the PDSCH. The size of a transport block (Transport Block Size or TBS) mapped to the PDSCH may be determined based on one or both of the target encoding rate and the modulation scheme for the PDSCH.

The PDSCH HARQ feedback timing indicator field may be used for indicating an offset from the slot including the last OFDM symbol of the PDSCH to the slot including the first OFDM symbol of the PUCCH.

The PUCCH resource indicator field may be a field indicating an index of any of one or multiple PUCCH resources included in a PUCCH resource set. The PUCCH resource set may include one or multiple PUCCH resources.

The DCI format 1_0 may not include the carrier indicator field. In other words, the downlink component carrier to which the PDSCH scheduled by using the DCI format 1_0 is mapped may be the same as the downlink component carrier to which the PDCCH including the DCI format 1_0 is mapped. Based on detection of the DCI format 1_0 on a certain downlink component carrier, the terminal apparatus 1 may recognize that the PDSCH scheduled in the DCI format 1_0 is mapped to the downlink component carrier.

The DCI format 1_0 may not include a BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in scheduling of the PDSCH.

The DCI format 1_1 is at least used for scheduling of the PDSCH mapped to a certain cell. The DCI format 1_1 includes at least some or all of 4A to 4I:
4A) Identifier field for DCI formats;
4B) Frequency domain resource assignment field;
4C) Time domain resource assignment field;
4E) MCS field;
4F) PDSCH_HARQ feedback timing indicator field;
4G) PUCCH resource indicator field;
4H) BWP field; and
4I) Carrier indicator field.

The identifier field for DCI formats included in the DCI format 1_1 may indicate 1.

The frequency domain resource assignment field included in the DCI format 1_1 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target encoding rate.

In a case that the PDSCH_HARQ feedback timing indicator field is included in the DCI format 1_1, the PDSCH_HARQ feedback timing indicator field may be at least used for indicating an offset from the slot including the last OFDM symbol of the PDSCH to the slot including the first OFDM symbol of the PUCCH. In a case that the PDSCH HARQ feedback timing indicator field is not included in the DCI format 1_1, an offset from the slot including the last OFDM symbol of the PDSCH to the slot including the first OFDM symbol of the PUCCH may be identified by a higher layer parameter.

The PUCCH resource indicator field may be a field indicating an index of any of one or multiple PUCCH resources included in a PUCCH resource set.

The BWP field of the DCI format 1_1 may be used to indicate the downlink BWP to which the PDSCH scheduled in the DCI format 1_1 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and the DCI format 1_1 not including the BWP field.

In a case that the DCI format 1-1 includes the BWP field but the terminal apparatus 1 does not support the function of switching the BWP according to the DCI format 1_1, the terminal apparatus 1 may disregard the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and the DCI format 1_1 including the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (a case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (a case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field may not be included in the DCI format 1_1 used for scheduling of the PDSCH mapped to the certain serving cell group).

The PDSCH may be transmitted for conveying a transport block. The PDSCH may be used for transmitting a transport block delivered on the DL-SCH. The PDSCH may be used for conveying a transport block. A transport block may be mapped to the PDSCH. The transport block corresponding to the DL-SCH may be mapped to the PDSCH. The base station apparatus 3 may transmit the PDSCH. The terminal apparatus 1 may receive the PDSCH.

A downlink physical signal may correspond to a set of resource elements. The downlink physical signal may not carry information generated in a higher layer. The downlink physical signal may be a physical signal used in a downlink component carrier. The downlink physical signal may be transmitted by the base station apparatus 3. The downlink physical signal may be transmitted by the terminal apparatus 1. In the radio communication system according to an aspect of the present embodiment, at least some or all of the following downlink physical signals may be used:
Synchronization signal (SS);
DownLink DeModulation Reference Signal (DL DMRS);
Channel State Information-Reference Signal (CSI-RS); and
DownLink Phase Tracking Reference Signal (DL PTRS).

The synchronization signal may be used for the terminal apparatus 1 to take synchronization in one or both of the frequency domain and the time domain in downlink. The synchronization signal is a general term for a primary synchronization signal (PSS) and a secondary synchronization signal (SSS).

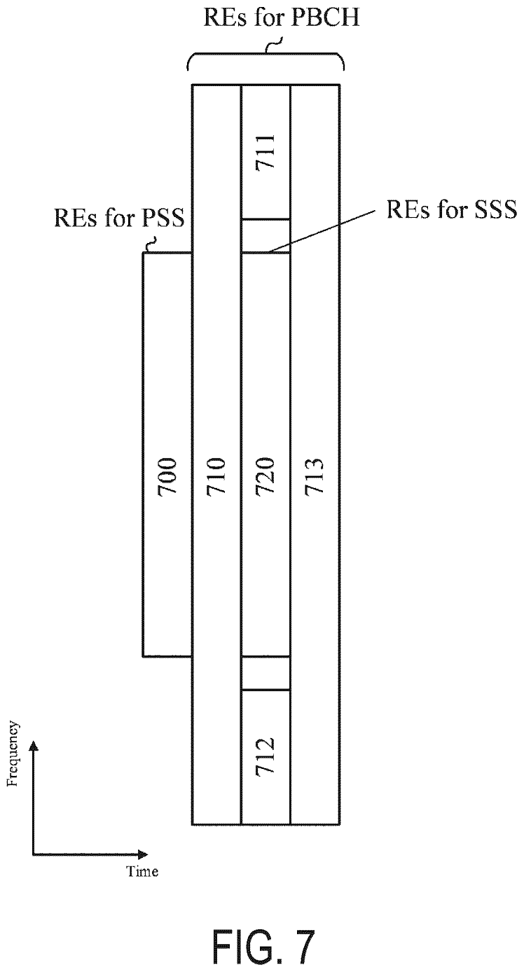

FIG. 7 is a diagram illustrating a configuration example of the SS/PBCH block according to an aspect of the present embodiment. In FIG. 7, the horizontal axis corresponds to a time axis (OFDM symbol index 1sym), and the vertical axis represents the frequency domain. In addition, a block 700 represents a set of resource elements for a PSS. In addition, a block 720 represents a set of resource elements for an SSS. In addition, four blocks (blocks 710, 711, 712, and 713) represent a set of resource elements for a PBCH and a DMRS for the PBCH (DMRS related to the PBCH, DMRS included in the PBCH, or DMRS corresponding to the PBCH).

As illustrated in FIG. 7, the SS/PBCH block includes a PSS, an SSS, and a PBCH. In addition, the SS/PBCH block includes four continuous OFDM symbols. The SS/PBCH block includes 240 subcarriers. The PSS is mapped to the 57th to 183rd subcarriers in the first OFDM symbol. The SSS is mapped to the 57th to 183rd subcarriers in the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which a DMRS for the PBCH is not mapped. The PBCH is mapped to subcarriers which are the 1st to 48th subcarriers of the third OFDM symbol and to which a DMRS for the PBCH is not mapped. The PBCH is mapped to subcarriers which are the 193rd to 240th subcarriers of the third OFDM symbol and to which a DMRS for the PBCH is not mapped. The PBCH is mapped to subcarriers which are the 1st to 240th subcarriers of the fourth OFDM symbol and to which a DMRS for the PBCH is not mapped.

The antenna ports of the PSS, the SSS, the PBCH, and the DMRS for the PBCH may be the same.

The PBCH over which the symbol of the PBCH on a certain antenna port is conveyed may be inferred from the DMRS for the PBCH mapped to the slot to which the PBCH is mapped and the DMRS for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (a DMRS related to the PDSCH, a DMRS included in the PDSCH, or a DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) in one DCI format. The PDSCH and the DMRS for the PDSCH may be collectively referred to as a PDSCH. Transmission of the PDSCH may be transmission of the PDSCH and the DMRS for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (the DMRS related to the PDCCH, the DMRS included in the PDCCH, or the DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is applied (in a case that the same precoder is assumed to be applied, or in a case of assuming that the same precoder is applied) to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels. A transport channel defines the relationship between a physical layer channel and a MAC layer channel (also referred to as a logical channel).

A BCH of the transport layer is mapped to the PBCH of the physical layer. In other words, a transport block passing through the BCH of the transport layer is delivered to the PBCH of the physical layer. In addition, the UL-SCH of the transport layer is mapped to the PUSCH of the physical layer. In other words, the transport block passing through the UL-SCH of the transport layer is delivered to the PUSCH of the physical layer. In addition, the DL-SCH of the transport layer is mapped to the PDSCH of the physical layer. In other words, a transport block passing through the DL-SCH of the transport layer is delivered to the PDSCH of the physical layer.

One UL-SCH and one DL-SCH may be given to each serving cell. The BCH may be given to a PCell. The BCH may not be given to a PSCell and an SCell.

In the MAC layer, control over a Hybrid Automatic Repeat reQuest (HARQ) is performed for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting an MIB or system information. In addition, a Common Control CHannel (CCCH) may be used for transmitting a common RRC message in multiple terminal apparatuses 1. Here, the CCCH may be, for example, used for a terminal apparatus 1 that is not in a state of RRC connection. In addition, a Dedicated Control CHannel (DCCH) may be at least used for transmitting an RRC message dedicated to a terminal apparatus 1. Here, the DCCH may be, for example, used for the terminal apparatus 1 that is in a state of RRC connection.

A higher layer parameter common to multiple terminal apparatuses 1 is also referred to as a common higher layer parameter. Here, the common higher layer parameter may be defined as a parameter specific to a serving cell. Here, a parameter specific to a serving cell may be a parameter common to terminal apparatuses configured with the serving cell (for example, terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter can provide a dedicated RRC parameter to the terminal apparatus 1-A configured with the serving cell. In other words, the dedicated RRC parameter is a higher layer parameter capable of providing a unique configuration to each of the terminal apparatuses 1-A, 1-B, and 1-C.

The BCCH of the logical channel may be mapped to the BCH or the DL-SCH of the transport layer. For example, a transport block including information of an MIB is delivered to the BCH of the transport layer. In addition, a transport block including system information other than the MIB is delivered to the DL-SCH of the transport layer. In addition, the CCCH is mapped to the DL-SCH or the UL-SCH. In other words, a transport block mapped to the CCCH is delivered to the DL-SCH or the UL-SCH. In addition, the DCCH is mapped to the DL-SCH or the UL-SCH. In other words, a transport block mapped to the DCCH is delivered to the DL-SCH or the UL-SCH.

An RRC message includes one or multiple parameters managed in the RRC layer. Here, the parameters managed in the RRC layer are also referred to as RRC parameters. For example, the RRC message may include the MIB. In addition, the RRC message may include system information. In addition, the RRC message may include a message corresponding to the CCCH. In addition, the RRC message may include a message corresponding to the DCCH. An RRC message including a message corresponding to the DCCH is also referred to as an individual RRC message.

A higher layer parameter (parameter in higher layer) is an RRC parameter or a parameter included in a Medium Access Control Control Element (MAC CE). In other words, the higher layer parameter is a general term for the MIB, the system information, a message corresponding to the CCCH, a message corresponding to the DCCH, and a parameter included in a MAC CE. The parameter included in the MAC CE is transmitted by using a MAC Control Element (CE) command.

Procedures performed by the terminal apparatus 1 include at least some or all of the following 5A to 5C:
5A) Cell search;
5B) Random access; and
5C) Data communication

The cell search is a procedure used for the terminal apparatus 1 synchronizing with a certain cell related to the time domain and the frequency domain and detecting a physical cell identity (physical cell ID). In other words, by means of the cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (possible to, scheduled to, configured to, defined to, having a possibility to) transmit the SS/PBCH block.

A set of SS/PBCH block candidates in a certain half radio frame is also referred to as an SS burst set. The SS burst set is also referred to as a transmission window (transmissionwindow), an SS transmission window, or a Discovery Reference Signal transmission window (DRS transmission window). The SS burst set is a general term including at least a first SS burst set and a second SS burst set.

The base station apparatus 3 transmits SS/PBCH blocks with one or multiple indices with a prescribed period. The terminal apparatus 1 may detect at least one SS/PBCH block out of the SS/PBCH blocks with one or multiple indices and attempt decoding of the PBCH included in the SS/PBCH block.

The random access is a procedure including at least some or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of the SS/PBCH block candidate detected based on the cell search. Each of the PRACH occasions is defined based at least on resources in the time domain and the frequency domain.

The terminal apparatus 1 transmits one random access preamble selected out of the PRACH occasions corresponding to the indices of the SS/PBCH block candidates in which the SS/PBCH block is detected.

The message 2 is a procedure of attempting to detect a DCI format 1_0 with a Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on a cell search, and in resources indicated based on a configuration of a search space set. The message 2 is also referred to as a random access response.

The message 3 is a procedure of transmitting the PUSCH scheduled by using a random access response grant included in the DCI format 1_0 detected through the procedure of the message 2. Here, the random access response grant (random access responsegrant) is indicated by the MAC CE included in the PDSCH scheduled by using the DCI format 1_0.

The PUSCH scheduled based on the random access response grant is either a message 3PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure of attempting to detect the DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In the data communication, the terminal apparatus 1 attempts detection of the PDCCH (monitors the PDCCH or supervises the PDCCH) in a control resource set and resources identified based on a search space set.

The control resource set (CORESET) is a set of resources including a prescribed number of resource blocks and a prescribed number of OFDM symbols. In the frequency domain, the control resource set may include continuous resources (non-interleaved mapping) or may include distributed resources (interleaver mapping).

A set of resource blocks constituting the control resource set may be indicated by a higher layer parameter. The number of OFDM symbols constituting the control resource set may be indicated by a higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates of the PDCCH. The search space set may be a Common Search Space (CSS) set or may be a UE-specific Search Space (USS) set. The terminal apparatus 1 attempts detection of candidates of the PDCCH in some or all of a Type 0 PDCCH common search space set, a Type 0a PDCCH common search space set, a Type 1 PDCCH common search space set, a Type 2 PDCCH common search space set, a Type 3PDCCH common search space set, and/or a UE-specific PDCCH search space set (UE-specific search space set).

The Type 0 PDCCH common search space set may be used as a common search space set having the index 0. The Type 0 PDCCH common search space set may be a common search space set having the index 0.

A CSS set is a general term for the Type 0 PDCCH common search space set, the Type 0a PDCCH common search space set, the Type 1 PDCCH common search space set, the Type 2PDCCH common search space set, and the Type 3 PDCCH common search space set. A USS set is also referred to as a UE-specific PDCCH search space set.

A certain search space set is related to (included in or corresponds to) a certain control resource set. The index of the control resource set related to the search space set may be indicated by a higher layer parameter.

For a certain search space set, some or all of 6A to 6C may be indicated by at least a higher layer parameter:
6A) PDCCH monitoring periodicity
6B) PDCCH monitoring pattern within a slot
6C) PDCCH monitoring offset

The monitoring occasion of a certain search space set may correspond to the OFDM symbol to which the first OFDM symbol of a control resource set related to the certain search space set is mapped. The monitoring occasion of a certain search space set may correspond to a resource of a control resource set starting from the first OFDM symbol of the control resource set related to the certain search space set. The monitoring occasion of the search space set is given based at least on some or all of the monitoring periodicity of the PDCCH, the monitoring pattern of the PDCCH in a slot, and a monitoring offset of the PDCCH.

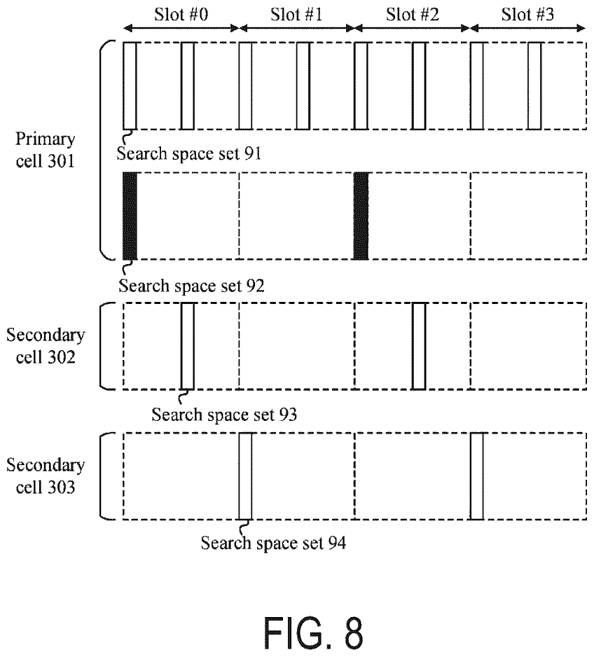

FIG. 8 is a diagram illustrating an example of the monitoring occasions for the search space sets according to an aspect of the present embodiment. In FIG. 8, search space set 91 and search space set 92 are configured in a primary cell 301, search space set 93 is configured in a secondary cell 302, and search space set 94 is configured in a secondary cell 303.

In FIG. 8, solid white blocks in the primary cell 301 represent the search space set 91, solid black blocks in the primary cell 301 represent the search space set 92, blocks in the secondary cell 302 represent the search space set 93, and blocks in the secondary cell 303 represent the search space set 94.

The monitoring periodicity of the search space set 91 is set to one slot, the monitoring offset of the search space set 91 is set to zero slots, and the monitoring pattern of the search space set 91 is set to [1, 0, 0, 0, 0, 0, 0, 1, 0, 0, 0, 0, 0, 0]. In other words, the monitoring occasions for the search space set 91 correspond to the first OFDM symbol (OFDM symbol #0) and the eighth OFDM symbol (OFDM symbol #7) in each of the slots.

The monitoring periodicity of the search space set 92 is set to two slots, the monitoring offset of the search space set 92 is set to zero slots, and the monitoring pattern of the search space set 92 is set to [1, 0, 0, 0, 0, 0, 0, 0, 0, 0, 0, 0, 0, 0]. In other words, the monitoring occasion for the search space set 92 corresponds to the first OFDM symbol (OFDM symbol #0) in each of the even-numbered slots.

The monitoring periodicity of the search space set 93 is set to two slots, the monitoring offset of the search space set 93 is set to zero slots, and the monitoring pattern of the search space set 93 is set to [0, 0, 0, 0, 0, 0, 0, 1, 0, 0, 0, 0, 0, 0]. In other words, the monitoring occasion for the search space set 93 corresponds to the eighth OFDM symbol (OFDM symbol #7) in each of the even-numbered slots.

The monitoring periodicity of the search space set 94 is set to two slots, the monitoring offset of the search space set 94 is set to one slot, and the monitoring pattern of the search space set 94 is set to [1, 0, 0, 0, 0, 0, 0, 0, 0, 0, 0, 0, 0, 0]. In other words, the monitoring occasion for the search space set 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type 0a PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by C-RNTI.

In downlink communication, the terminal apparatus 1 detects a downlink DCI format. The detected downlink DCI format is at least used for resource assignment of the PDSCH. The detected downlink DCI format is also referred to as downlink assignment. The terminal apparatus 1 attempts reception of the PDSCH. A HARQ-ACK corresponding to the PDSCH (HARQ-ACK corresponding to the transport block included in the PDSCH) is reported to the base station apparatus 3 based on PUCCH resources indicated based on the detected downlink DCI format.

In uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured scheduling (configured grant), the uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured scheduling.

The PUSCH transmission may correspond to a configured scheduling type 1 or a configured scheduling type 2. In other words, the configured scheduling may be any one of the configured scheduling type 1 or the configured scheduling type 2. A PUSCH transmission of the configured scheduling type 1 is semi-statically configured. For example, a PUSCH transmission of the configured scheduling type 1 may be operated in response to receiving a certain higher layer parameter. A certain higher layer parameter may be configuredGrantConfig. For example, configuredGrantConfig may include rrc-ConfiguredUplinkGrant. The PUSCH transmission may be operated without detecting an uplink grant in the DCI.

The PUSCH transmission of the configured scheduling type 2 may be semi-persistently scheduled. For example, the PUSCH transmission may be scheduled by a certain uplink grant.

The certain uplink grant may be included in activation DCI (or valid activation DCI). For example, after receiving a certain higher layer parameter, the PUSCH transmission of the configured scheduling type 2 may be scheduled by a certain uplink grant. A certain higher layer parameter may be configuredGrantConfig. For example, configuredGrantConfig need not include rrc-ConfiguredUplinkGrant.

A system frame number (SFN) n_{f} may be a number assigned to a radio frame and/or an index for a radio frame. The system frame number may include 10 bits. At least a part of the system frame number may be signaled in the MIB. For example, 6 bits (e.g., 6 most significant bits) of the 10-bit system frame number may be signaled in the MIB. At least a part of the system frame number may be determined based on the PBCH for conveying the MIB. For example, 4 bits (e.g., 4 least significant bits) of the 10-bit system frame number may be conveyed in a PBCH transport block as a part of channel coding.

PDCCH-Config may be a dedicated higher layer parameter. PDCCH-Config may configure a parameter for a PDCCH. Multiple (for example, up to three) CORESETs may be configured in PDCCH-Config. A CORESET ID may be configured in one CORESET. One CORESET pool index may be configured in one CORESET.

PDSCH-Config may be a dedicated higher layer parameter. PDSCH-Config may configure a parameter for a PDSCH.

In a case that multiple PDCCH candidates (PDCCH candidate(s)) are associated with a search space set configured by a higher layer parameter, one PDCCH candidate is used. The one PDCCH candidate may be one of two PDCCH candidates that starts earlier. The higher layer parameter may be a searchSpaceLinking.

At least two transmission schemes may be supported for the PUSCH. For example, codebook-based transmission may be one of the transmission schemes for the PUSCH. For example, non-codebook-based transmission may be one of the transmission schemes for the PUSCH. A higher layer parameter may provide one of codebook-based transmission and non-codebook-based transmission. For example, in a case that ‘codebook’ is set for the higher layer parameter, the terminal apparatus 1 may be configured with codebook-based transmission. For example, in a case that ‘nonCodebook’ is set for the higher layer parameter, the terminal apparatus 1 may be configured with non-codebook-based transmission. The higher layer parameter may be txConfig. The higher layer parameter may be usage. For example, in a case that the higher layer parameter is not configured, the terminal apparatus 1 may not expect scheduling to be performed in either of the DCI format 0_1 and the DCI format 0_2. In a case that the PUSCH is scheduled in the DCI format 0_0, transmission of the PUSCH may be performed based at least on one antenna port. In a case that the PUSCH is scheduled in the DCI format 0_0, a first TA may be used, and a second TA need not be used.

In codebook-based transmission, the PUSCH may be scheduled in a DCI format. The DCI format may be any one of the DCI format 0_0, the DCI format 0_1, and the DCI format 0_2. In codebook-based transmission, the PUSCH is configured to be transmitted semi-statically. The terminal apparatus 1 may determine one or multiple precoders for PUSCH transmission. For example, the precoder may be determined based at least on some or all of an SRS resource indicator (SRI), a transmitted precoding matrix indicator (TPMI), and a transmission rank (or rank). For example, the SRI may be provided by a DCI field of one or two SRS resource indicators. For example, the TPMI may be provided by a DCI field of one or two pieces of precoding information. For example, the transmission rank may be provided by a DCI field of the number of layers (the number of transmission layers). The SRI may be provided by a first higher layer parameter. The TPMI and the transmission rank may be provided by a second higher layer parameter. The first higher layer parameter may be srs-ResourceIndicator or srs-ResourceIndicator2. The second higher layer parameter may be precodingAndNumberOfLayers or precodingAndNumberOfLayers2.

An SRS resource set applied to the PUSCH may be determined based on the higher layer parameter. The PUSCH may be scheduled by the DCI format 0_1 or the DCI format 0_2. The higher layer parameter may be srs-ResourceSetToAddModList or srs-ResourceSetToAddModeListDCI-0-2. The higher layer parameter may be a higher layer parameter configured in SRS-Config.

In a case that ‘codebook’ is set for the higher layer parameter usage, one or two SRS resource sets may be configured in srs-ResourceSetToAddModList or srs-ResourceSetToAddModListDCI-0-2. The higher layer parameter usage may be configured in the higher layer parameter SRS-ResourceSet.

In a case that one SRS resource set is configured, the SRI and the TPMI may be given by the DCI field. The TPMI may be used to indicate a precoder. The precoder may be applied across v layers. In a case that multiple SRS resources are configured, one SRS resource may be selected by the SRI. A transmission precoder (precoder) may be selected from a codebook (uplink codebook). For example, the codebook may have the number of antenna ports. The number of antenna ports may be the same as the higher layer parameter nrofSRS-Ports. In a case that ‘codebook’ is set for the higher layer parameter txConfig, the terminal apparatus 1 may be configured with at least one SRS resource. The indicated SRI may relate to transmission of the SRS resource identified by the SRI.

In a case that two SRS resource sets are configured, one or two SRIs and one or two TPMIs may be given by the DCI field. For example, the DCI field may be one or both of a DCI field for SRS resource indication and a DCI field of precoding information and number of layers. The terminal apparatus 1 may apply the indicated SRI and TPMI to one or multiple PUSCH repetitions. The TA applied to one or multiple PUSCH repetitions may be the same. The TPMI may be used to indicate the precoder based on a codepoint for an SRS resource set indication. The precoder may be applied to the 0th layer to (v-1)-th layer. The precoder may correspond to the SRS resource selected by the SRI. Multiple SRS resources may be configured for an applicable SRS resource set. For one or two TPMIs, a transmission precoder (precoder) may be selected from a codebook (uplink codebook). In a case that two SRIs are indicated, the terminal apparatus 1 may expect the numbers of antenna ports for the indicated two SRS resources to be equal. The number of antenna ports may be provided by a higher layer parameter.

In codebook-based transmission, the terminal apparatus 1 may determine a codebook subset. For example, the codebook subset may be determined based at least on a TPMI. The codebook subset may be determined in response to reception of a certain higher layer parameter. The certain higher layer parameter may be codebookSubset or codebookSubsetDCI-0-2. Any of ‘fullyAndPartialAndNonCoherent’, ‘partialAndNonCoherent’, and ‘nonCoherent’ may be set for the certain higher layer parameter. For example, in a case that at least a certain higher layer parameter is set to ‘partialAndNonCoherent’, the codebook subset associated with a 2-port SRS resource (an SRS resource with two ports) may be ‘nonCoherent’. For example, the codebook may include at least one SRS resource with four ports and at least one SRS resource with two ports.

The terminal apparatus 1 may report UE capability (terminal capability). In a case that the terminal apparatus 1 reports the UE capability of ‘partialAndNonCoherent’ transmission, the terminal apparatus 1 may not expect the codebook subset with ‘fully AndPartialAndNonCoherent’ to be configured.

In a case that the terminal apparatus 1 reports the UE capability of the ‘nonCoherent’ transmission, the terminal apparatus 1 need not expect that the codebook subset with ‘fully AndPartialAndNonCoherent’ or ‘partialAndNonCoherent’ is configured.

In a case that the number of antenna ports indicates that the maximum number of configured SRS antenna ports is 2, the terminal apparatus 1 may not expect the higher layer parameter set to ‘partialAndNonCoherent’ to be configured. The higher layer parameter may be codebookSubset or codebookSubsetForDCI-Format0-2. The number of antenna ports may be determined by the higher layer parameter nrofSRS-Ports.

For codebook-based transmission, one SRS resource may be determined based on the SRI from the SRS resource set. Except the case that a first higher layer parameter is set to ‘fullpowerMode2’, the maximum number of configured SRS resources for codebook-based transmission may be 2. The first higher layer parameter may be ul-FullPowerTransmission. The DCI may indicate transmission of the SRS resource. For example, in a case that an aperiodic SRS is configured, the SRS request field in the DCI may indicate transmission of aperiodic SRS resources. The terminal apparatus 1 may not expect that the first higher layer parameter for which ‘fullpowerModel’ is set and the second higher layer parameter for which ‘fullAndPartial AndNonCoherent’ is set are configured.

The terminal apparatus 1 may transmit the PUSCH by using the same one or multiple antenna ports as one or multiple SRS ports in the SRS resource indicated by the DCI format or the higher layer parameter. For example, the SRS ports may be the same as the antenna ports for PUSCH transmission. A DMRS antenna port may be determined according to ordering of a DMRS port.

In a case that multiple SRS resources are configured by an SRS resource set, the terminal apparatus 1 may expect the higher layer parameter nrofSRS-Ports with the same value for these SRS resources to be configured. The SRS resource set may be the higher layer parameter SRS-ResourceSet with the higher layer parameter usage for which ‘codebook’ is set.

In a case that the higher layer parameter is set to ‘fullpowerMode2, one or multiple SRS resources with the same number or different numbers of SRS ports may be configured in one SRS resource set. In a case that the higher layer parameter is set to 'fullpowerMode2, up to two different spatial relations may be configured for all SRS resources in one SRS resource set. In a case that the higher layer parameter is set to 'fullpowerMode2, up to two or four SRS resources may be configured in one SRS resource set. In addition, up to eight SRS resources may be configured in one SRS resource set. The SRS resource set may be an SRS resource set with the higher layer parameter usage for which 'codebook’ is set. Two spatial relations may be associated with two uplink timings (Timing Advances (TAs)), or two uplink timing IDs (Timing Advance group IDs (TAG IDs)), or subTAG IDs. Two SRS resource sets may be associated with two TAs, two subTAG IDs, or two TAG IDs.

For non-codebook-based transmission, the PUSCH may be scheduled by the DCI format 0_0, the DCI format 0_1, or the DCI format 0_2. The terminal apparatus 1 may determine the precoder and the transmission rank of the PUSCH based on the SRI. For example, in a case that multiple SRS resources are configured, the SRI may be given by one or two SRS resource indications in the DCI. For example, the SRI may be given by the higher layer parameter. The SRS resource set applied to the PUSCH may be defined by an entry of the higher layer parameter. The higher layer parameter may be srs-ResourceSetToAddModList or srs-ResourceSetToAddModListDCI-0-2.

The terminal apparatus 1 may use one or multiple SRS resources for SRS transmission. The maximum number of SRS resources in one SRS resource set may be transmitted to the base station apparatus 3 as UE capability (terminal capability). SRS resources may be configured for simultaneous transmission in the same OFDM symbol. Multiple SRS resources transmitted at the same time may occupy the same resource block. One SRS port may be configured in each SRS resource. One or two SRS resource sets may be configured in the higher layer parameter srs-ResourceSetToAddModList where the higher layer parameter usage in the higher layer parameter SRS-ResourceSet is set to ‘nonCodebook’. In a case that two SRS resource sets are configured, one or two SRIs may be given by the DCI field. The DCI field may be a DCI field of two SRS resource indications.

The terminal apparatus 1 may apply the indicated SRI to one or multiple PUSCH repetitions. For example, in accordance with the SRS resource set of the PUSCH repetition, the terminal apparatus 1 may apply the indicated SRI to one or multiple PUSCH repetitions. The maximum number of SRS resources per SRS resource set configured for non-codebook-based transmission may be 4. The maximum number of SRS resources per SRS resource set configured for non-codebook-based transmission may be 8. Each of the indicated one or two SRIs may be associated with the latest transmission of an SRS resource in the SRS resource set identified by the SRI. The SRS transmission may be before the PDCCH carrying the SRI. The terminal apparatus 1 may not expect that the different numbers of SRS resources are configured in the two SRS resource sets.

The terminal apparatus 1 may apply an “indicated TCI state” to one or multiple PUSCH repetitions. For example, the terminal apparatus 1 may apply the “indicated TCI state” to one or multiple PUSCH repetitions according to the SRS resource set indicator field or a TRP indicator field. Each of one or two “indicated TCI states” may be associated with the latest indicator of a TCI state indicated by a first DCI format. The first DCI format may be transmitted prior to a second DCI format scheduling the PUSCH repetition. One “indicated TCI state” may be associated with one TA, one subTAG ID, or one TAG ID.

In a case that multiple PDCCH candidates (PDCCH candidate(s)) are associated with a search space set configured by a higher layer parameter, one PDCCH candidate is used. The one PDCCH candidate may be one of two PDCCH candidates that starts earlier. The higher layer parameter may be a searchSpaceLinking.

For non-codebook-based transmission, the terminal apparatus 1 may calculate a precoder. For example, a precoder used for SRS transmission may be calculated based on measurement of an NZP CSI-RS resource. One NZP CSI-RS resource may be configured for one SRS resource set. For example, one SRS resource set may be an SRS resource set with the higher layer parameter set to ‘nonCodebook’.

In a case that an aperiodic SRS resource set is configured, the NZP-CSI RS may be indicated through the SRS request field. The SRS request field may be one of the DCI fields in any one of the DCI format 0_1, the DCI format 0_2, the DCI format 1_1, and the DCI format 1_2. The first higher layer parameter may indicate an association between an aperiodic SRStriggerting state (SRS) and an SRS resource set. The first higher layer parameter, a triggered SRS resource, srs-ResourceSetId, and csi-RS may be configured in the higher layer parameter SRS-ResourceSet. The higher layer parameter csi-RS may indicate NZP-CSI-RS-ResourceId.

The higher layer parameter SRS-ResourceSet associated with the SRS request may be defined by an entry in a list that is a higher layer parameter. The list that is a higher layer parameter may be the higher layer parameter srs-ResourceSetToAddModList or srs-ResourceSetToAddModListDCI-0-2. The terminal apparatus 1 may not expect to update the precoding information (SRS precoding information). For example, in a case that the gap between the last OFDM symbol in reception of the aperiodic NZP-CSI-RS resource and an initial OFDM symbol in transmission of the aperiodic SRS is equal to or less than the 42 OFDM symbols, the terminal apparatus 1 may not expect to update the precoding information.

In a case that the aperiodic SRS associated with the aperiodic NZP CSI-RS resource is configured, the presence of the CSI-RS may be indicated by the SRS request field. In a case that the value of the SRS request field is not ‘00’ and the scheduling DCI is not used for cross carrier scheduling or cross BWP scheduling (cross bandwidth partscheduling), the presence of the CSI-RS may be indicated by the SRS request field.

The terminal apparatus 1 may perform one to-one mapping. One to-one mapping may be mapping from an SRI to a PUSCH layer corresponding to a DMRS port. The 0th to a (v-1)-th PUSCH layers may be provided. v may be the number of layers. The number of layers may be configured by the higher layer parameter. The number of layers may be indicated by the DCI. The terminal apparatus 1 may transmit the PUSCH by using the same antenna port as the SRS port. For example, the SRS port in the SRS resource indicated by the SRI may be indexed as pi=1000 +i. For example, the SRS port in the (i+1)-th SRS resource may be pi. In addition, the SRS port in the (i+1)-th SRS resource may also be indexed as pi. pi may be 1000+i. In other words, pi=1000+i may be satisfied.

In non-codebook-based transmission, the terminal apparatus 1 may not expect both spatial relation information (info) for the SRS resource and the higher layer parameter associatedCSI-RS in the higher layer parameter SRS-ResourceSet for the SRS resource set to be configured. The spatial relation information may be determined by a higher layer parameter. The spatial relation information may be a higher layer parameter spatialRelationInfo. In the non-codebook-based transmission, in a case that at least one SRS resource is configured in the SRS resource set with the higher layer parameter set to ‘nonCodebook’, the terminal apparatus 1 may be scheduled by the DCI format 0_1 or the DCI format 0_2. The spatial relation information may be determined according to the TCI state. The spatial relation information may be determined according to the “indicated TCI state”. In a case that the spatial relation information is determined according to the TCI state, the spatial relation information may be associated with one subTAG ID.

One or multiple Sounding Reference Signal resource sets (SRS resource sets) may be configured by the first higher layer parameter. The first higher layer parameter may be SRS-ResourceSet or SRS-PosResourceSet. In each SRS resource set, K SRS resources may be configured. K may be an integer of 1 or more. The maximum value of K may be indicated by the UE capability. The maximum value of K may be 16. The adaptability of the SRS resource set may be configured in a second higher layer parameter. The second higher layer parameter may be usage. For example, in a case that the second higher layer parameter is set to ‘beamManagement’, one SRS resource may be transmitted in each of the one or multiple SRS resource sets. For example, an SRS resource may be transmitted at a given time instance. Multiple SRS resources in different SRS resource sets may be transmitted simultaneously. For example, in different SRS resource sets of the same BWP, multiple SRS resources with the same time domain behaviour may be transmitted simultaneously.

For the aperiodic SRS, at least one DCI field may be used to select at least one from the configured SRS resource sets.

In a case that two SRS resource sets (a first SRS resource set and a second SRS resource set) are configured and that the number K of repetitions in a PUSCH repetition type A is more than 1, the same OFDM symbol allocation may be applied across continuous K slots and the PUSCH may be limited to one transmission layer. The terminal apparatus 1 may repeat a transport block across K continuous slots. In a case that the codepoint “00” of the SRS resource set indicator field is indicated, the first SRS resource set may be associated with K continuous slots. In a case that the codepoint “01” of the SRS resource set indicator field is indicated, the second SRS resource set may be associated with K continuous slots. In a case that the codepoint “10” of the SRS resource set indicator field is indicated, the first and second SRS resource sets may be associated with K continuous slots. For example, in a case of K=2, the first SRS resource set may be applied to a first slot and the second SRS resource set may be applied to a second slot. In a case of K>2 and that cyclic mapping (cyclicMapping) is enabled, the first and second SRS resource sets may be applied to the first and second slots of K continuous slots, respectively, and the same SRS resource set mapping pattern may continue in the remaining slots of K continuous slots. In a case of K>2 and that sequential mapping (sequentialMapping) is enabled, the first SRS resource set may be applied to the first and second slots of K continuous slots, and the second SRS resource set may be applied to third and fourth slots of K continuous slots, and the same SRS resource set mapping pattern may continue in the remaining slots of K continuous slots. In a case that the codepoint “11” of the SRS resource set indicator field is indicated, the first and second SRS resource sets may be associated with continuous K slots. For example, in a case of K=2, the second SRS resource set may be applied to the first slot and the first SRS resource set may be applied to the second slot. In the case of K>2 and that cyclic mapping (cyclicMapping) is enabled, the second and first SRS resource sets may be applied to the first and second slots of K continuous slots, respectively, and the same SRS resource set mapping pattern may continue in the remaining slots of K continuous slots. In the case of K>2 and that sequential mapping (sequentialMapping) is enabled, the second SRS resource set may be applied to the first and second slots of K continuous slots, and the first SRS resource set may be applied to the third and fourth slots of K continuous slots, and the same SRS resource set mapping pattern may continue in the remaining slots of K continuous slots. The SRS resource set indicator field may be included in one or both of the DCI format 0_1 and the DCI format 02. usage in SRS-ResourceSet may be set to ‘codebook’ or ‘noncodebook’ to configure two SRS resource sets. In continuous K slots, the applied TA need not be expected to be changed.

The SRS resource set indicator field may determine one or two TCI states. For example, in a case that the SRS resource set indicator field indicates “00” or “01”, one TCI state may be used. For example, in a case that the SRS resource set indicator field indicates “10” or “11”, two TCI states may be used. One or two TCI states may be one or both of a UL TCI state (UL-TCIState) and a DL/Joint TCI state (DLorJoint-TCIState). One or two TCI states may be one or both of an “indicated UL TCI state (UL-TCIState)” and an “indicated DL/Joint TCI state (DLorJoint-TCIState)”.

The SRS resource set indicator field may determine that one or both of a first TCI state and a second TCI state are used. For example, in a case that the SRS resource set indicator field indicates “00”, the first TCI state may be used. For example, in a case that the SRS resource set indicator field indicates “01”, the second TCI state may be used. For example, in the case that the SRS resource set indicator field indicates “10” or “11”, the first and second TCI states may be used.

STxMP (Simultaneous Transmission with Multi panel) may be applied to the terminal apparatus 1. STxMP (Simultaneous Transmission with Multi panel) may be applied to one or both of a first uplink physical channel and a second uplink physical channel. In a case that STxMP is applied, the terminal apparatus 1 may simultaneously transmit the first uplink physical channel and the second uplink physical channel. In the case that STxMP is applied, the terminal apparatus 1 may transmit the first and second uplink physical channels in the same time resource and the same frequency resource. In the case that STxMP is applied, a first code division multiplexing (CDM) group for a first DMRS port indicated for the first uplink physical channel may be different from a second CDM group for a second DMRS port indicated for the second uplink physical channel. The first CDM group need not be expected to be the same as the second CDM group. One or both of the first DMRS port and the second DMRS port may be indicated by an antenna port field in one DCI format. The first and second CDM groups may be indicated by the antenna port field. In the case that STxMP is applied, the first and second uplink physical channels may correspond to one precoding matrix. One precoding matrix may be determined by a TPMI field in the DCI format. In the case that STxMP is applied, the first uplink physical channel may correspond to the first TCI state, and the second uplink physical channel may correspond to the second TCI state. The first and second TCI states may be indicated by a transmission configuration indicator (TCI) field in the DCI format 1_1/1_2. In the case that STxMP is applied, the first uplink physical channel may correspond to a first uplink transmission spatial filter (UL Tx Spatial filter), and the second uplink physical channel may correspond to a second uplink transmission spatial filter. The first uplink transmission spatial filter may be determined by an SRS resource indication (SRI) field in the DCI format. The second uplink transmission spatial filter may be determined by a Second SRI field in the DCI format.

In the case that STxMP is applied, the first number of transmission layers (number of ranks) corresponding to the first uplink physical channel may be the same as or different from the second number of transmission layers (number of ranks) corresponding to the second uplink physical channel. A difference between the first number of transmission layers and the second number of transmission layers need not be expected to be two or more. In the case that STxMP is applied, the first and second uplink physical channels may fully overlap each other. In the case that STxMP is applied, the first and second uplink physical channels need not be expected to partially overlap each other. In the case that STxMP is applied, a first transport block corresponding to the first uplink physical channel need not be expected to be different from a second transport block corresponding to the second uplink physical channel. In the case that STxMP is applied, each of the first and second uplink physical channels need not be expected to convey two transport blocks (codewords). In the case that STxMP is applied, a higher layer parameter sfnSchemePusch or a higher layer parameter sfnSchemePucch need not be expected to be configured for one or both of the first and second uplink physical channels. In a case that the higher layer parameter sfnSchemePusch is configured for a certain PUSCH, a DMRS port for the certain PUSCH may be QCLed with reference signals in multiple (e.g., two) TCI states. In a case that the higher layer parameter sfnSchemePucch is configured for a certain PUCCH, a DMRS port for the certain PUCCH may be QCLed with reference signals in multiple (e.g., two) TCI states.

The application of STxMP may be configured by a higher layer parameter. For example, the application of STxMP for a PUSCH may be configured by a dedicated higher layer parameter for the PUSCH. For example, the application of STxMP for a PUCCH may be configured by a dedicated higher layer parameter for the PUCCH. The application of STxMP may be indicated by the DCI format.

A PUSCH-MTRP scheme may be a general term for the PUSCH repetition in the case that cyclicMapping is enabled, the PUSCH repetition in the case that sequentialMapping is enabled, and STxMP. For example, the fact that the PUSCH-MTRP scheme is applied may be any one of the fact that cylicMapping is enabled, the fact that sequentialMapping is enabled, and the fact that STxMP is applied.

Multiple Transmission Reception Points (Transmit/Receive Points or TRPs) may be used. The base station apparatus 3 may include multiple TRPs (Multi-TRP). The terminal apparatus 1 may be scheduled by two TRPs in one serving cell. In Multi-TRP, the operation mode of one of single-DCI and multi-DCI may be used. In Multi-TRP, uplink control may be completed in the MAC layer and the physical layer. In Multi-TRP, downlink control may be completed in the MAC layer and the physical layer. In the Single-DCI mode, the terminal apparatus 1 may be scheduled by the same DCI for two TRPs. In a Multi-DCI mode, the terminal apparatus 1 may be scheduled by independent DCI from each TRP. In the Multi-DCI mode, each TRP in the Multi-TRP may be identified by TRP information. In other words, one TRP in the Multi-TRP may be identified by one piece of TRP information. The TRP information may be used to select one TRP. In addition, an index of a Control Resource Set (CORESET) resource pool may be associated with one CORESET. The terminal apparatus 1 may transmit the PUSCH based on the index of the CORESET resource pool. The terminal apparatus 1 may transmit the PDCCH and the PDSCH based on the index of the CORESET resource pool. The TRP information may be a CORESET pool index. The TRP information may be given by a TRP indicator field.

The terminal apparatus 1 may form a beam (beamforming). For example, the terminal apparatus 1 may transmit a radio wave (electromagnetic waves) in a specific spatial direction by beamforming. For example, the terminal apparatus 1 may receive a radio wave from a specific spatial direction by beamforming. The terminal apparatus 1 may include and use one or multiple antennas for one or both of transmission and reception of a radio wave. A directional radio wave may be referred to as a beam. Information related to a beam may be referred to as beam information. For example, the beam information may be a specific spatial direction. For example, the beam information may be an arrival direction of a radio wave. The beam information may be a TCI state. The beam information may be an uplink transmission spatial filter. The beam information may be an SRS resource indicator. The beam information may be a QCL assumption or a QCL relationship.

The terminal apparatus 1 may be configured with a higher layer parameter TCI-State. For example, the terminal apparatus 1 may be configured with one list in the higher layer parameter PDSCH-Config. One list may include up to M higher layer parameters TCI-State. One list may be a list of up to M higher layer parameters TCI-State. The terminal apparatus 1 may be configured with one list in order to decode (receive) the PDSCH according to the PDCCH with the DCI. M may depend on the terminal capability (UE capability). For example, M may depend on the terminal capability maxNumberConfiguredTCIStatePerCC. TCI-State may be referred to as a TCI state.

Each TCI-State (i.e., higher layer parameter TCI-State) may include a parameter for configuring a QCL (quasi co-location (QCL relationship)). The QCL relationship may be a relationship between one or two downlink reference signals (downlink physical signals) and a DMRS (DMRS port) of a PDSCH. The QCL relationship may be a relationship between one or two downlink reference signals (downlink physical signals) and a DMRS (DMRS port) of a PDCCH. The QCL relationship may be a relationship between one or two downlink reference signals (downlink physical signals) and a CSI-RS (CSI-RS port) of one CSI-RS resource. For example, the QCL relationship between a channel/signal A and a channel/signal B may indicate that the channel/signal A is QCLed with the channel/signal B. In a case that the channel/signal A is QCLed with the channel/signal B, the first TA for the channel/signal A and the second TA for the channel/signal B may be the same.

The QCL relationship may be configured by one or both of a higher layer parameter qcl-Type1 and a higher layer parameter qcl-Type2. For example, the QCL relationship may be configured by one or both of the higher layer parameter qcl-Typel for a first downlink reference signal (DL RS) and the higher layer parameter qcl-Type2 for a second downlink reference signal. In a case that the first downlink reference signal and the second downlink reference signal are different from each other, a QCL type of qcl-Typel need not be the same as a QCL type of qcl-Type2. A QCL type corresponding to each downlink reference signal may be given by a higher layer parameter qcl-Type in a higher layer parameter QCL-Info. The QCL type may be any one of typeA, typeB, typeC, and typeD.

The terminal apparatus 1 may be configured with a higher layer parameter DLorJointTCIState. For example, the terminal apparatus 1 may be configured with one list in the higher layer parameter PDSCH-Config. One list may include up to 128 higher layer parameters DLorJointTCIState (TCIState). One list may be a list of up to 128 higher layer parameters DLorJointTCIState (TCIState). One list may be configured to provide one reference signal. The higher layer parameter DLorJointTCIState (TCIState) may be configured to provide one reference signal. One reference signal may be a reference signal for the QCL for the DMRS of the PDSCH and the DMRS of the PDCCH. One reference signal may be a reference signal for the CSI-RS. One list may be configured to provide one reference. The higher layer parameter DLorJointTCIState may be configured to provide one reference. One reference may be used to determine an uplink transmission spatial filter (UL TX spatial filter). The uplink transmission spatial filter may be used for a PUSCH, a PUCCH, and an SRS. In other words, one reference may be provided to determine uplink transmission spatial filters for a PUSCH, a PUCCH, and an SRS. The TCI state may be DLorJointTCIState (TCIState). DLorJointTCIState may be referred to as a DL/Joint TCI state or a unified TCI state. One list may be dl-OrJoint-TCIStateList.

The terminal apparatus 1 may be configured with the higher layer parameter UL-TCIState. For example, the terminal apparatus 1 may be configured with one list in a higher layer parameter BWP-UplinkDedicated. One list may include up to 64 higher layer parameters UL-TCIState. One list may be a list of up to 64 higher layer parameters UL-TCIState. Each UL-TCIState (or UL-TCIState configuration) may include a parameter for configuring one reference signal. For example, each UL-TCIState may include one parameter for configuring one reference signal for determining the uplink transmission spatial filter for some or all of a PUSCH, a PUCCH, and an SRS. One list may be a higher layer parameter ul-TCI-StateList. The TCI state may be UL-TCIState. UL-TCIState may be referred to as a UL TCI state or a unified TCI state.

UL-TCIState may be a higher layer parameter TCI-UL-State. UL-TCIState may be configured by the higher layer parameter TCI-UL-State. The higher layer parameter TCI-UL-State may associate one or two downlink reference signals with a corresponding QCL type.

In a case that DLorJointTCIState or the UL-TCIState is configured, the terminal apparatus 1 may transmit the PUSCH according to a spatial relation. For example, the spatial relation may be a relation with reference to one reference signal (RS). For example, one reference signal may be a reference signal for determining the uplink transmission spatial filter. One reference signal may be a reference signal configured with qcl-Type set to typeD in the “indicated TCI state”. The “indicated TCI state” may be indicated DLorJointTCIState or indicated UL-TCIState. A reference RS in indicated DLorJointTCIState may be a CSI-RS resource in a higher layer parameter NZP-CSI-RS-ResourceSet. A reference RS in the indicated UL-TCIState may be a CSI-RS resource in NZP-CSI-RS-ResourceSet. Indicated UL-TCIState (Indicated UL-TCIState) may be a TCI state, a UL TCI state, or a unified TCI state indicated by the DCI format 1_1 or the DCI format 1_2. Indicated DLorJointTCIState (Indicated DLorJointTCIState) may be a TCI state, a DL/Joint TCI state, or a unified TCI state indicated by the DCI format 1_1 or the DCI format 1_2.

DLorJointTCIState (e.g., higher layer parameter DLorJointTCIState) and UL-TCIState (e.g., higher layer parameter UL-TCIState) may be configured in one BWP of one component carrier. In a case that the configuration of DLorJointTCIState or the configuration of UL-TCIState is not performed in one BWP, the terminal apparatus 1 may apply the configuration of DLorJointTCIState or the configuration of UL-TCIState from the reference BWP.

The terminal apparatus 1 need not expect that both of a first higher layer parameter and a second higher layer parameter are configured. The first higher layer parameter may be any one of TCI-State, SpatialRelationInfo, and PUCCH-SpatialRelationInfo. The second higher layer parameter may be any one of DLorJointTCIState and UL-TCIState. In a case that TCI-State is configured in any component carrier in a certain list, the second higher layer parameter need not be configured in any component carrier in the same band in the certain list. The certain list may be configured by a higher layer parameter simultaneousTCI-UpdateList1, a higher layer parameter simultaaneousTCI-UpdateList2, a higher layer parameter simultaneousSpatial-UpdatedList1, or a higher layer parameter simultaneousSpatial-UpdatedList2. In a case that the first higher layer parameter is configured, two TAs need not be expected to be provided in one serving cell.

The terminal apparatus 1 may receive an activation command. The activation command may be used for up to eight “one or both of TCI states and pairs of TCI states” to be mapped to codepoints of the DCI field ‘Transmission Configuration Indication’. A pair of TCI states may involve one TCI state for multiple downlink channels/signals (DL TCI state) and one TCI state for multiple uplink channels/signals (UL TCI state). The multiple downlink channels/signals may be part or all of the PDSCH, the PDCCH, and the CSI-RS. The multiple uplink channels/signals may be part or all of a PUSCH, a PUCCH, and an SRS. The DCI (DCI format) may include one or multiple DCI fields. For example, the DCI (DCI format) may include the TCI field (‘Transmission Configuration Indication’field).

In a case that a first set of one or multiple TCI state IDs is activated in a second set, the first set may be applied for a downlink BWP in an indicated component carrier. In a case that the first set of one or multiple TCI state IDs is activated in a third set, the first set may be applied for the downlink BWP and an uplink BWP in the indicated component carrier. The second set may be a set of one or both of one or multiple component carriers and one or multiple downlink BWPs. The third set may be a set of some or all of one or multiple component carriers, one or multiple downlink BWPs, and one or multiple uplink BWPs.

In a case that the activation command maps one or both of DLorJointTCIState and UL-TCIState to one TCI codepoint (codepoint of the DCI field ‘Transmission Configuration Indication’), the terminal apparatus 1 may apply one or both of indicated DLorJointTCIState (Indicated DLorJointTCIState) and indicated UL-TCIState (Indicated UL-TCIState).

The terminal apparatus 1 may receive the DCI format 1_1/1_2 that provides indicated DLorJointTCIState or indicated UL-TCIState. The DCI format need not involve a downlink assignment. For example, in a case that the DCI format 1_1/1_2 does not involve the downlink assignment, the terminal apparatus 1 may assume some or all of the following: the CS-RNTI is used to scramble the CRC for the DCI, all redundancy versions (RVs) are 1, all MCSs are 1, the NDI is 0, all 0 is set for the FDRA type 0, and all 1 is set for the FDRA type 1.

The terminal apparatus 1 may receive the DCI format including the TRP indicator field. The TRP indicator field may select one or two TCI states from one or multiple “indicated TCI states”. The TCI state may be referred to as an “applied TCI state”. In a case that one TCI state is selected, one TCI state may be applied to a PDSCH, a PUSCH, a PUCCH, a CSI-RS, or an SRS scheduled according to the DCI format. In a case that two TCI states are selected, two TCI states may be applied to a PDSCH, a PUSCH, a PUCCH, a CSI-RS, or an SRS scheduled according to the DCI format. The “indicated TCI state” may be “indicated DLorJointTCIState” or “indicated UL-TCIState”. The DCI may be referred to as a DCI format.

N_{conf} TCI states may be configured. For example, N_{conf} TCI states may be configured in a radio resource control layer. For example, N_{conf} TCI states may be configured by a higher layer parameter. Each of N_{conf} TCI states may be referred to as a “configured TCI state”. N_{conf} may be an integer from 1 to 128. In a case that the TCI state is a DL TCI state or a Joint TCI state, N_{conf} may be an integer from 1 to 128. In case that the TCI state is a UL TCI state, N_{conf} may be an integer from 1 to 64.

Nact TCI states may be activated. For example, the N_{act} TCI states may be some or all of N_{conf} TCI states. For example, N_{act} TCI states may be activated in a medium access control layer. For example, N_{act} TCI states may be activated by the MAC CE. Each of N_{act} TCI states may be referred to as an “activated TCI state”. N_{act} may be an integer from 1 to 32.

N_{ind} TCI states may be indicated. For example, N_{ind} TCI states may be some or all of N_{act} TCI states. For example, N_{ind} TCI states may be indicated in the physical layer. For example, N_{ind} TCI states may be indicated by the DCI. For example, N_{ind} TCI states may be indicated by the TCI field in the DCI. Each of N_{ind} TCI states may be referred to as an “indicated TCI state”. The “indicated TCI state” may be applied to the PDSCH, the PDCCH, and the CSI-RS. The “indicated TCI state” may be applied to a PUSCH, a PUCCH and an SRS. The “indicated TCI state” may be applied to a PDSCH, a PDCCH, a CSI-RS, a PUSCH, a PUCCH, and an SRS. N_{ind} may be an integer from 1 to 4.

Nₐₚₚ TCI states may be indicated and applied. For example, Nₐₚₚ TCI states may be some or all of N_{ind} TCI states. For example, Nₐₚₚ TCI states may be indicated in the physical layer. For example, Nₐₚₚ TCI states may be indicated by the DCI. For example, Nₐₚₚ TCI states may be indicated by the TRP indicator field in the DCI. Each of Nₐₚₚ TCI states may be referred to as an ‘applied TCI state’. Nₐₚₚ may be 1 or 2.

The terminal apparatus 1 may receive a higher layer configuration. After the “configured TCI state” is configured for the terminal apparatus 1 and before one “indicated TCI state” from the “configured TCI state” is applied to the terminal apparatus 1, the terminal apparatus 1 may assume that the DMRS of the PDSCH, the DMRS of the PDCCH, and the CSI-RS to which the “indicated TCI state” is applied are QCLed with the SS/PBCH block. For example, after the terminal apparatus 1 receives an initial configuration of multiple DLorJoint-TCIState and before one indicated TCI state from the configured TCI states is applied to the terminal apparatus 1, the terminal apparatus 1 may assume that the DMRS of the PDSCH, the DMRS of the PDCCH, and the CSI-RS to which the indicated TCI state is applied are QCLed with the SS/PBCH block.

The terminal apparatus 1 may receive a higher layer configuration. After the “configured TCI state” is configured for the terminal apparatus 1 and before one “indicated TCI state” from the “configured TCI state” is applied to the terminal apparatus 1, the terminal apparatus 1 may assume that the first uplink transmission spatial filter for the PUSCH, the PUCCH, and the SRS to which the “indicated TCI state” is applied is the same as the second uplink transmission spatial filter. For example, after the terminal apparatus 1 receives an initial configuration of multiple DLorJoint-TCIState or multiple UL-TCIState and before one indicated TCI state from the configured TCI states is applied to the terminal apparatus 1, the terminal apparatus 1 may assume that the first uplink transmission spatial filter (UL TX spatial filter) for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in an initial access procedure.

After the terminal apparatus 1 receives a configuration of multiple DLorJoint-TCIState configurations (“configured TCI states”) and before one “indicated TCI state” from the configured TCI states is applied to the terminal apparatus 1, the DMRS of the PDSCH, the DMRS of the PDCCH, and the CSI-RS to which the indicated TCI state is applied may be QCLed with the SS/PBCH block or the CSI-RS resource. For example, the SS/PBCH block or the CSI-RS resource may be identified in a random access procedure initiated by a reconfiguration with sync. For example, the terminal apparatus 1 may receive the configuration of DLorJoint-TCIState as a part of the reconfiguration with sync.

After the terminal apparatus 1 receives a configuration of multiple DLorJoint-TCIState or multiple UL-TCIState (“configured TCI states”) and before one “indicated TCI state” from the configured TCI states is applied to the terminal apparatus 1, the terminal apparatus 1 may assume that the first uplink transmission spatial filter for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in the random access procedure initiated by the reconfiguration with sync.

DLorJoint-TCIState may be used as an “indicated TCI state”. For example, the terminal apparatus 1 may acquire the QCL assumption (QCL relationship, QCL) from the “configured TCI states” for the DMRS of the PDSCH, the DMRS of the PDCCH, and the CSI-RS to which the “indicated TCI state” is applied“. The “indicated TCI state” may be applied to the DMRS of the PDSCH, the DMRS of the PDCCH, and the CSI-RS. The “indicated TCI state” may be applied to the DMRS of the PDSCH, the DMRS of the PDCCH, the CSI-RS, the PUSCH, the PUCCH, and the SRS.

UL-TCIState may be used as an “indicated TCI state”. For example, the terminal apparatus 1 may determine the uplink transmission spatial filter from the “configured TCI states” for the PUSCH, the PUCCH, and the SRS to which the “indicated TCI state” is applied.

In a case that the terminal apparatus 1 transmits a first channel and that a first “indicated TCI state” is different from a second “indicated TCI state”, the first “indicated TCI state” may be applied starting from the first slot. The first channel may be a PUCCH with HARQ-ACK information or a PUSCH with the HARQ-ACK information. The HARQ-ACK information may be HARQ-ACK information corresponding to a DCI conveying a TCI state indication without a downlink assignment. The HARQ-ACK information may be HARQ-ACK information corresponding to a PDSCH scheduled by the DCI conveying the TCI state indication. The second indicated TCI state may be indicated prior to (before) the first indicated TCI state. The first slot may be the first slot at least beamAppTime symbols after the last OFDM symbol in the first channel. BeamAppTime may be the number of OFDM symbols. BeamAppTime may be configured by a higher layer parameter. BeamAppTime may be determined according to the terminal capability. The indicated TCI state may be indicated DLorJointTCIState or indicated UL-TCIState.

In a case that the higher layer parameter PDCCH-Config includes two different values of the CORESET pool indices (CORESET Pool Index or coresetPoolIndex), the terminal apparatus 1 may receive an activation command (“activated TCI state”) for the CORESET associated with each CORESET pool index. The activation command may be used to map up to eight TCI states to the codepoints of the DCI field ‘Transmission Configuration Indication’. In a case that a set of TCI state IDs is activated for one CORESET pool index, an “activated TCI state” corresponding to the one CORESET pool index may be associated with one physical cell ID, and an “activated TCI state” corresponding to a CORESET pool index different from the one CORESET pool index may be associated with a physical cell ID different from the one physical cell ID. The activation command may be transmitted as a MAC CE command. One or multiple CORESETs may be configured in one BWP. One CORESET may correspond to a CORESET pool index of ‘0’ or ‘1’.

One codepoint of the DCI field ‘Transmission Configuration Indication’ (in other words, the TCI field) may include up to four TCI states. For example, one of up to four TCI states may be a Joint TCI state. One of the up to four TCI states may be a DL TCI state. One of the up to four TCI states may be a UL TCI state. One codepoint of the DCI field ‘Transmission Configuration Indication’ may include two pairs of TCI states. The pair of TCI states may be a pair of a DL TCI state and a UL TCI state. The terminal apparatus 1 may receive an activation command. The activation command may be used to map up to eight combinations of four or fewer TCI states to the codepoints of the DCI field ‘Transmission Configuration Indication’. The activation command may be used to map up to eight combinations of one or two “pairs of TCI states” to a code map of the DCI field ‘Transmission Configuration Indication’. The terminal apparatus 1 need not expect to receive more than eight TCI states in the activation command. The terminal apparatus 1 need not expect to receive more than eight “pairs of TCI states” in the activation command.

In a case that the terminal apparatus 1 transmits a first PUCCH in the first slot, the mapping between the TCI state and the codepoints may be applied starting from the second slot. The first PUCCH may involve first HARQ-ACK information. The first PUCCH may be transmitted corresponding to a first PDSCH. The first PDSCH may convey an activation command.

In a case that the first higher layer parameter is configured, and that a first time offset is more than or equal to a first value, and after the terminal apparatus 1 receives the initial configuration of the TCI state (the configured TCI state) and before the activation command (the activated TCI state) is received, the DMRS port of the PDSCH may be QCLed with the SS/PBCH block with respect to the QCL typeA. The first higher layer parameter may be configured for a CORESET scheduling a PDSCH. The CORESET may schedule the PDSCH. The first time offset may be an offset between reception of the DL DCI and the PDSCH. The first value may be a timeDurationForQCL.

In the case that the first higher layer parameter is configured, the terminal apparatus 1 may assume that the TCI field is present in the DCI format for the PDCCH transmitted in the CORESET. The first higher layer parameter may be a tci-PresentInDCI set to ‘enabled'. The first higher layer parameter may be tci-PresentInDCI set to 'enabled’ for the CORESET scheduling the PDSCH or the multicast PDSCH. The first higher layer parameter may be tci-PresentDCI-1-2.

In a case that the first DCI format schedules a PDSCH and that a time offset is equal to or greater than a threshold, the TCI state or QCL assumption for the PDSCH may be the same as the TCI state or QCL assumption applied for the CORESET used for the PDCCH, in order to determine a PDSCH antenna port QCL. The time offset may be a time offset between the reception of the DL DCI and the corresponding PDSCH. The threshold may be timeDurationForQCL. The first DCI format need not include the TCI field.

In a case that a first terminal capability is indicated to the terminal apparatus 1, the terminal apparatus 1 may determine a spatial domain filter. The spatial domain filter may be used while an applicable channel access procedure prior to a UL transmission in the channel is performed. In a case that an SRI corresponding to a UL transmission is indicated, the terminal apparatus 1 may use the spatial domain filter the same as the spatial domain filter associated with the indicated SRI. The terminal apparatus 1 may use the spatial domain filter the same as the spatial domain filter used to receive the DL reference signal associated with the indicated TCI state. For example, in a case that DLorJointTCIState or the TCI state configuration with UL-TCIState (configured TCI state) is configured, the terminal apparatus 1 may use the spatial domain filter the same as the spatial domain filter used to receive the DL reference signal associated with the indicated TCI state. The first terminal capability may be beamCorrespondenceWithoutUL-BeamSweeping set to ‘1’.

In a case that the first higher layer parameter is configured and that multiple (e.g., two) TCI states are indicated, the DMRS port of the PDSCH may be QCLed with the DL-RSs in the multiple (e.g., two) TCI states. The multiple TCI states in one codepoint of the DCI field ‘Transmission Configuration Indication’ in the DCI for scheduling the PDSCH may be indicated. The first higher layer parameter may be sfnSchemePdsch. The first higher layer parameter may be sfnSchemePdsch set to ‘sfnSchemeA’. The first higher layer parameter may be sfnSchemePdsch set to ‘sfnSchemeB’. The second of two TCI states need not include the QCL parameters {Doppler shift, Doppler spread}. In a case that the first higher layer parameter is configured, and that multiple (e.g., two) TCI states are indicated, and that the TRP indicator field indicates a third indication or a fourth indication, the DMRS port of the PDSCH may be QCLed with the DL-RSs in the multiple (e.g., two) TCI states. The fact that the first higher layer parameter is configured may mean that the SFN scheme is applied for the PDSCH.

The terminal apparatus 1 may receive a DMRS for a PDSCH scheduled by a PDCCH with the DCI format. In the case that two TCI states are indicated, and in a case the terminal apparatus 1 receives the DMRS for the PDSCH and the SS/PBCH block in the same OFDM symbol, at least one DMRS port for the PDSCH and the SS/PBCH block may be QCLed with the typeD (‘QCL-TypeD’). In a case that the first higher layer parameter is configured, and that multiple PDSCHs are overlapped by multiple PDCCHs in the time-frequency domain, different DMRS configurations need not be expected, and two TCI states need not indicate DMRS ports in one CDM group. The first higher layer parameter may be PDCCH-Config including two different CORESET pool indices. The SS/PBCH block may belong to one of group 1 and group 2. For example, group 1 may correspond to a first TAG ID or a second subTAG ID. Group 2 may correspond to a second TAG ID or a second subTAG ID.

In the downlink, up to 16 or 32 HARQ processes may be supported in one serving cell. The number of HARQ processes may be configured by a higher layer parameter. In a case that the higher layer parameter is not configured, the number of HARQ processes may be eight.

The terminal apparatus 1, in response to detecting a PDCCH with a DCI format, may receive (decode) the corresponding PDSCH as indicated by the DCI format.

The higher layer parameter may include values of two different CORESET pool indices. The PDCCHs scheduling two PDSCHs (first PDSCH and second PDSCH) may be associated with the CORESETs having the different values of the CORESET pool indices. The higher layer parameter may be PDCCH-Config. The terminal apparatus 1 may receive the first PDSCH and the second PDSCH.

The terminal apparatus 1 may assume that the DMRS port of the first PDSCH is QCLed with a first SS/PBCH block with respect to the first QCL parameter. The first PDSCH may be scheduled with the SI-RNTI, the P-RNTI, or a G-RNTI for broadcast. The terminal apparatus 1 may assume that the DMRS port of the second PDSCH is QCLed with a second SS/PBCH block or a second CSI-RS resource with respect to the first QCL parameter. The second SS/PBCH block or the second CSI-RS resource may be used for RACH association. The second PDSCH may be scheduled with the RA-RNTI, or an MSGB-RNTI. The terminal apparatus 1 may assume that a DMRS port of the first PDCCH order, a DMRS port of a third PDSCH are QCLed with the second SS/PBCH block or the second CSI-RS resource with respect to the first QCL parameter. The third PDSCH may be scheduled with the RA-RNTI for a random access procedure triggered by the first PDCCH order. The first QCL parameter may include some or all of Doppler shift, Doppler spread, average delay, delay spread, and spatial RX parameters.

In a case that the decoding of the PDCCH with the CRC scrambled by the CS-RNTI is configured by the higher layer, the terminal apparatus 1 may receive the PDSCH without the corresponding PDCCH.

In the case that the first higher layer parameter is configured, the terminal apparatus 1 may receive multiple PDCCHs. The first higher layer parameter may be PDCCH-Config. The first higher layer parameter may include values of two different CORESET pool indices.

Multiple PDCCHs may schedule multiple PDSCHs. The multiple PDSCHs may or may not overlap in the time-frequency domain. In a case that the multiple PDCCHs are associated with different CORESETs, the terminal apparatus 1 may simultaneously receive the multiple PDSCHs. The different CORESETs may have values of different CORESET pool indices (coresetPoolIndex).

In a case that the CORESET (the higher layer parameter ControlResourceSet) does not involve the CORESET pool index (the higher layer parameter coresetPoolIndex), the terminal apparatus 1 may assume that the CORESET is assigned with the CORESET pool index 0. In a case that two TAG IDs or two subTAG IDs are provided, the CORESET may have a CORESET pool index.

A first physical cell ID associated with the first CORESET may be different from a second physical cell ID associated with the second CORESET. For example, the first and second CORESETs may be associated with different physical cell IDs via the activated TCI state. The first and second CORESETs may correspond to different CORESET pool indices.

In a case that the PDCCH reception includes two PDCCH candidates from the search space set, one PDCCH monitoring occasion may be a union of the PDCCH monitoring occasions for the two PDCCH candidates. The start of the PDCCH reception may be the start of a previous PDCCH candidate. The end of the PDCCH reception may be the end of a subsequent PDCCH candidate.

In a case that no CORESET pool index is provided in one BWP in one serving cell, three or fewer CORESETS may be provided. In a case that the same CORESET pool index is provided for all CORESETs in one BWP in one serving cell, three or fewer CORESETs may be provided. In a case that a CORESET pool index 0 is provided for the first CORESET in one BWP in one serving cell and that a CORESET pool index 1 is provided for the second CORESET, five or fewer CORESETs may be provided.

In each CORESET, there may be provided at least a CORESET index by the first higher layer parameter, a QCL relationship (antenna port QCL) by the second higher layer parameter, and an indication of whether a TCI field is present by the third higher layer parameter. The first higher layer parameter may be controlResourceSetId. The second higher layer parameter may be TCI-State. The third higher layer parameter may be tci-PresentInDCI or tci-PresentDCI-1-2.

In a case that a value of 0 is provided for a search space ID, the terminal apparatus 1 may determine a search occasion for the PDCCH candidate. The search space ID may be searchSpaceID. The search space ID may be included in PDCCH-Config or PDCCH-ConfigCommon.

In a case that two TCI states are provided in one CORESET, the terminal apparatus 1 may assume QCL information indicated by both of the two TCI states for the PDCCH reception in one CORESET. The two TCI states may indicate the QCL information (QCL relationship) of the DMRS antenna port for the PDCCH reception.

In a case that a configuration of the TCI state is not provided in one CORESET, and that an initial configuration of two or more TCI states are provided, and that a MAC CE activation command is not received, the terminal apparatus 1 may assume that the DMRS antenna port related to the PDCCH reception is the QCLed with the SS/PBCH block. The SS/PBCH block may be identified by the terminal apparatus 1 at the time of an initial access procedure.

In a case that the configurations of two or more TCI states are provided by reconfiguration with synchronization (Reconfiguration with synch) in one CORESET, and that the MAC CE activation command is not received, the terminal apparatus 1 may assume that the DMRS antenna port related to the PDCCH reception is QCLed with the SS/PBCH block or the CSI-RS resource. The SS/PBCH block or the CSI-RS resource may be identified by the terminal apparatus 1 in the random access procedure initiated by the reconfiguration with sync.

In a case that the TCI state (for example, unified TCI state) is provided in the CORESET with the index 0 and the unified TCI state is applied, the terminal apparatus 1 may assume that the DMRS antenna port (DMRS port) for a first PDCCH reception and the DMRS antenna port for a first PDSCH reception are QCLed with the reference signal indicated in the TCI state. The fact that the unified TCI state is applied may mean that followUnifiedTCIstate set to ‘enable’ is configured. The first PDSCH reception may be scheduled by the DCI format provided by the first PDCCH reception. The unified TCI state may be DLorJoint-TCIState.

In a case that the TCI state (for example, unified TCI state) is provided in the CORESET with the index 0 and the unified TCI state is not applied, the terminal apparatus 1 and the DMRS antenna port (DMRS port) for the first PDCCH reception are QCLed with one or multiple reference signals according to the activated TCI state.

In a case that one TCI state is provided in a CORESET with an index of other than 0, or in a case that the MAC CE activation command is received for one or two provided TCI states, the terminal apparatus 1 may assume that the DMRS antenna port for the PDCCH reception is QCLed with one or multiple DL RSs configured by the TCI state. The TCI state indicated by the MAC CE activation command may be the “activated TCI state”.

In a case that the unified TCI state is provided, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

In a case that multiple (e.g., two) unified TCI states are provided (or indicated), the DMRS antenna port for the PDCCH reception in one CORESET with the index of other than 0 and the DMRS antenna port for the PDSCH scheduled by the DCI format provided by the PDCCH reception may be QCLed with a reference signal provided by one or both of the indicated unified TCI states (“indicated TCI states”).

In a case that the unified TCI state is applied, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

Ten or fewer search space sets may be provided in one BWP in one serving cell. For each search space set, at least a search space set index by the first higher layer parameter, the relationship between the search space set and the CORESET by the second higher layer parameter, and the search space set (search space set index) linked by the third higher layer parameter may be determined. The first higher layer parameter may be searchSpaceld. The second higher layer parameter may be controlResourceSetId. In a first search space set, a second search space set index may be provided by the third higher layer parameter. The third higher layer parameter may link the first search space set to the second search space set. The third higher layer parameter may be searchSpaceLinking. The fact that the third higher layer parameter is provided may mean that the search space linking is applied.

In a case that the first search space set is linked to the second search space set, the terminal apparatus 1 may perform monitoring in accordance with each search space set in the monitoring occasion in one slot. The count of PDCCH candidates corresponding to the first search space set and the second search space set may be 3. A CORESET pool index of the first CORESET associated with the first search space set may be different from a CORESET pool index of the second CORESET associated with the second search space set. The fact that the first search space set is linked to the second search space set may mean that the first search space set includes searchSpaceLinking with the second search space set and the second search space set includes searchSpaceLinking with the first search space set.

In a case that the first search space set is linked to the second search space set and that a third search space set is not linked, the terminal apparatus 1 may monitor a first PDCCH candidate corresponding to the first search space set and may monitor a second PDCCH candidate corresponding to the second search space set for the first DCI format. The terminal apparatus 1 may monitor a third PDCCH candidate corresponding to the third search space set for the second DCI format. In one CORESET and in the same symbol in one slot, the first PDCCH candidate corresponding to the first search space set or the second PDCCH candidate corresponding to the second search space set and the third PDCCH candidate corresponding to the third search space set may use the same set of CCEs and may be subjected to the same scrambling. The third PDCCH candidate corresponding to the third search space set need not be counted for monitoring. The detected DCI format need not be assumed to be the first DCI format.

In a case that the first search space set is linked to the second search space set, and that the third search space set is linked to a fourth search space set, and that sizes of the detected DCI formats are the same, the terminal apparatus 1 may expect different CCEs or different scrambling in one CORESET.

In a case that the terminal apparatus monitors multiple PDCCHs in the first CORESET and the second CORESET, the first CORESET may correspond to the CSS set with the smallest index or may correspond to the USS set with the smallest index. The second CORESET may have the same ‘typeD’ property as the first CORESET. The repetition may be applied for the PDCCH. The fact that the repetition is applied for the PDCCH may mean that two-QCLTypeDforPDCCHRepetition is provided.

In the case that the first search space set is linked to the second search space set, the terminal apparatus 1 may detect that one of two PDCCH receptions which ends later is the DCI format.

A MAC protocol data unit (PDU) may be a bit string that is byte aligned (in other words, a multiple of 8 bits) in length. A MAC service data unit (SDU) may be a bit string that is byte aligned (in other words, a multiple of 8 bits) in length. One MAC SDU may be included into one MAC PDU from the first bit onward. The MAC CE may be a bit string that is byte aligned (in other words, a multiple of 8 bits) in length. A MAC subheader may be a bit string that is byte aligned (in other words, a multiple of 8 bits) in length. Each MAC subheader may be placed immediately before the corresponding MAC SDU, MAC CE, or padding.

The MAC protocol data unit (PDU) may include one or multiple MAC subPDUs. Each MAC subPDU may include one MAC subheader. Each MACsubPDU may include one MAC subheader and one MAC service data unit (SDU). Each MAC subPDU may include one MAC subheader and one MAC CE. Each MAC subPDU may include one MAC subheader and padding. The MAC SDU may have a variable size. Each MAC subheader may correspond to one MAC SDU, one MAC CE, or padding. One MAC PDU may be one transport block.

A first MAC CE may be an activation command A. The first MAC CE may be a MAC CE for activation or deactivation of a TCI state for a PDSCH (a UE-specific PDSCH). The MAC CE for the activation/deactivation of the TCI state for the PDSCH may be identified by a first MAC subheader. For example, the first MAC subheader may involve a first Logical channel ID (LCID). For example, a value of the first LCID may be “TCI States Activation/Deactivation for UE-specific PDSCH”.

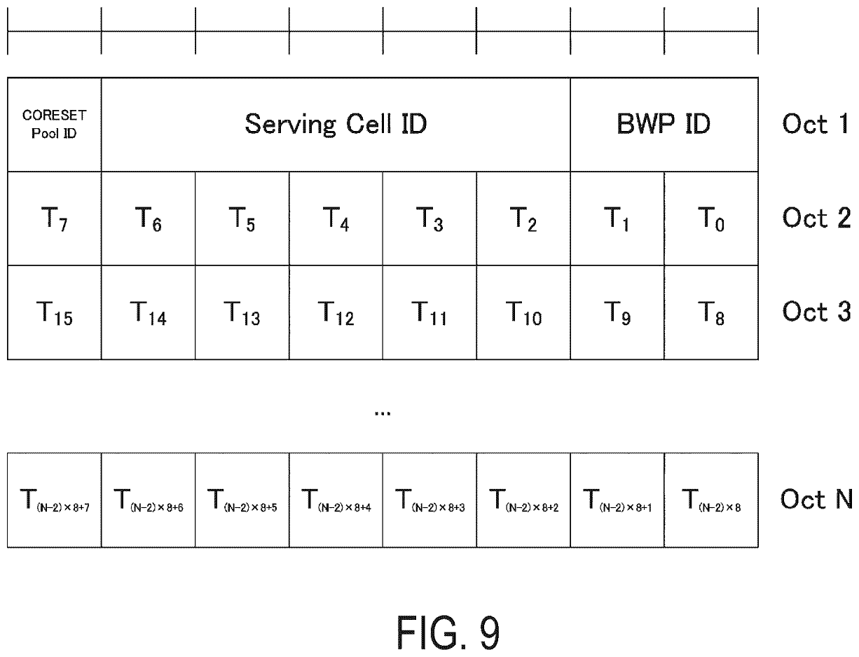

FIG. 9 is a diagram illustrating an example of the activation command A according to an aspect of the present embodiment. A field of a serving cell ID may indicate an identifier of a serving cell to which the first MAC CE is applied. A field of a BWP ID may indicate a DL BWP to which the MAC CE is applied as a codepoint of the ‘bandwidth part indicator field’ of the DCI. In a case that the first MAC CE is applied to a set of multiple serving cells, the field of the BWP ID may be disregarded. A field of “Tᵢ” may indicate an activation/deactivation status of a TCI state with a TCI state ID i. The field of “Tᵢ” set to 1 may indicate that the TCI state with the TCI state ID i is activated. The field of “Tᵢ” set to 1 may indicate that the TCI state with the TCI state ID i is mapped to one codepoint of ‘Transmission Configuration Indication field’ of the DCI. The field of “Tᵢ” set to 0 may indicate that the TCI state with the TCI state ID i is deactivated. The field of “Tᵢ” set to 1 may indicate that the TCI state with the TCI state ID i is not mapped to one codepoint of ‘Transmission Configuration Indication field’ of the DCI. i may be a TCI state ID (or TCI-StateID). The TCI state may involve a TCI state ID. A maximum number of “activated TCI states” may be eight. A field of the CORESET pool ID may indicate that first mapping is specific to a CORESET ID (ControlResourceSetId) configured with a CORESET pool ID (CORESET pool index). The first mapping may be mapping between the “activated TCI state” and the codepoint of the DCI ‘Transmission Configuration Indication’ set by the “Tᵢ” field. The field of the CORESET pool ID set to 1 may indicate that the first MAC CE is applied to a downlink transmission scheduled by the CORESET with the CORESET pool ID (CORESET pool index) having a value of 1. The field of the CORESET pool ID set to 0 may indicate that the first MAC CE is applied to a downlink transmission scheduled by the CORESET with the CORESET pool ID (CORESET pool index) having a value of 0. In a case that the CORESET pool index (coresetPoolIndex) is not configured, the field of the CORESET pool ID in the first MAC CE may be disregarded.

A second MAC CE may be an activation command B. The second MAC CE may be a MAC CE for activation or deactivation of a TCI state for a PDSCH (a UE-specific PDSCH). The MAC CE for the activation/deactivation of the TCI state for the PDSCH may be identified by a second MAC subheader. For example, the second MAC subheader may involve a second Logical channel ID (LCID). The second LCID may be an eLCID. For example, a value of the second LCID may be “Enhanced TCI States Activation/Deactivation for UE-specific PDSCH”.

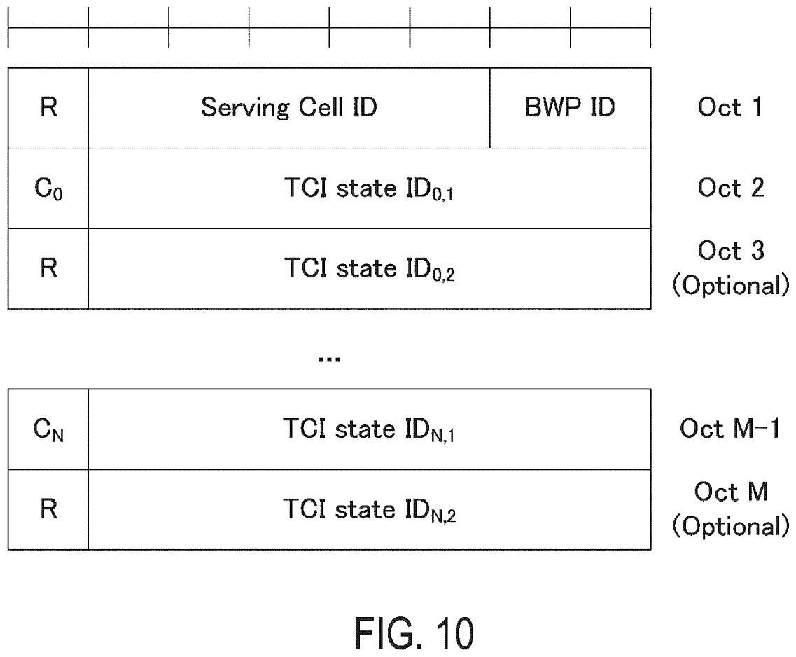

FIG. 10 is a diagram illustrating an example of the activation command B according to an aspect of the present embodiment. A field of “Ci” may indicate whether an octet including the TCI state ID_{i, 2} is present. For example, in a case that the field of “Cᵢ” is set to 1, an octet including the TCI state ID_{i, 2} may be present. For example, in a case that the field of “Cᵢ” is set to 0, the octet including the TCI state ID_{i, 2} need not be present. The field of the TCI state ID_{i, j} may indicate a TCI state identified by the TCI state ID (TCI-StateId). The TCI state ID_{i, j} may represent the j-th TCI state indicated for the i-th codepoint of the DCI ‘Transmission configuration indication’ field. The TCI state ID_{i, 2} may be optional based on the indication of the “Cᵢ” field. i may be an index of a codepoint of the DCI ‘Transmission configuration indicatin’ field. j may be 1 or 2.

A third MAC CE may be an activation command C. The third MAC CE may be a MAC CE for activation or deactivation of a unified TCI state. The MAC CE for the activation/deactivation of the unified TCI state may be identified by a third MAC subheader. For example, the third MAC subheader may involve a third Logical channel ID (LCID). The third LCID may be an eLCID. For example, a value of the third LCID may be “Unified TCI States Activation/Deactivation MAC CE”.

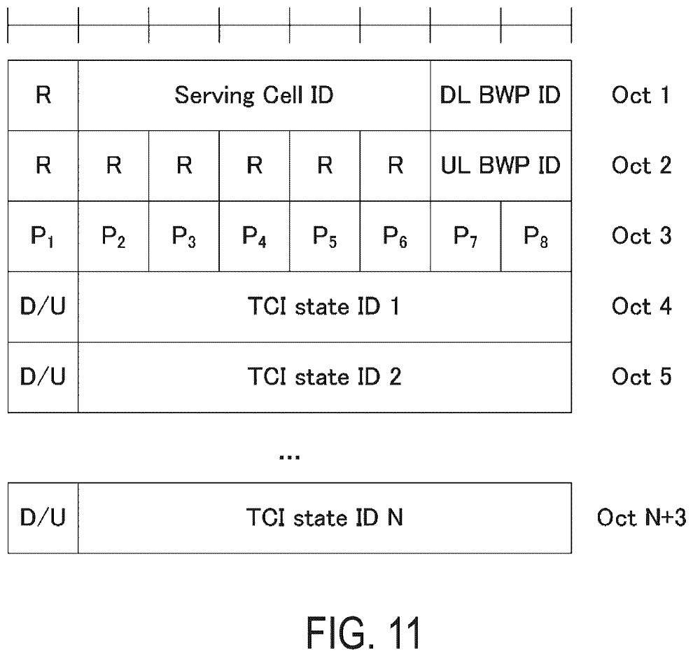

FIG. 11 is a diagram illustrating an example of the activation command C according to an aspect of the present embodiment. A field of a DL BWP ID may indicate one downlink BWP to which the MAC CE is applied as one codepoint of the DCI ‘bandwidth part indicator’ field. A field of a UL BWP ID may indicate one uplink BWP to which the MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/U” may indicate whether the TCI state ID in the same octet is for joint (both DL and UL)/DL or UL. For example, in a case that the “D/U” field is set to 1, the TCI state ID in the same octet may be for DL/joint. For example, in a case that the “D/U” field is set to 0, the TCI state ID in the same octet may be for UL. A “TCI state ID” field may indicate a TCI state identified by the TCI state ID (TCI-StateId). In a case that the “D/U” field is set to 1, a 7-bit long “TCI state ID” may be used. In a case that the “D/U” field is set to 0, the most significant bit of the “TCI state ID” may be regarded as reserved and the remaining 6 bits may indicate the ID of the UL-TCIState (UL-TCIState-Id). The DL TCI state may be a TCI state applied to some or all of the PDSCH, the PDCCH, and the CSI-RS. The UL TCI state may be a TCI state applied to some or all of the PUSCH, the PUCCH, and the SRS. The Joint TCI state may be a TCI state representing both the DL TCI state and the UL TCI state. DLorJointTCIState may be a DL TCI state or a Joint TCI state. UL-TCIState may be a UL TCI state. The DL TCI state may be a TCI state for DL. The Joint TCI state may be a TCI state for both DL and UL. The UL TCI state may be a TCI state for UL. The TCI codepoint may be a codepoint of the DCI ‘Transmission configuration indication’ field. An “R” field in the MAC CE may be a reserved bit. The reserved bit may be set to 0.

A fourth MAC CE may be an activation command D. A fifth MAC CE may be an activation command E. The fourth MAC CE may be a MAC CE for activation or deactivation of a unified TCI state. For example, the fourth MAC CE may be a MAC CE for activation or deactivation of an enhanced unified TCI state. The fifth MAC CE may be a MAC CE for activation or deactivation of a unified TCI state. For example, the fifth MAC CE may be a MAC CE for activation or deactivation of an enhanced unified TCI state. The MAC CE for the activation/deactivation of the unified TCI state may be identified by a fourth MAC subheader. The MAC CE for the activation/deactivation of the unified TCI state may be identified by a fifth MAC subheader. For example, the fourth MAC subheader may involve a fourth Logical channel ID (LCID). For example, the fifth MAC subheader may involve a fifth Logical channel ID (LCID). The fourth LCID may be an eLCID. The fifth LCID may be an eLCID. For example, a value of the fourth LCID may be “Enhanced unified TCI States Activation/Deactivation MAC CE 1”. For example, a value of the fifth LCID may be “Enhanced unified TCI States Activation/Deactivation MAC CE 2”.

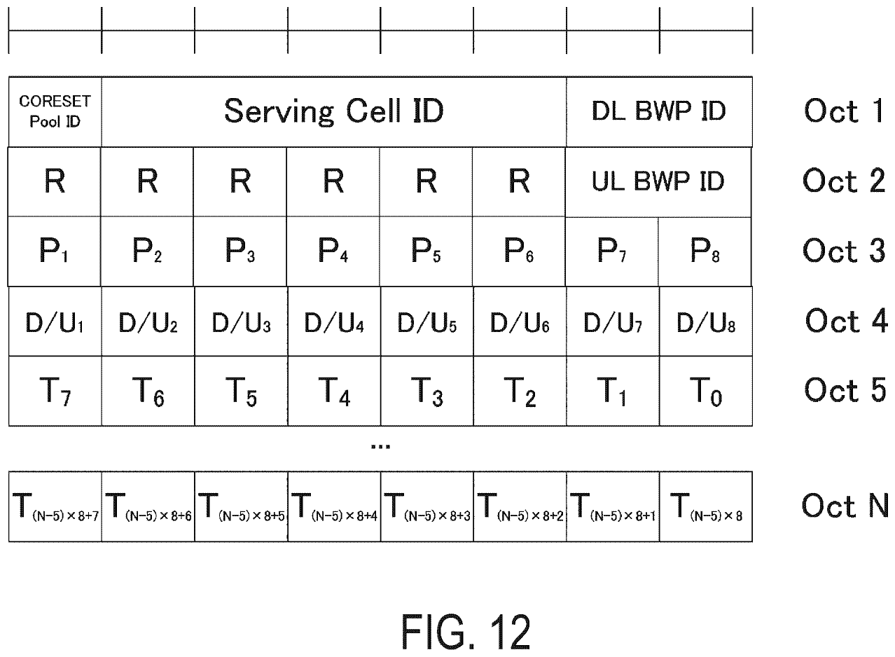

FIG. 12 is a diagram illustrating an example of the activation command D according to an aspect of the present embodiment. A field of a serving cell ID may indicate an identifier of a serving cell to which the fourth MAC CE is applied. A field of a DL BWP ID may indicate one downlink BWP to which the fourth MAC CE is applied. A field of a DL BWP ID may indicate one downlink BWP to which the fourth MAC CE is applied as one codepoint of the DCI ‘bandwidth part indicator’ field. A field of a UL BWP ID may indicate one uplink BWP to which the fourth MAC CE is applied. A field of a UL BWP ID may indicate one uplink BWP to which the fourth MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/U;” may indicate whether each TCI codepoint is for joint (both DL and UL)/DL or UL. For example, in a case that the “D/Uᵢ” field is set to 1, the i-th TCI codepoint may be for DL/joint. For example, in a case that the “D/Uᵢ” field is set to 0, the i-th TCI codepoint may be for UL. A field of “Tⱼ” may indicate an activation/deactivation status of a TCI state with a TCI state ID j. The field of “Tⱼ” set to 1 may indicate that the TCI state with the TCI state ID j is activated. The field of “Tⱼ” set to 1 may indicate that the TCI state with the TCI state ID j is mapped to one codepoint of ‘Transmission Configuration Indication field’ of the DCI. The field of “Tⱼ” set to 0 may indicate that the TCI state with the TCI state ID j is deactivated. The field of “Tⱼ” set to 1 may indicate that the TCI state with the TCI state ID j is not mapped to one codepoint of ‘Transmission Configuration Indication field’ of the DCI. j may be a UL TCI state ID (UL-TCIState-Id) or a DL/Joint TCI state ID (DLorJoint-TCIState-Id). The number of UL TCI state IDs may be up to 64. The number of DL/Joint TCI state IDs may be up to 128. j may be {0, . . . , 63}. j may be {0, . . . , 127.j may be {0, . . . , 191}. For example, in a case that the i-th TCI codepoint corresponds to a UL TCI state, the field of “Tⱼ” may indicate an activation/deactivation status of a TCI state with the TCI state ID j-128. For example, in a case that the i-th TCI codepoint corresponds to a DL TCI state or a Joint TCI state, the field of “Tⱼ” may indicate an activation/deactivation status of a TCI state with the TCI state ID j-64. For example, in the case that the i-th TCI codepoint corresponds to a UL TCI state, the field of “Tⱼ” set to 1 may indicate that the TCI state with the TCI state ID j-128 is activated. For example, in the case that the i-th TCI codepoint corresponds to a UL TCI state, the field of “Tⱼ” set to 1 may indicate that the TCI state with the TCI state ID j-128 is mapped to the i-th TCI codepoint. For example, in the case that the i-th TCI codepoint corresponds to a DL TCI state or a Joint TCI state, the field of “Tⱼ” set to 1 may indicate that the TCI state with the TCI state ID j-64 is activated. For example, in the case that the i-th TCI codepoint corresponds to a DL TCI state or a Joint TCI state, the field of “Tⱼ” set to 1 may indicate that the TCI state with the TCI state ID j-64 is mapped to the i-th TCI codepoint. The field of the CORESET pool ID may indicate that second mapping is specific to a CORESET ID (ControlResourceSetId) configured with a CORESET pool ID (CORESET pool index). The second mapping may be mapping between the “activated TCI state” and the codepoint of the DCI ‘Transmission Configuration Indication’ set by the “Tᵢ” field. The field of the CORESET pool ID set to 1 may indicate that the MAC CE is applied to a downlink or uplink transmission scheduled by the CORESET with the CORESET pool ID (CORESET pool index) having a value of 1. The field of the CORESET pool ID set to 0 may indicate that the MAC CE is applied to a downlink or uplink transmission scheduled by the CORESET with the CORESET pool ID (CORESET pool index) having a value of 0. In the case that the CORESET pool index (coresetPoolIndex) is not configured, the field of the CORESET pool ID in the fourth MAC CE may be disregarded.

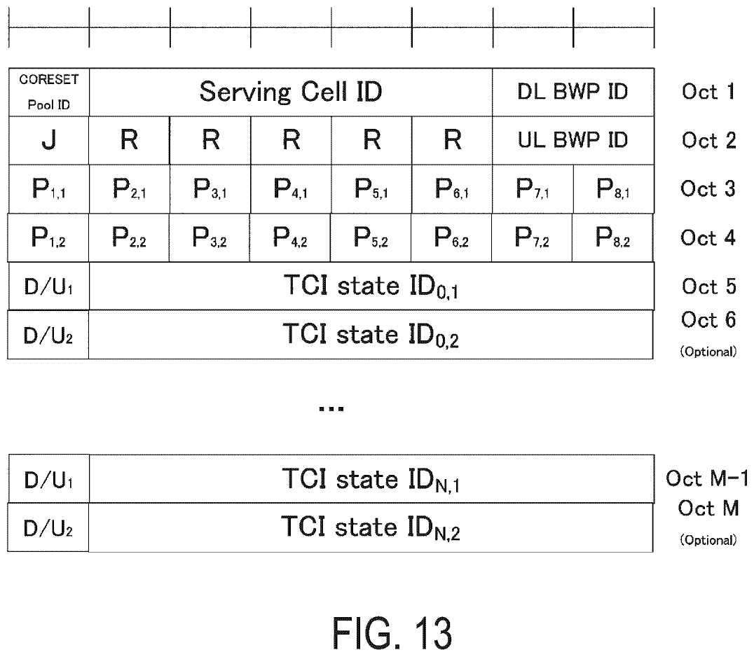

FIG. 13 is a diagram illustrating an example of the activation command E according to an aspect of the present embodiment. A field of a CORESET pool ID in FIG. 13 may be reserved. A field of “P_{i, j}” may indicate whether each TCI codepoint has multiple TCI states or one TCI state. For example, in a case that the “P_{i, j}” field is set to 1, the j-th TCI state in the i-th TCI codepoint may include two TCI states (e.g., DL TCI state and UL TCI state). For example, in a case that the “P_{i, j}” field is set to 0, the j-th TCI state in the i-th TCI codepoint may include one TCI state (e.g., DL TCI state or UL TCI state). A field of “D/U;” may indicate whether the TCI state ID in the same octet is for joint (both DL and UL)/DL or UL. The field of “D/U;” may indicate whether the TCI state ID in the same octet is for joint (both DL and UL)/DL or UL. For example, in a case that the “D/Uⱼ” field is set to 1, the TCI state ID in the same octet may be for DL/joint. For example, in a case that the “D/Uⱼ” field is set to 0, the TCI state ID in the same octet may be for UL. A “TCI state ID_{i, j}” field may indicate a TCI state identified by the DL/Joint TCI state ID (TCI-StateId) or the UL TCI state ID (UL-TCIState-Id). In a case that the “D/Uⱼ” field is set to 1, a 7-bit long “TCI state ID_{i, j}” may be used. In a case that the “D/Uⱼ” field is set to 0, the most significant bit of the “TCI state ID_{i, j}” may be regarded as reserved and the remaining 6 bits may indicate the ID of the UL-TCIState (UL TCI state, UL-TCIState-Id).

j in FIG. 13 may correspond to a CORESET pool ID (CORESET pool index). For example, j=1 may correspond to a CORESET pool ID (CORESET pool index)=0. For example, j=2 may correspond to a CORESET pool ID (CORESET pool index)=1. For example, j=0 may correspond to a CORESET pool ID (CORESET pool index)=0. For example, j=1 may correspond to a CORESET pool ID (CORESET pool index)=1. Whether j corresponds to a CORESET pool ID (CORESET pool index) may be determined according to the “J” field. For example, in a case that the “J” field is set to 1, j may correspond to a CORESET pool ID (CORESET pool index). For example, in a case that the “J” field is set to 0, j may correspond to an index of a TCI state in one codepoint. The field of “P_{i, j}” may indicate whether each TCI codepoint of the DCI associated with the CORESET pool ID corresponding to j has multiple TCI states or one TCI state. For example, in a case that the “P_{i, j}” field is set to 1, the i-th TCI codepoint of the DCI associated with the CORESET pool ID corresponding to j may correspond to both the DL TCI state and the UL TCI state. For example, in a case that the “P_{i, j}” field is set to 0, the i-th TCI codepoint of the DCI associated with the CORESET pool ID corresponding to j may correspond to one of the DL TCI state and the UL TCI state. In a case that the CORESET pool index (higher layer parameter coresetPoolIndex) is not configured, j need not correspond to the CORESET pool ID.

An activation command F may be a MAC CE for TCI state indication for a PDCCH. The activation command F may include a 5-bit serving cell ID, a 4-bit CORESET ID, and a 7-bit TCI state ID.

An activation command G may be a MAC CE for TCI state indication for a PDCCH. The activation command G may include a 5-bit serving cell ID, a 4-bit CORESET ID, a first 7-bit TCI state ID, and a second 7-bit TCI state ID. In a case that one or multiple CORESETs in one BWP are configured with different CORESET pool index values, the activation command G need not be applied to the one or multiple CORESETs. In a case that the SFN is applied for the PDCCH, the activation command G may be applied. The fact that the SFN for the PDCCH is applied may mean that sfnSchemePdcch is configured.

The terminal apparatus 1 may receive an activation command. The activation command may be a general term for the activation commands A, B, C, D, E, F, and G.

A UL slot may be a slot including a UL symbol. A special slot may be a slot including a UL symbol, a flexible symbol, and a DL symbol. A DL slot may be a slot including a DL symbol.

The UL symbol may be an OFDM symbol configured or indicated for uplink in time division duplex. The UL symbol may be an OFDM symbol configured or indicated for the PUSCH, the PUCCH, the PRACH, or the SRS. The UL symbol may be provided by a higher layer parameter tdd-UL-DL-ConfigurationCommon. The UL symbol may be provided by a higher layer parameter tdd-UL-DL-ConfigurationDedicated. The UL slot may be provided by the higher layer parameter tdd-UL-DL-ConfigurationCommon. The UL slot may be provided by the higher layer parameter tdd-UL-DL-ConfigurationDedicated.

The DL symbol may be an OFDM symbol configured or indicated for downlink in time division duplex. The DL symbol may be an OFDM symbol configured or indicated for the PDSCH or the PDCCH. The DL symbol may be provided by the higher layer parameter tdd-UL-DL-ConfigurationCommon. The DL symbol may be provided by the higher layer parameter tdd-UL-DL-ConfigurationDedicated. The DL slot may be provided by the higher layer parameter tdd-UL-DL-ConfigurationCommon. The DL slot may be provided by the higher layer parameter tdd-UL-DL-ConfigurationDedicated.

The flexible symbol may be an OFDM symbol that is not configured or indicated as a UL symbol or a DL symbol among the OFDM symbols within a certain periodicity. The certain periodicity may be a periodicity given by a higher layer parameter dl-UL-TransmissionPeriodicity. The flexible symbol may be an OFDM symbol configured or indicated for the PDSCH, the PDCCH, the PUSCH, the PUCCH, or the PRACH.

The higher layer parameter tdd-UL-DL-ConfigurationCommon may be a parameter for configuring one of a UL slot, a DL slot, and a special slot for each of one or multiple slots. The higher layer parameter tdd-UL-DL-ConfigurationDedicated may be a parameter for configuring any one of a UL symbol, a DL symbol, and a flexible symbol for a flexible symbol in each of the one or multiple slots. tdd-UL-DL-ConfigurationCommon may be a common higher layer parameter. tdd-UL-DL-ConfigurationDedicated may be a dedicated higher layer parameter.

Multiple Transmission Reception Points (Transmit/Receive Points or TRPs) may be used. The base station apparatus 3 may include multiple TRPs (Multi-TRP). The terminal apparatus 1 may be scheduled by two TRPs in one serving cell. In Multi-TRP, the operation mode of one of single-DCI and multi-DCI may be used. In Multi-TRP, uplink control may be completed in the MAC layer and the physical layer. In Multi-TRP, downlink control may be completed in the MAC layer and the physical layer. In the Single-DCI mode, the terminal apparatus 1 may be scheduled by the same DCI for two TRPs. In a Multi-DCI mode, the terminal apparatus 1 may be scheduled by independent DCI from each TRP. Each TRP in the Multi-TRP may be identified by TRP information. In other words, one TRP in the Multi-TRP may be identified by one piece of TRP information. The TRP information may be used to select one TRP.

A value of a Timing advance offset (TA offset) may be provided by a higher layer parameter. A Timing advance (TA) may be determined based at least on a TA offset. In one serving cell, one TA offset may be provided. In one serving cell, two TA offsets may be provided. In a case that no higher layer parameter is provided, the terminal apparatus 1 may determine the value of the TA offset. The terminal apparatus 1 may determine values of two TA offsets in one serving cell. The value of the TA offsets may be N_{TA,offset}. A higher layer parameter may be n-TimingAdvanceOffset. The determination of the TA may be adjustment of an uplink timing. In other words, the uplink timing may be referred to as a TA.

In a case that two uplink carriers are configured in one serving cell, the value of one TA offset may be applied to the two uplink carriers. In a case that two Transmission Reception Points (TRPs) are configured in one serving cell, a value of one TA offset may be applied to the two TRPs. In a case that two TRPs are configured in one serving cell, values of two TA offsets may be applied to the two TRPs, respectively.

The terminal apparatus 1 may adjust the uplink timing. For example, the terminal apparatus 1 may adjust the uplink timing in response to reception of a Timing advance command (TA command). For example, in response to the reception of one Timing advance command (TA command) for one Timing advance group (TAG), the terminal apparatus 1 may adjust the uplink timing for PUSCH/SRS/PUCCH transmission in all serving cells in one TAG. For example, in response to the reception of one TA command for one TAG, the terminal apparatus 1 may adjust the uplink timing for the PUSCH/SRS/PUCCH transmission in one or multiple serving cells belonging to one TAG. For example, the terminal apparatus 1 may adjust the uplink timing based on the value of NTA, offset. NTA, offset may be the same for all serving cells in one TAG. NTA, offset need not be the same for all serving cells in one TAG. In addition, the terminal apparatus 1 may adjust the uplink timing based on one or both of the value of NTA, offset and a TA command. The uplink timing may be the same for all serving cells in one TAG. The uplink timing need not be the same for all serving cells in one TAG. For example, a first uplink timing may be the same for a first portion of the serving cells in one TAG. For example, a second uplink timing may be the same for a second portion of the serving cells in one TAG. All serving cells in one TAG may be divided into the first portion and a second portion.

In response to the reception of one Timing advance command (TA command) for one subTAG, the terminal apparatus 1 may adjust the uplink timing for PUSCH/SRS/PUCCH transmission corresponding to one subTAG (or subTAG ID). For example, in response to the reception of one TA command for one subTAG, the terminal apparatus 1 may adjust the uplink timing for the PUSCH/SRS/PUCCH transmission in one or multiple serving cells belonging to one subTAG or TRPs. NTA, offset may be the same for all serving cells in one subTAG. The uplink timing may be the same for all serving cells in one subTAG. In one serving cell, two subTAGs may be used.

The terminal apparatus 1 may determine the uplink timing based on at least some or all of a TA command, a TA offset, and TRP information. The first uplink timing and the second uplink timing may be determined based at least on the TRP information. For example, Transmission Reception Point (TRP) information may be information for identifying one TRP among one or multiple TRPs. For example, the TRP information may be an index for identifying one TRP. For example, one TRP may be determined based on the TRP information. For example, the TRP information may be information for identifying one or multiple TRPs. The TRP information may be provided by a higher layer parameter. The TRP information may be included in a random access response. The TRP information may be included in a DCI format. The TRP information may be a CORESET pool index. The TRP information may be associated with an index of the CORESET resource pool. For example, a first CORESET pool index may be associated with a first TRP and a second CORESET pool index may be associated with a second TRP. The TRP information may be associated with a TCI state. The TRP information may be associated with a pool (or pool index) of the TCI state. The first one or multiple TCI states may be associated with a pool index of the first TCI state. The second one or multiple TCI states may be associated with a pool index of the second TCI state. The TRP information may be a TAG ID (subTAG ID). For example, a first TAG ID (subTAG ID) may be associated with the first TRP, and a second TAG ID (subTAG ID) may be associated with the second TRP.

The Tag ID may be used to identify the TAG or the subTAG.

The first uplink timing may be determined based on a Timing adjustment indication for one TAG from an MCG. The second uplink timing may be determined based on a timing adjustment indication for one TAG from an SCG. The first and second uplink timings may be determined based on a timing adjustment indication for two TAGs from an MCG.

The TA command may be modified based on a subcarrier spacing. For example, in a subcarrier spacing configuration μ, one TA command for one TAG may indicate a change in an uplink timing. For example, the uplink timing may be changed by a multiple of 16*64*T_{c}/2″. “*” may be a multiplication operator.

A Timing advance (TA) of a random access preamble may be 0.

The TA command may be included in a random access response. For example, a TA command for one TAG (or subTAG) may be included in a random access response associated with one TAG (or subTAG). For example, a TA command associated with one piece of TRP information may be included in a random access response in a random access procedure associated with one piece of TRP information. The TA command may be transmitted as a MAC CE command. For example, the TA command may be an Absolute timing advance command MAC CE. The random access response or the TA command TA in case of an Absolute timing advance command MAC CE may indicate the value of N_{TA} for one TAG. For example, T_{A} may be an integer from 0 to 3846. For example, N_{TA} may be TA * 16 * 64/2″. NTA may be associated with a subcarrier spacing of certain uplink transmission. For example, the certain uplink transmission may be uplink transmission from the terminal apparatus 1. For example, the certain uplink transmission may be first uplink transmission after receiving a random access response. For example, the certain uplink transmission may be the first uplink transmission after reception of an absolute timing advance command MAC CE. T_{A} may be an index value. The uplink transmission may be uplink channel transmission. In the random access procedure, whether to receive the Absolute timing advance command MAC CE or receive the random access response may be determined by a higher layer parameter. For example, the random access procedure may be initiated (triggered) by a PDCCH order.

The TA command T_{A} may indicate adjustment of the current N_{TA} value for one TAG. For example, the TA command T_{A} may indicate adjustment from N_{TA,old} to N_{TA,new}. N_{TA,new} may be N_{TA,old}+(T_{A}31)*16*64/2^{μ}. For example, T_{A} may be an integer from 0 to 63.

In a case that the terminal apparatus has one or multiple active uplink BWPs, the TA command (TA command value) may be associated with the maximum subcarrier spacing of the one or multiple active uplink BWPs. The TA command may be a TA command in one TAG including uplink BWPs on two uplink carriers of one serving cell. For example, N_{TA,new} for one uplink BWP with the first subcarrier spacing may be rounded to match the timing advance (TA) granularity for one uplink BWP with the first subcarrier spacing. The rounding of the value may be rounding of the value. For example, N_{TA,new} may be rounded while maintaining Timing advance (TA) accuracy requirements.

Adjustment of N_{TA} to a positive value may indicate advancing of an uplink transmission timing (uplink timing) for one Timing advance group (TAG). Adjustment of N_{TA} to a negative value may indicate delaying of an uplink transmission timing for one TAG.

In a case that one TA command is received in a first slot n, adjustment of the uplink transmission timing may be applied from the beginning of the second slot. The first slot n may be an uplink slot. The uplink slot may be a slot corresponding to an uplink frame. The second slot may be n+k+1+24*Koffset. That is, the second slot may be a slot after k+1+2^{μ}*K_{offset} slots from the first slot n. K_{offset} may be provided by a higher layer parameter. k may be ceil (N^{subframe,μ}ₛₗₒₜ·(N_{T,1}+N_{T,2}+N_{TA,max}+0.5)/T_{sf}). The unit of N_{T, 1} may be milliseconds. N_{T, 1} may be the unit period of milliseconds of N₁ symbols. The N₁ symbols may correspond to a PDSCH processing time. N_{T, 2} may be the unit period of milliseconds of N₂ symbols. The N₂ symbols may correspond to a PUSCH preparation time. N_{TA,max} may be a maximum timing advance (TA) value in the unit period of milliseconds. N_{TA,max} may be a maximum TA value that can be provided by a 12-bit TA command field. N^{subframe,μ}ₛₗₒₜ may be the number of slots in one subframe. T_{sf} may be one millisecond. T_{sf} may be the period of a subframe. K_{offset} may be K_{cell,offset}-K_{UE,offset}. K_{cell,offset} may be provided by a higher layer parameter. K_{UE,offset} may be provided by one MAC CE command. K_{cell,offset} may be 0. K_{UE,offset} may be 0. One or both of N₁ and N₂ may be determined in association with the minimum Subcarrier spacing (SCS). The minimum subcarrier spacing may be a minimum subcarrier spacing among subcarrier spacings of all configured downlink BWPs and all configured uplink BWPs. In a case of μ=0, N₁ may be 14. The slot n and N^{subframe,μ}ₛₗₒₜ may be determined in association with the minimum subcarrier spacing. N_{TA,max} may be determined in association with the minimum subcarrier spacing. The slot n may be the last slot among one or multiple slots that overlap with the slot for PDSCH reception. For PDSCH reception, it may be assumed that T_{TA}=0. One TA command may be received on the PDSCH. A PDSCH including one TA command may be received. The PDSCH may provide one TA command.

In a case that the terminal apparatus 1 changes the active uplink BWP, the terminal apparatus 1 may determine the TA command (the TA command value) based on the subcarrier spacing of the changed active uplink BWP. For example, in a case that the terminal apparatus 1 changes the active uplink BWP in the period from the time the TA command is received to the time the adjustment for the uplink transmission timing is applied, the terminal apparatus 1 may determine the TA command based on the subcarrier spacing of the new active uplink BWP. In a case that the active uplink BWP is changed after the adjustment for the uplink transmission timing is applied, the terminal apparatus 1 may assume the same absolute timing advance command value (absolute timing advance command MAC CE). That is, the first absolute timing advance command value before the active uplink BWP is changed may be the same as the second absolute timing advance command value after the active uplink BWP is changed.

In a case that the downlink timing is changed and in a case that the downlink timing is not corrected, the terminal apparatus 1 may change N_{TA}. In a case that the downlink timing is changed and in a case that the downlink timing is partially corrected by the uplink timing adjustment without the TA command, the terminal apparatus 1 may change NTA. The uplink timing adjustment may be determination or change of the uplink timing.

In a case that two adjacent slots are overlapped by one TA command, the latter slot may be reduced. In a case that the start of the first slot is started within X symbols from the end of the second slot, the first slot may be reduced. The X symbols may be determined based at least on one or both of the subcarrier spacing and the terminal capability.

A timing advance group (TAG) may be a group of one or multiple serving cells. One or multiple serving cells may be configured by RRC. The one or multiple serving cells may use one TA value. The one or multiple serving cells may use one timing reference cell. A primary TAG (PTAG) may be a TAG including an SpCell. A secondary TAG (STAG) may be a TAG not including an SpCell. The one or multiple serving cells may use two TA values. One TAG may include two subTAGs.

A subTAG may be one serving cell or a group of multiple serving cells. A subTAG may be a group of serving cells using the same TA (TA value). For example, a subTAG may be associated with one piece of TRP information. For example, a subTAG may be associated with one TRP. A serving cell associated with a subTAG need not be associated with a TAG. For example, a subTAG may be configured for one serving cell. For example, a serving cell associated with a subTAG may be associated with a TAG. A subTAG may be a group of one or multiple TRPs. A subTAG may be a group of TRPs using the same TA (TA value). For example, a subTAG may be associated with one serving cell. A subTAG may be a TA group for one serving cell. In one serving cell, two subTAGs may be provided, configured, or determined. In each subTAG, a subTAG ID may be determined. A subTAG may be a type of TAG. That is, a TAG and a subTAG may be referred to as a TAG.

The RRC layer may configure one or multiple higher layer parameters for maintenance of uplink time alignment. For example, the RRC layer may configure a time alignment timer. For example, the time alignment timer may be configured by a higher layer parameter timeAlignmentTimer. The time alignment timer may control a first time. The first time may be a time at which a MAC entity regards multiple serving cells as belonging to an associated TAG.

For example, the time alignment timer may be a time for uplink time alignment. That is, the fact that the time alignment timer is operating may mean that time alignment has been achieved. The time alignment may mean that an uplink timing is determined (or adjusted). That is, TA may be time alignment.

The RRC layer may configure one or multiple higher layer parameters for maintenance of multiple times of uplink time alignment. For example, the RRC layer may configure multiple time alignment timers. At least one of the multiple time alignment timers may be associated with a subTAG. At least one of the multiple time alignment timers may be associated with a TAG.

The time alignment timers may correspond to one subTAG. For example, the time alignment timer may control the time at which the MAC entity regards one or multiple serving cells as belonging to the subTAG. For example, the time alignment timer may control the time at which the MAC entity regards one or multiple TRPs as belonging to the subTAG.

The Mac entity may perform some or all of the first to fourth processing operations.

In the first processing, in a case that a Timing advance command MAC CE (TA command MAC CE) is received and NTA is carried in the indicated TAG, the MAC entity may apply the TA command for the indicated TAG. In the first processing, in a case that a Timing advance command MAC CE (TA command MAC CE) is received and NTA is carried in the indicated TAG, the MAC entity may start or restart the time alignment timer associated with the indicated TA command. The time alignment timer may be timeAlignmentTimer.

The second processing may be processing performed in a case that the TA command is received in a random access response (random access response message). The second processing may be processing in a case that a TA command is received in a message B (MSGB). The second processing may be processing in one serving cell belonging to one TAG (or subTAG).

The second processing may be processing in the SpCell. In the second processing, in a case that a Random access preamble is not selected from preambles in a Contention-based random access (CBRA), the MAC entity may apply a TA command for one TAG (or subTAG) or may start or restart a time alignment timer associated with one TAG (or subTAG). The TA command may be received in a random access response.

In the second processing, in a case that the time alignment timer associated with one TAG (or subTAG) is not running, the MAC entity may apply the TA command for one TAG (or subTAG) and may start the time alignment timer. Furthermore, in a case that Contention resolution is not successfully completed, the MAC entity may stop the time alignment timer.

In the second processing, in a case that the time alignment timer associated with one subTAG is not running, the MAC entity may apply a TA command in a random access response in a first random access procedure, and may start the time alignment timer. Furthermore, in a case that contention resolution is not successfully completed, the MAC entity may stop the time alignment timer. The first random access procedure may be a random access procedure associated with one subTAG. The first random access procedure may be a random access procedure for TA acquisition.

In the second processing, in a case that the random access preamble is selected from the preamble in the CBRA and in a case that the time alignment timer associated with one TAG (or subTAG) is running, the MAC entity may ignore the received TA command.

In the third processing, in a case that an Absolute Timing Advance (TA) Command is received in response to a message A (MSGA) transmission including a C-RNTI MAC CE, the MAC entity may apply the absolute TA Command for a Primary TAG (PTAG) and may start or restart a time alignment timer associated with the PTAG. In a case that the absolute TA command is received in response to a random access preamble transmission, the MAC entity may apply the absolute TA command for the TAG or the subTAG. In this case, the time alignment timer associated with the PTAG need not be started and restarted.

In the third processing, in a case that an Absolute Timing Advance (TA) Command associated with one subTAG is received in response to a message A (MSGA) transmission or a message 1 transmission including a C-RNTI MAC CE, the MAC entity may apply the absolute TA command for one subTAG and may start or restart the time alignment timer associated with one subTAG.

The fourth processing may be processing in a case that the time alignment timer expires. In the fourth processing, in a case that the time alignment timer is associated with the PTAG (or the subTAG associated with the first TRP), the MAC entity may perform some or all of the first sub-operation to the seventh sub-operation. The first sub-operation may be to flush all HARQ buffers for all serving cells. The second sub-operation may be to notify the RRC of release of PUCCHs for all serving cells. The third sub-operation may be to notify the RRC of release of SRSs for all serving cells. The fourth sub-operation may be to clear the configured downlink assignment and the configured uplink grant. The fifth sub-operation may be to clear a PUSCH resource for semi-persistent CSI reporting. The sixth sub-operation may be to regard all time alignment timers being expired. The seventh sub-operation may be to maintain NTA for all TAGS (or subTAGs). That is, in a case that the time alignment timer is not running, the MAC entity need not change NTA. In the fourth processing, in a case that the time alignment timer is associated with an STAG (or the subTAG associated with the second TRP), the MAC entity may perform some or all of the 8th sub-operation to the 13th sub-operation. The 8th sub-operation may be to flush all HARQ buffers for the serving cell belonging to this TAG (or this subTAG). The 9th sub-operation may be to notify the RRC of release of PUCCHs for the serving cell belonging to the TAG (or the subTAG). The 10th sub-operation may be to notify the RRC of release of SRSs for the serving cell belonging to the TAG (or the subTAG). The 11th sub-operation may be to clear configured downlink assignment and a configured uplink grant for the serving cell belonging to the TAG (or the subTAG). The 12th sub-operation may be to clear a PUSCH resource for a semi-persistent CSI report for the serving cell belonging to the TAG (or the subTAG). The 13th sub-operation may be to maintain NTA of the TAG (or the subTAG).

A HARQ buffer may store a MAC PDU to be transmitted. One HARQ buffer may be associated with one HARQ process. One HARQ process may correspond to one HARQ process ID. To flush a HARQ buffer may be to empty a HARQ buffer. In a case that a HARQ entity requests new transmission for one transport block, the HARQ process may store the MAC PDU in the associated HARQ buffer.

In a case that the MAC entity stops uplink transmission for the SCell to exceed the Maximum uplink transmission timing difference, the MAC entity may regard that stop of the time alignment timer as being expired. The time alignment timer may be a time alignment timer associated with the SCell.

In a case that the time alignment timer expires, the MAC entity need not perform uplink transmission. In a case that the time alignment timer is not running, the MAC entity need not perform uplink transmission. The uplink transmission need not include random access preamble transmission. The uplink transmission need not include message A transmission. The uplink transmission may be uplink transmission in one serving cell. The uplink transmission may be uplink transmission in one TRP. This time alignment timer may be a time alignment timer associated with a TAG to which one serving cell belongs. This time alignment timer may be a time alignment timer associated with a subTAG to which one serving cell belongs. This time alignment timer may be a time alignment timer associated with a subTAG to which one TRP belongs.

In a case that the time alignment timer associated with one subTAG expires, the MAC entity need not perform uplink transmission for one or multiple TRPs included in the one subTAG. In a case that the time alignment timer associated with one subTAG expires, the MAC entity need not perform uplink transmission associated with the one subTAG. This uplink transmission need not include one or both of the random access preamble transmission and the message A transmission. For example, in a case that a time alignment timer associated with one piece of TRP information expires, the MAC entity need not perform uplink transmission associated with the one piece of TRP information.

In a case that the time alignment timer associated with the PTAG is not running, the MAC entity need not perform uplink transmission in any serving cell. This uplink transmission need not include random access preamble transmission in an SpCell. This uplink transmission need not include message A transmission in the SpCell.

A MAC Protocol Data Unit (PDU) may be a bit string arranged in 1 byte. The MAC PDU may be transport blocks. For example, the MAC PDU may include one or multiple MAC subPDUs. Each MAC subPDU may include one MAC subheader. Each MAC subPDU may include one MAC subheader and one MAC Service Data Unit (SDU). Each MAC subPDU may include one MAC subheader and one MAC Control Element (CE). Each MAC subPDU may include one MAC header and padding. The MAC SDU may be data from a higher layer. The MAC SDU may be data to a higher layer.

A TA command may be a MAC CE. In addition, the TA command may be included in the MAC CE. For example, the TA command may be included in a TA command MAC CE. The TA command MAC CE may include a TAG ID and a TA command. The TAG ID may indicate one or both of one TAG and one subTAG. A TAG including an SpCell may correspond to a TAG ID 0. The TAG ID may be indicated with 2 bits. The TAG ID may indicate one subTAG. The TAG ID may indicate one TRP. The TA command may indicate T_{A}. T_{A} may be an integer from 0 to 63. T_{A} may be used for controlling an amount of timing adjustment. The timing adjustment may be applied by the MAC entity. The TA command may be indicated with 6 bits. The TA command MAC CE may be identified by a MAC subheader with a certain Logical channel ID (LCID). A certain LCID may be the LCID corresponding to the index 61.

A TA command may be included in an absolute Timing advance command MAC CE (absolute TA command MAC CE). The absolute TA command MAC CE may include a reserved bit and a TA command. The TA command may indicate an index value T_{A}. T_{A} may be used for controlling an amount of timing adjustment. The TA command may be indicated with 12 bits. Reserved bits may be four bits. The value 0 may be set for the reserved bit. The absolute TA command MAC CE may include at least a TAG ID. The TAG ID may indicate one subTAG. The TAG ID may indicate one TRP. The absolute TA command MAC CE may be identified by a MAC subheader with a certain eLCID. The certain eLCID may be an eLCID corresponding to the index 316.

The TA command may be included in a random access response. For example, the TA command may be included in the MAC payload of the random access response. For example, the TA command may indicate an index value T_{A}. T_{A} may be used for controlling an amount of timing adjustment. The size of a TA command field may be 12 bits. The random access response may include the TA command, an uplink grant, and a Temporary C-RNTI. The uplink grant may indicate resources to be used in uplink. The uplink grant field may be 27 bits. The Temporary C-RNTI may indicate a temporary ID used by the MAC entity during random access. The Temporary C-RNTI field may be 16 bits. The random access response may be a MAC RAR. For example, the random access response may be fallbackRAR. The TA command may be included in a message B (MSGB). For example, the TA command may be included in the MAC payload of message B. The TA command may be included in successRAR. In addition, the random access response may include TRP information. For example, the TA corresponding to one TRP identified by the TRP information may be indicated by the TA command included in the random access response.

Random access (or a random access procedure) may be initiated by a MAC entity. The random access may be initiated by a PDCCH order (or PDCCH). The random access may be initiated by RRC. Random access in the SCell may be initiated by a PDCCH order. In addition, random access may be triggered by the MAC entity. Random access may be triggered by a PDCCH order. Random access may be triggered by RRC.

For example, random access may be triggered (initiated) by a certain event. For example, a certain event may be Initial access from an RRC_IDLE state. For example, the certain event may be an RRC connection Re-establishment procedure. For example, the certain event may be arrival of uplink or downlink data in the RRC_CONNECTED state in a case that the uplink synchronization state is ‘non-synchronized’. For example, the certain event may be arrival of uplink data in the RRC_CONNECTED state in a case that there are no PUCCH resources. For example, the certain event may be a failure of a scheduling request. For example, the certain event may be a request by RRC in response to a handover. For example, the certain event may be RRC connection Resume. For example, the certain event may be establishing Time alignment.

For example, the certain event may be establishing time alignment for an STAG. For example, the certain event may be establishing time alignment for a certain TRP. For example, the certain event may be requesting Other SI. For example, the certain event may be Beam failure recovery. For example, the certain event may be TA acquisition. For example, the certain event may be secondary TA acquisition. The certain event may be for the purpose of the random access procedure.

The random access (random access type) may be a 4-step-random access (4-step-random access type). The random access (random access type) may be a 2-step-random access (2-step-random access type). The random access may support a Contention-based random access (CBRA). That is, the random access may be CBRA. The random access may support a Contention-free random access (CFRA). That is, the random access may be CFRA. For example, the random access may be CBRA of the 4-step-random access type. For example, the random access may be CFRA of the 4-step-random access type. For example, the random access may be CBRA of the 2-step-random access type. For example, the random access may be CFRA of the 2-step-random access.

In the CBRA of the 4-step-random access type, the terminal apparatus 1 may transmit a message 1 (random access preamble), receive a message 2 (random access response), transmit a message 3, and receive a message 4 (contention resolution). In the CBRA of the 2-step-random access type, the terminal apparatus 1 may transmit a message A (random access preamble and PUSCH payload) and receive a message B (the contention resolution). In the CFRA of the 4-step-random access type, the terminal apparatus 1 may receive assignment of a random access preamble, transmit the random access preamble, and receive a random access response. In the CFRA of the 2-step-random access type, the terminal apparatus 1 may receive assignment of a random access preamble and a PUSCH, transmit the random access preamble and the PUSCH, and receive a random access response.

In a case that no CFRA resources are configured, a Reference signal received power (RSRP) Threshold may be used to select one of the 2-step-random access type and the 4-step-random access type. In a case that CFRA resources of the 4-step-random access type are configured, the terminal apparatus 1 may perform random access of the 4-step-random access type. In a case that CFRA resources of the 2-step-random access type are configured, the terminal apparatus 1 may perform random access of the 2-step-random access type.

The message 1 may include one preamble in the PRACH. After transmission of the message 1, the terminal apparatus 1 may monitor one response (random access response) within a configured window. In the CFRA, a dedicated preamble may be assigned. In the CFRA, the terminal apparatus 1 may end the random access in response to the reception of the random access response. In the CBRA, the terminal apparatus 1 may transmit the message 3 in response to the reception of the random access response. For example, the terminal apparatus 1 may transmit the message 3 by using an uplink grant (random access response grant). In the CBRA, the terminal apparatus 1 may monitor the message 4 (contention resolution). In a case that contention resolution after the transmission of the message 3 is not successful, the terminal apparatus 1 may transmit the message 1.

The message A may include one preamble in the PRACH. In addition, the message A may also include a payload in the PUSCH. After transmission of the message A, the terminal apparatus 1 may monitor one response (random access response) within a configured window. In the CFRA, the dedicated preamble and PUSCH resources for the transmission of the message A may be assigned. In the CFRA, the terminal apparatus 1 may end the random access in response to the reception of one response. In the CBRA, in a case that the contention resolution is successful, the terminal apparatus 1 may end the random access. In a case that a fallback indication is received in the message B, the terminal apparatus 1 may transmit the message 3 based on the fallback indication and monitor the contention resolution. In a case that the contention resolution after the transmission of the message 3 is not successful, the terminal apparatus 1 may transmit the message A. In a case that the random access of the 2-step-random access type is not completed, the terminal apparatus 1 may be configured to be switched to the CBRA of the 4-step-random access type.

The random access procedure may be initiated (triggered) by a PDCCH order. The random access procedure may be initiated (triggered) by the MAC. The random access procedure may be initiated (triggered) by RRC. The random access procedure in the SCell may be initiated by a PDCCH order. The random access procedure in a cell associated with an additional PCI index may be initiated by a PDCCH order.

For a MAC entity, there may be only one random access that can proceed simultaneously. In a case that first random access is in progress and in a case that second random access is triggered, the terminal apparatus 1 may continue the first random access. In a case that first random access is in progress and in a case that second random access is triggered, the terminal apparatus 1 may initiate the second random access.

The RRC may configure some or all of the first to ninth higher layer parameters for the random access. A first set of PRACH Occasions for message 1 (random access preamble) transmission may be configured by the first higher layer parameter. The first set may be used for the message A PRACH. A second set of PRACH occasions for random access preamble transmission for the message A may be configured by the first higher layer parameter. That is, the first higher layer parameter may determine an available set of PRACH occasions for transmission of random access preamble transmission. The PRACH occasions may be referred to as RA occasions. The PRACH occasions may be referred to as RACH occasions.

Some or all of the first to ninth higher layer parameters may be referred to as an RACH configuration. The RACH configuration may be configured in a higher layer parameter SI-RequestConfig, a higher layer parameter ReconfigurationWithSync, a higher layer parameter BeamFailureRecoveryConfig, a higher layer parameter RACH-ConfigCommon, a higher layer parameter TwoTA-Config1-r18, and a higher layer parameter TwoTA-Config2-r18. The RACH configuration may be included in some or all of the higher layer parameter SI-RequestConfig, the higher layer parameter ReconfigurationWithSync, the higher layer parameter BeamFailureRecoveryConfig, the higher layer parameter RACH-ConfigCommon, the higher layer parameter TwoTA-Config1-r18, and the higher layer parameter TwoTA-Config2-r18. The RACH configuration may be RACH-ConfigGeneric.

The first higher layer parameter may be prach-ConfigurationIndex. The first higher layer parameter may be configured in a configuration for the secondary TA acquisition (one or both of the higher layer parameter twoTA-Config1-r18 and the higher layer parameter twoTA-Config2-r18). The secondary TA acquisition may mean that two TAs (TAG or subTAG) are determined, provided or configured in one serving cell.

Power for the random access preamble may be configured by the third higher layer parameter. For example, power for the first (first-transmitted) random access preamble may be configured by the third higher layer parameter.

A threshold for RSRP may be configured by the fourth higher layer parameter. For example, the threshold for RSRP is SS/PBCH block selection, or. It may be a threshold for RSRP for CSI-RS selection. For example, the threshold for RSRP may be a threshold for RSRP for selecting a signal from two uplink carriers. The two uplink carriers may be of Normal Uplink (NUL) and Supplementary Uplink (SUL).

The maximum number of transmission operations of one or both of the message 1 and message A may be configured by the fifth higher layer parameter. One or both of the message 1and message A may change the transmission power for each transmission operation. For example, the power for one or both of the message 1 and message A may be changed based on the sixth higher layer parameter. The sixth higher layer parameter may be a power ramping factor.

The random access preamble may be configured by the seventh higher layer parameter.

For example, the index of the random access preamble used in the PRACH occasions may be configured by the seventh higher layer parameter. The seventh higher layer parameter may indicate any value from 0 to 63. The seventh higher layer parameter may be ra-PreambleIndex.

The number of SS/PBCH blocks mapped to each PRACH occasion may be defined by the eighth higher layer parameter. In addition, the number of CBRA random access preambles mapped to each SS/PBCH block may be defined by the eighth higher layer parameter. The CBRA random access preamble may be a Contention-based Random Access Preamble. Transmission of one or both of the message 1 and message A may use the random access preamble corresponding to group A or group B. The terminal apparatus 1, for example, may transmit the message A using a random access preamble group A. The terminal apparatus 1, for example, may transmit the message A using a random access preamble group B.

The ninth higher layer parameter may define a PRACH occasion associated with one SS/PBCH block (SSB). The MAC entity may transmit the random access preamble in the PRACH occasion. The ninth higher layer parameter may be ra-ssb-OccasionMaskIndex.

First to twelfth variables (UE variables) may be used for the random access procedure. The first variable may be PREAMBLE_INDEX. The second variable may be PREAMBLE_TRANSMISSION_COUNTER. The third variable may be PREAMBLE_POWER_RAMPING_COUNTER. The fourth variable may be PREAMBLE_POWER_RAMPING_STEP. The fifth variable may be PREAMBLE_RECEIVED_TARGET_POWER. The sixth variable may be PREAMBLE_BACKOFF. The seventh variable may be PCMAC. The eighth variable may be SCALING_FACTOR_BI. The ninth variable may be TEMPORARY_C-RNTI. The tenth variable may be RA_TYPE. The eleventh variable may be POWER_OFFSET_2STEP_RA. The twelfth variable may be MSGA_PREAMBLE_POWER_RAMPIPNG_STEP.

RA_TYPE may be set to 4-stepRA. For example, in a case that a random access procedure is initiated by a PDCCH order, and in a case that a random access preamble index (ra-PreambleIndex) is provided by a PDCCH, and in a case that the random access preamble index is not 0b000000, RA_TYPE may be set to 4-stepRA. For example, in a case that a random access procedure is initiated for an SI request and in a case that a random access resource (RACH configuration) is provided by RRC for the SI request, RA_TYPE may be set to 4-stepRA. In a case that a random access procedure is initiated for beam failure recovery (or beam failure recovery for the SpCell), and in a case that a CFRA resource corresponding to a beam failure recovery request for a 4-step random access type is provided, RA_TYPE may be set to 4-stepRA. In a case that a random access procedure is initiated for reconfiguration with sync and in a case that a CFRA resource for a 4-step random access type is provided in a higher layer parameter rach-ConfigDedicated, RA_TYPE may be set to 4-stepRA. For example, in a case that a random access procedure is initiated for the secondary TA acquisition and in a case that a random access resource (e.g., CFRA resource) is provided for the secondary TA acquisition, RA_TYPE may be set to 4-stepRA. The random access resource may be one or both of a CFRA resource and a CBRA resource. The fact that the random access resource is provided may mean that an RACH configuration is configured. The secondary TA acquisition may mean that the second TA is (or two TAs are) acquired in one serving cell. In a case that RA_TYPE is set to 4-stepRA, random access of the 4-step random access type may be performed. In a case that RA TYPE is set to 2-stepRA, random access of the 2-step random access type may be performed.

In the case that RA_TYPE is set to 4-StepRA, the MAC entity may perform any of first to sixth operations.

The first operation may be performed in a case that a random access procedure is initiated for the beam failure recovery. The first operation may be performed in a case that a timer for beam failure recovery (beamFailureRecovery Timer) is running or is not configured. The first operation may be performed in a case that the contention-free random access resources (CFRA resources) for the beam failure recovery request are provided by the RRC. The beam failure recovery request may be associated with any one of the SSB and the CSI-RS. The first operation may be performed in a case that at minimum one SSB or at minimum one CSI-RS is available. The at minimum one SSB may be an SSB with a Reference Signal Received Power (RSRP) above a threshold. The at minimum one CSI-RS may be a CSI-RS with an RSRP above a threshold. In the first operation, the MAC entity may select a first SSB. The first SSB may be an SSB included in a first reference signal set. The first SSB may be an SSB with an RSRP above a certain threshold. In the first operation, the MAC entity may select a first CSI-RS. The first CSI-RS may be a CSI-RS included in the first reference signal set. The first CSI-RS may be a CSI-RS with an RSRP above a certain threshold. The first reference signal set may be configured by the candidateBeamRSList. In a case that the first SSB is selected, PREAMBLE_INDEX may be set to a first random access preamble index (ra-PreambleIndex). The first random access preamble index may be ra-PreambleIndex corresponding to an SSB selected from a random access preamble set for the beam failure recovery.

The second operation may be performed in a case that a random access preamble index (ra-PreambleIndex) is provided by a PDCCH (PDCCH order). The second operation may be performed in a case that the random access preamble index is not a 0b000000. In the second operation, the MAC entity may set PREAMBLE_INDEX to the random access preamble index. In the second operation, one SSB may be indicated (signaled) by a PDCCH.

The second operation may be performed in a case that a random access preamble index (ra-PreambleIndex) is provided by a PDCCH (PDCCH order). The second operation may be performed in a case that the random access preamble index is not a 0b000000. The second operation may be performed in a case that the PDCCH provides a first value. The second operation may be performed in a case that the first value is determined by the PDCCH. In the second operation, the MAC entity may set PREAMBLE_INDEX to a second random access preamble index. The second random access preamble index may be a random access preamble index for the secondary TA acquisition. The second random access preamble index may be ra-PreambleIndex corresponding to the indicated SSB from a random access preamble set for the secondary TA acquisition. The first value may identify one RACH configuration. The first value may identify one higher layer parameter including an RACH configuration. The first index may be an additional PCI index, a TAG ID, and TRP information.

The third operation may be performed. The third action may be performed in a case that a CFRA resource associated with an SSB is provided in rach-ConfigDedicated. The third operation may be performed in a case that at minimum one SSB is available. The at minimum one SSB may be an SSB with an RSRP above a certain threshold. In the third operation, the MAC entity may select one SSB. One SSB may be with an RSRP above a certain threshold. In the third operation, the PREAMBLE_INDEX may be set to ra-PreambleIndex corresponding to the selected SSB.

The fourth operation may be performed. The fourth operation may be performed in a case that the random access procedure for the SI request is initiated. The fourth operation may be performed in a case that the random access resource for the SI request is provided by RRC. In the fourth operation, in a case that at minimum one SSB is available, the MAC entity may select one SSB. The at minimum one SSB may be with an RSRP above a certain threshold. One SSB may be with an RSRP above a certain threshold. In the fourth operation, the MAC entity may select any SSB. In the fourth operation, one random access preamble corresponding to the selected SSB may be selected from the random access preambles determined according to a higher layer parameter ra-PreambleStartIndex. In the fourth operation, PREAMBLE_INDEX may be set to the selected random access preamble.

The fifth operation may be performed. The fifth operation may be performed for CBRA preamble selection. In the fifth operation, the MAC entity may select one SSB. One SSB may be with an RSRP above a certain threshold. In the fifth operation also, the MAC entity may select any SSB.

The sixth operation may be performed. The sixth operation may be performed in a case that the random access procedure for the secondary TA acquisition is initiated. The sixth operation may be performed in a case that the random access resource for the secondary TA acquisition is provided by RRC. In the sixth operation, the MAC entity may select one SSB. One SSB may be with an RSRP above a certain threshold. In the sixth operation, any SSB may be selected. In the sixth operation, a random access preamble index (ra-PreambleIndex) corresponding to the selected SSB may be set. The random access resource for the secondary TA acquisition may be determined in one or both of the higher layer parameter twoTA-Config1-r18 and the higher layer parameter twoTA-Config2-r18.

The random access preamble may be associated with a reference signal (one of an SSB and a CSI-RS). For example, the number of random access preambles per one reference signal may be determined by a higher layer parameter.

In a case that a random access procedure is initiated for the SI request and in a case that the first higher layer parameter is configured, the MAC entity may determine a first PRACH occasion. The first PRACH occasion may be associated with the selected SSB. The first PRACH occasion may be determined based on a first restriction. The first restriction may be given by the higher layer parameter ra-ssb-OccasionMaskIndex. The first PRACH occasion may be the next valid PRACH occasion. The first higher layer parameter may be one or both of ra-AssociationPeriodIndex and si-RequestPeriod.

In any of the first to sixth operations in the case that RA_TYPE is set to 4-StepRA, in a case that an SSB is selected, the MAC entity may determine a second PRACH occasion. The selected SSB may be allowed by the first restriction. The selected SSB may be indicated by a PDCCH (PDCCH order).

In any of the first to sixth operations in the case that RA_TYPE is set to 4-StepRA, in a case that a CSI-RS is selected and in a case that there is no CFRA resource associated with the selected CSI-RS, the MAC entity may determine a third PRACH occasion based on the SSB.

In any of the first to sixth operations in the case that RA_TYPE is set to 4-StepRA, in a case that a CSI-RS is selected, the MAC entity may determine a fourth PRACH occasion corresponding to the selected CSI-RS.

In a case that random access (random access procedure) is initiated in one serving cell, the MAC entity may flush a message 3 buffer, flush a message A buffer, select a carrier for performing random access, determine a random access type, and perform a random access resource selection procedure (Random Access Resource slection procedure).

The MAC entity may randomly select one PRACH occasion of multiple PRACH occasions.

The MAC entity may perform a transmission procedure of the random access preamble.

The MAC entity may determine power based on the counter for each random access type. The MAC entity may calculate RA-RNTI associated with a PRACH occasion in which the random access preamble is transmitted. The MAC entity may indicate to the physical layer to transmit the random access preamble by using the selected PRACH occasion. The RA-RNTI associated with the PRACH occasion may be calculated based on some or all of the index of the first OFDM symbol of the PRACH occasion, the index of the first slot of the PRACH occasion in one system frame, the index of the PRACH occasion in the frequency domain, and an uplink carrier on which the random access preamble is transmitted.

The MAC entity may start a first window from the end of the random access preamble transmission. The random access preamble may be a Contention-free Random Access Preamble (CFRA random access preamble). The random access preamble may be a Contention-based Random Access Preamble (CBRA random access preamble). The MAC entity may monitor the PDCCH for a random access response. For example, while the first window is running, the MAC entity may monitor the PDCCH. The PDCCH may be a PDCCH in an SpCell. A notification of reception of the PDCCH may be received from the physical layer. The PDCCH transmission may be addressed to the C-RNTI. In a case that the CFRA random access preamble is transmitted by the MAC entity, the MAC entity may regard that the random access has been successfully completed.

Valid downlink assignment may be received on the PDCCH corresponding to the RA-RNTI. Received transport blocks may be decoded. The random access response may include a certain MAC subPDU. The certain MAC subPDU may carry a random access preamble ID. The MAC entity may regard that the random access response has been successfully received based at least on the random access response including a certain MAC subPDU.

The MAC entity may regard that the random access response has been successfully received. The MAC entity may regard that the random access has been successfully completed, may indicate reception of acknowledgements (ACKs) to higher layers, and may apply a received TA command based at least on the random access response regarded to have been successfully received. For example, the MAC entity may process the value of a received UL grant. For example, the MAC entity may indicate the received UL grant to the physical layer.

In a case that the reception of the random access response is regarded as being successful and in a case that the random access preamble is transmitted in one serving cell, the MAC entity may apply (process) the TA command for one serving cell. The MAC entity may apply the TA command for the one serving cell based at least on the random access response regarded as having been successfully received and the random access preamble being transmitted in the one serving cell. The MAC entity may apply the TA command for one TRP based at least on the random access response regarded as having been successfully received. For example, in a case that the MAC PDU includes a TA command (for example, an absolute TA command MAC CE), the MAC entity may apply (process) the TA command. For example, the MAC PDU may be included in a transport block. For example, one or multiple MAC SDUs may be multiplexed into a transport block. For example, the one or multiple MAC SDUs may be demultiplexed from a transport block.

A beam failure recovery (BFR) procedure may be configured for the MAC entity by RRC. The configuration of the BFR procedure may include an RACH configuration. The configuration of the BFR procedure may be the higher layer parameter BeamFailureRecoveryConfig. The MAC entity may trigger the BFR based on a value of BFI_COUNTER. BFI_COUNTER may be a counter for a beam failure candidate indication (Beam Failure Instance Indication). In a case that the BFR is triggered, the first random access procedure may be initiated. The first random access procedure may be a random access procedure for the beam failure recovery.

The terminal apparatus 1 may receive the higher layer parameter. The terminal apparatus 1 may initiate the random access procedure in response to reception of a higher layer parameter RRCReconfiguration. For example, in a case that the higher layer parameter RRCReconfiguration is received in a higher layer parameter nr-SCG and in a case that the higher layer parameter nr-SCG includes the higher layer parameter reconfigurationWithSync, the terminal apparatus 1 may initiate a second random access procedure in RRC. The RRCReconfiguration may be received for NR SCG RRC Reconfiguration. The second random access procedure may be a random access procedure for reconfiguration with synchronization (Reconfiguration with sync).

A secondary TA acquisition procedure may be configured for the MAC entity by RRC. A configuration of the secondary TA acquisition procedure may include an RACH configuration. The configuration of the secondary TA acquisition procedure may be one or both of TwoTA-Config1-r18 and TwoTA-Config2-r18. The MAC entity may trigger the secondary TA acquisition. For example, the MAC entity may trigger the secondary TA acquisition based on expiration of a timer associated with a subTAG. For example, up to two subTAGs may be provided in one serving cell. The secondary TA acquisition may be triggered to configure two TAs (TAGs) in one serving cell. Based on the secondary TA acquisition being triggered, a third random access procedure may be initiated. The third random access procedure may be a random access procedure for the secondary TA acquisition. The random access procedure for the secondary TA acquisition may be initiated in MAC or RRC in a case that one or both of TwoTA-Config1-r18 and TwoTA-Config2-r18 are provided.

Prior to the initiation of random access (a physical random access procedure), the physical layer may receive a set of SS/PBCH block indices from a higher layer and may provide a set of RSRP measurement to a higher layer. Before the initiation of the random access, the physical layer may indicate to a higher layer to perform type-1-random access. Before the initiation of the random access, the physical layer may indicate to a higher layer to perform type-2-random access. The type-1-random access may be random access of the 4-step-random access type. The type-2-random access may be random access of the 2-step-random access type. Before the initiation of the random access, the physical layer may receive one or multiple parameters from a higher layer. The one or multiple parameters may include a configuration of PRACH transmission parameters. The configuration of the PRACH transmission parameter may be an RACH configuration. The PRACH transmission parameter may be a PRACH preamble format for PRACH transmission, may be time resources, or may be frequency resources. The one or multiple parameters may include a parameter for determining a root sequence. The one or multiple parameters may include a parameter for determining a cyclic shift in a PRACH preamble sequence (a sequence of random access preambles). The one or multiple parameters may include TRP information. For example, one random access preamble may be associated with one TRP.

The random access may include at least transmission of the message 1 on the PRACH and the message 2. The random access may include transmission of the message 1 on the PRACH, the message 2, transmission of the PUSCH scheduled by a random access response grant (Random access response uplink grant), and the PDSCH for contention resolution. The message 1 may be a random access preamble. The message 2 may be a random access response message (random access response). For example, the message 2 may be a random access response accompanied with a PDCCH/PDSCH. The random access procedure may be referred to as random access.

The random access may include at least transmission of the message A and reception of the message B. The random access may include transmission of the message A, reception of the message B, transmission of the PUSCH scheduled by a random access response grant, and the PDSCH for contention resolution. The message A may be the random access preamble in the PRACH and the PUSCH. The message B may be a random access response. For example, the message B may be a random access response accompanied with a PDCCH/PDSCH. The random access response grant may be a fallback random access response grant.

In a case that random access is initiated by a PDCCH order, PRACH transmission (random access preamble transmission) may have the same subcarrier spacing as that of the PRACH transmission initiated by a higher layer. In a case that two uplink carriers are configured in one serving cell and in a case that the terminal apparatus 1 detects the PDCCH order, the terminal apparatus 1 may use the value of the UL/SUL indicator field from the detected PDCCH order in order to determine one uplink carrier for the PRACH transmission. In a case that N TRPs are configured in one serving cell and in a case that the terminal apparatus 1 detects the PDCCH order, the terminal apparatus 1 may use one field (or a value of the field) of the detected PDCCH order in order to determine one TRP for the PRACH transmission. In the random access procedure for the secondary TA acquisition, one field of the PDCCH order may include an additional PCI index.

Random access may be triggered by a higher layer or PDCCH order in response to a request for PRACH transmission. The configuration by the higher layer for the PRACH transmission may include some or all of the configuration for the PRACH transmission, the preamble index (index of the random access preamble), the preamble SCS (subcarrier spacing of the random access preamble), the RA-RNTI, the PRACH resource, and the TRP information.

The random access preamble may be a contention-based preamble. The random access preamble may be a contention-free preamble. The number of contention-based preambles for each valid PRACH occasion and each SS/PBCH block index may be configured by a higher layer parameter. The PRACH occasion may be valid. For example, the PRACH occasion may be valid based at least on an OFDM symbol configured for time division duplexing.

The terminal apparatus 1 may attempt to decode the DCI format 1_0 accompanied with CRC scrambled with a RA-RNTI. For example, in response to the PRACH transmission, the terminal apparatus 1 may attempt to decode the DCI format 1_0 accompanied by CRC scrambled with a RA-RNTI in a certain window. The certain window may be started based at least on the first OFDM symbol of a CORESET.

The terminal apparatus 1 may pass a transport block to the higher layer based at least on the fact that the terminal apparatus 1 detects the DCI format 1_0 accompanied by CRC scrambled with the RA-RNTI and the fact that the terminal apparatus 1 receives the transport block. For example, the transport may be received in the PDSCH within a certain window. The higher layer may analyze (parse) a transport block corresponding to a Random access preamble identity (RAPID) associated with the PRACH transmission. In a case that the higher layer identifies a RAPID in a random access response (random access response message), the higher layer may indicate an uplink grant (random access response grant) to the physical layer. The random access response may be a random access response of a transport block. The random access response grant may be a random access response uplink grant.

In a case that the terminal apparatus 1 does not detect the DCI format 1_0 accompanied by CRC scrambled with the RA-RNTI in the window or in a case that the terminal apparatus 1 does not receive the transport block in the PDSCH in the window, the higher layer may indicate the physical layer to transmit the PRACH. In addition, in a case that the higher layer does not identify the RAPID associated with the PRACH transmission, the higher layer may indicate the physical layer to transmit the PRACH. For example, the terminal apparatus 1 may be expected to transmit the PRACH at a prescribed time after the last OFDM symbol of the window. In addition, the terminal apparatus 1 may be expected to transmit the PRACH at a prescribed time after the last OFDM symbol of PDSCH reception. Transmission of the PRACH may mean transmission of a random access preamble.

The PDCCH order may trigger a Contention-free random access procedure (CFRA). For example, the PDCCH order may trigger a CFRA in one SpCell. The PDCCH order may initiate PRACH transmission. In a case that the terminal apparatus 1 attempts to detect the DCI format 1_0 accompanied by CRC scrambled with the RA-RNTI in response to the PRACH transmission initiated by the PDCCH order, it may be assumed that the PDCCH including the DCI format 1_0 and the PDCCH have the QCL characteristics in the same DMRS antenna port. The QCL properties may be large scale properties of a channel.

The random access response grant (random access response) may include one or multiple fields. For example, the one or multiple fields may include a frequency hopping flag field. For example, the one or multiple fields may include a frequency domain resource assignment field (or a PUSCH frequency resource assignment field). For example, the one or multiple fields may include a time domain resource assignment field (or a PUSCH time resource assignment field). For example, the one or multiple fields may include a Transmission power control (TPC) command field. For example, the one or multiple fields may include a CSI request field. For example, the one or multiple fields may include a field with TRP information.

In a case that a CRC of the DCI format 1_0 is scrambled by the C-RNTI and in a case that all of the frequency domain resource assignment fields are “1”, the DCI format 1_0 may be used for the first random access procedure. The first random access procedure may be referred to as a PDCCH order-initiated random access procedure. That is, the PDCCH in which the DCI format 1_0 is mapped may be in a PDCCH order.

The DCI format in the PDCCH order may include a random access preamble index field. The random access preamble index may be ra-PreambleIndex. The DCI format in the PDCCH order may include a UL/SUL indicator field. The UL/SUL indicator field may indicate a UL carrier. The DCI format in the PDCCH order may include an SS/PBCH index field. The SS/PBCH index field may indicate one SS/PBCH. One SS/PBCH may be used to determine an RACH occasion (PRACH occasion) for PRACH transmission. In a case that all of the random access preamble index values are not “0”, the SS/PBCH index field may indicate one SS/PBCH. The DCI format in the PDCCH order may include a PRACH mask index field. The PRACH mask index field may indicate one RACH occasion. One RACH occasion may be associated with one SS/PBCH. in the case that all of the random access preamble index values are not “0”, the PRACH mask index field may indicate one RACH occasion. The DCI format in the PDCCH order may include an additional PCI index field. The additional PCI index field may indicate the first higher layer parameter including an RACH configuration. The additional PCI index field may indicate one additional PCI index. One additional PCI index may be associated with the first higher layer parameter including an RACH configuration. The first higher layer parameter may be twoTA-Config1-r18. The first higher layer parameter may be twoTA-Config2-r18.

The PCI (Physical Cell ID) may be referred to as a physical cell ID. The additional PCI may be a physical cell ID for a non-serving cell. The additional PCI index may be an index for identifying the additional PCI. The additional PCI index may be configured by the higher layer parameter. The additional PCI index may be indicated by a DCI field. The additional PCI index may be used to indicate a physical cell ID.

The DCI format 1_0/1_1/1_2 may be used for scheduling the PDSCH. The bandwidth part indicator (BWP indicator) field may be included in one or both of the DCI format 1_1 and the DCI format 1_2. The number of information bits constituting the BWP indicator field may be determined based on the number of DL BWPs. A TPC command (TPC command for scheduled PUCCH) field may be included in one or both of the DCI format 1_1 and the DCI format 1_2. A second TPC command (Second TPC command for scheduledPUCCH) field may be included in one or both of the DCI format 1_1 and the DCI format 1_2. For example, in a case that a higher layer parameter SecondTPCFieldDCI is configured, the second TPC command (second TPC command for scheduled PUCCH) field may be included in the DCI format 1_1 .

The DCI format 1_0, the DCI format 1_1, and the DCI format 1_2 may be DCI formats for PDSCH scheduling. The DCI format 1_0 may be used for scheduling the PDSCH in a single downlink cell.

The antenna port field (Antenna port(s) field) may be included in the DCI format 1_1 and the DCI format 1_2. The number of information bits constituting the antenna port field may be 4, 5, or 6 bits. The number of information bits constituting the antenna port field may be 4, 5, 6, or 7 bits. The number of information bits constituting the antenna port field may be 4, 5, 6, 7, or 8 bits. The number of CDM groups without data may be any of a value 1, a value 2, and a value 3. The number of CDM groups without data of the value 1 may refer to a CDM group 0. The number of CDM groups without data of the value 2 may refer to a CDM group {0, 1}. The number of CDM groups without data of the value 3 may refer to a CDM groups {0, 1, 2}.

The higher layer parameter dmrs-Type being 1 may mean that DMRS configuration type 1 is configured. The higher layer parameter dmrs-Type being 2 may mean that the DMRS configuration type 2 is configured. The higher layer parameter maxLength being 1 may mean that the maximum number of the front-loaded DMRS symbols is 1. The higher layer parameter maxLength being 2 may mean that the maximum number of the front-loaded DMRS symbols is 2. For example, the higher layer parameter maxLength being 1 may mean that a single symbol front-loaded DMRS (front-loaded DMRS symbol) is configured. For example, the higher layer parameter maxLength being 2 may mean that a single symbol front-loaded DMRS (front-loaded DMRS symbol) or a double symbol front-loaded DMRS may be configured.

The number of DMRS ports may be the number of layers (transmission layers) of v. An antenna port {p0, . . . , pv-1} (antenna port value, antenna port number) may be a sum of a DMRS port (DMRS port value, DMRS port number) and 1000. For example, the DMRS port 0 may correspond to the antenna port p0=1000. For example, the DMRS port 1 may correspond to the antenna port p1=1001. For example, the DMRS ports {0, 1} may correspond to the antenna ports {p0=1000, p1=1001}. For example, the DMRS ports {2, 3} may correspond to the antenna ports {p2=1002, p3=1003}.

The transmission configuration indication (TCI) field may be included in one or both of the DCI format 1_1 and the DCI format 1_2. For example, in a case that the higher layer parameter is configured, the transmission configuration indication (TCI) field may be included in one or both of the DCI format 1_1 and the DCI format 1_2. For example, in a case that the higher layer parameter tci-PresentInDCI is configured, the transmission configuration indication (TCI) field may be included in one or both of DCI format 1_1 and DCI format 1_2. One or two TCI states may be indicated by the DCI format. One or multiple (e.g., two) TCI states may be indicated by the TCI field in the DCI format.

The DCI format 0_0/0_1/0_2 may be used for scheduling the PUSCH. The bandwidth part indicator (BWP indicator) field may be included in some or all of the DCI format 0_1 and the DCI format 0-2. The number of information bits constituting the BWP indicator field may be determined based on the number of UL BWPs. A TPC command (TPC command for scheduled PUSCH) field may be included in one or both of the DCI format 0_1 and the DCI format 0_2. A second TPC command (second TPC command for scheduled PUSCH) field may be included in one or both of the DCI format 0_1 and the DCI format 0_2. For example, in the case that a higher layer parameter SecondTPCFieldDCI is configured, the second TPC command (second TPC command for scheduled PUSCH) field may be included in the DCI format 1_1.

The SRS resource indicator field may be included in one or both of the DCI format 0_1 and the DCI format 0_2. The SRS resource set indicator field may be included in one or both of the DCI format 0_1 and the DCI format 0_2. In a case that the SRS resource set indicator field indicates 0 (“00”), the SRS resource indicator field and the field of the precoding information and number of layers may be associated with the first SRS resource set. In a case that the SRS resource set indicator field indicates 1 (“01”), the SRS resource indicator field and the field of the precoding information and number of layers may be associated with the second SRS resource set. In a case that the SRS resource set indicator field indicates 2 (“10”), the SRS resource indicator field and the field of the precoding information and number of layers may be associated with the first SRS resource set. In the case that the SRS resource set indicator field indicates 2(“10”), a second SRS resource indicator field and a second “field of the precoding information and number of layers” (a second precoding information field) may be associated with the second SRS resource set. In a case that the SRS resource set indicator field indicates 3 (“11”), the SRS resource indicator field and the field of the precoding information and number of layers may be associated with the first SRS resource set. In the case that the SRS resource set indicator field indicates 3 (“11”), the second SRS resource indicator field and the second “field of the precoding information and number of layers” may be associated with the second SRS resource set.

The terminal apparatus 1 transmits an uplink physical channel/signal (for example, a PUSCH, a PUCCH, an SRS), based on an uplink timing (Timing Advance (TA)). The same multiple uplink timings may belong to one TAG or one subTAG. One TAG or one subTAG may be associated with one TAG ID, and may be identified by one TAG ID. Thus, as a problem, one TAG ID needs to be indicated or determined in a case that the terminal apparatus 1 transmits the uplink physical channel/signal. As a solution to the problem, an aspect of the present invention may be used for TAG ID determination in a case that two uplink timings are provided in one serving cell.

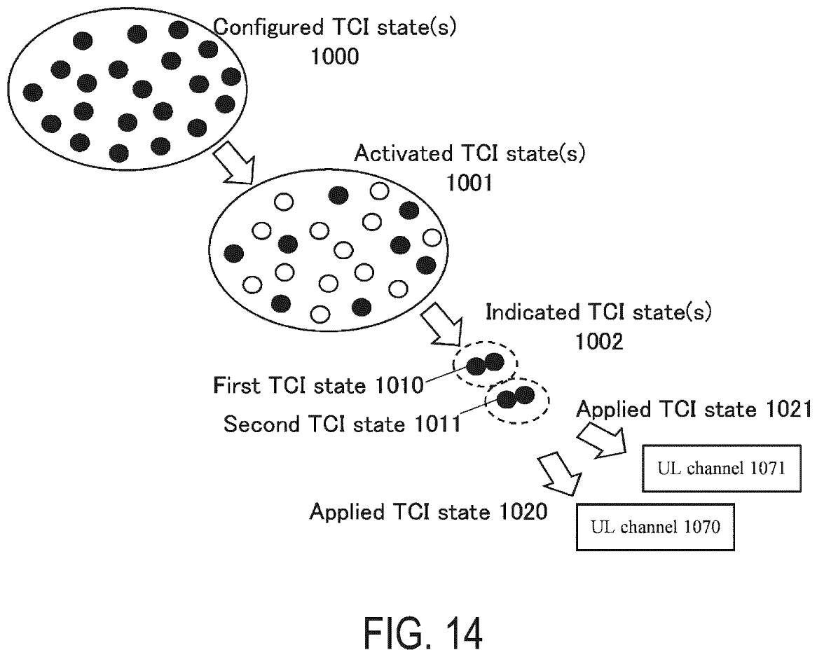

FIG. 14 is a diagram illustrating an example of management of the TCI state according to an aspect of the present embodiment. A black circle in FIG. 14 may be one TCI state.

One or multiple TCI states 1000 may be configured by the higher layer parameter. For example, one or multiple UL TCI states (UL-TCIState) may be configured by the higher layer parameter for each uplink BWP (BWP-UplinkDedicated). For example, one or multiple DL/Joint TCI states (DLorJointTCIState) may be configured by the higher layer parameter for each PDSCH configuration (PDSCH-Config). One TCI state may be associated with one TCI state ID. For example, one UL TCI state may be associated with one UL TCI state ID (TCI-UL-State-Id, UL-TCIState-Id). For example, one DL/Joint TCI state may be associated with one TCI state ID (TCI-stateId). The one or multiple TCI states configured by the higher layer parameter may be the configured TCI states 1000.

One or multiple TCI states 1001 may be activated by the MAC CE (e.g., activation command). The PDSCH may convey the first transport block. The first transport block may be one MAC PDU. One MAC PDU may include an activation command or a MAC CE referred to as an activation command. For example, the activation command may be the activation command D or the activation command E. One or both of the one or multiple TCI states and the one or multiple “pairs of TCI states” may be mapped to one or multiple codepoints. For example, one or both of the one or multiple TCI states and the “pairs of TCI states” may be mapped to one or multiple codepoints by the activation command. Each TCI state or each pair of TCI states may be mapped to one codepoint. For example, each TCI state or each pair of TCI states may be mapped to one codepoint by the activation command. The codepoint to which the TCI state or the pair of TCI states is mapped may be a codepoint in the TCI field. The codepoint to which the TCI state or the pair of TCI states is mapped may be a codepoint of the TCI field in the DCI format 1_1 or DCI format 1_2. The codepoint to which the TCI state or the pair of TCI states is mapped may be a codepoint of a TCI field in one of DCI 1040 and DCI 1041. For example, the TCI state or the pair of TCI states may be mapped to the codepoint of the TCI field in the DCI 1040 by the activation command in a CORESET pool index 1080 with which the DCI 1040 is associated. For example, the TCI state or the pair of TCI states may be mapped to the codepoint of the TCI field in the DCI 1041 by the activation command in a CORESET pool index 1081 with which the DCI 1041 is associated. The TCI state activated by the MAC CE (activation command) may be the activated TCI state 1401. The TCI state mapped to the codepoint of the TCI field may be the activated TCI state 1401.

In a case that the CORESET pool index (coresetPoolIndex) is not configured in one or multiple CORESETS (ControlResourceSet), the activation command E may be used. In a case that the CORESET pool index (coresetPoolIndex) is configured in one or multiple CORESETS (ControlResourceSet), the activation command D or the activation command E may be used. For example, in the single-DCI mode, the activation command E may be used. For example, in the multi-DCI mode, the activation command D may be used. For example, in the single-DCI mode and the multi-DCI mode, the activation command E may be used.

One or multiple TCI states 1002 may be indicated by the first DCI. The first DCI may be the DCI format 1_1 or the DCI format 1_2. The first DCI may include the TCI field (Transmission Configuration Indication field). The TCI field may indicate one or multiple (e.g., two or four) TCI states. For example, one value of the TCI field may correspond to one codepoint of the TCI field. The TCI state indicated by the first DCI format may be the indicated TCI state 1002. The indicated TCI state 1002 may be some or all of a UL TCI state, a DL TCI state, and a Joint TCI state. The UL TCI state may be a TCI state for a PUSCH, a PUCCH, and an SRS. The DL TCI state may be a TCI state for a PDSCH, a PDCCH, and a CSI-RS. The Joint TCI state may be a TCI state for a PUSCH, a PUCCH, an SRS, a PDSCH, a PDCCH, and a CSI-RS.

The number of indicated TCI states 1002 may be four. For example, the indicated TCI states 1002 may include a first pair of a first UL TCI state and a first DL TCI state, and a second pair of a second UL TCI state and a second DL TCI state. The first pair may be associated with the first TRP. The second pair may be associated with a second TRP.

The number of indicated TCI states 1002 may be three. For example, the indicated TCI states 1002 may include the first pair of the first UL TCI state and the first DL TCI state, and a third DL/UL/Joint TCI state. The first pair may be associated with the first TRP and the third DL/UL/Joint TCI state may be associated with the second TRP. The first pair may be associated with the second TRP and the third DL/UL/Joint TCI state may be associated with the first TRP.

The number of indicated TCI states 1002 may be two. For example, the indicated TCI states 1002 may include a first DL/UL/Joint TCI state and a second DL/UL/Joint TCI state. The first DL/UL/Joint may be associated with the first TRP and the second DL/UL/Joint TCI state may be associated with the second TRP.

The number of indicated TCI states 1002 may be two. For example, the indicated TCI states 1002 may include the first pair of the first DL TCI state and the first UL TCI state. The first pair may be associated with the first TRP. The first pair may be associated with the second TRP.

The number of indicated TCI states 1002 may be one. For example, the indicated TCI states 1002 may include the first DL/UL/Joint TCI state. The first DL/UL/Joint need not be associated with a TRP. The first DL/UL/Joint TCI state may be associated with the first TRP. The first DL/UL/Joint TCI state may be associated with the second TRP.

The indicated TCI state 1002 may be applied from a first slot that is N_{symb} symbols after the last OFDM symbol of a PUCCH 1060 or a PUCCH 1061. For example, the indicated TCI state 1002 may be applied from a first slot that is N_{symb} symbols after the last OFDM symbol of the PUCCH 1060 to which transmission is indicated by the DCI 1040. For example, the indicated TCI state 1002 may be applied from a first slot that is N_{symb} symbols after the last OFDM symbol of the PUCCH 1061 to which transmission is indicated by the DCI 1041. The indicated TCI state 1002 may be applied to multiple channels/signals. N_{symb} may be BeamApp Time. For example, in a case that the DCI 1040 is associated with the CORESET pool index 1080, the indicated TCI state 1002 may be a TCI state 1010. For example, in a case that the DCI 1041 is associated with the CORESET pool index 1081, the indicated TCI state 1002 may be a TCI state 1011.

A part of one or multiple TCI states 1002 may be applied to an uplink channel (uplink physical channel) 1070. The “indicated TCI state 1002” applied to the uplink channel 1070 may be one or both of one or multiple UL TCI states and one or multiple Joint TCI states. The “indicated TCI state” 1002 applied to the uplink channel 1070 may be an “applied TCI state” 1020. The TCI state 1020 may be an “applied TCI state” for the uplink channel 1070.

A part of one or multiple TCI states 1002 may be applied to an uplink channel (uplink physical channel) 1071. The “indicated TCI state 1002” applied to the uplink channel 1071 may be one or both of one or multiple UL TCI states and one or multiple Joint TCI states. The “indicated TCI state” 1002 applied to the uplink channel 1071 may be an “applied TCI state” 1021. The TCI state 1021 may be an “applied TCI state” for the uplink channel 1071.

The indicated TCI state 1002 may include at least the TCI state 1010 and the TCI state 1011. One or both of the TCI state 1010 and the TCI state 1011 may be applied to the uplink channel 1070. One or both of the TCI state 1010 and the TCI state 1011 may be applied to the uplink channel 1071. One or both of the TCI state 1010 and the TCI state 1011 applied to the uplink channel 1070 may be the TCI state 1020. One or both of the TCI state 1010 and the TCI state 1011 applied to the uplink channel 1071 may be the TCI state 1021.

In a case that DCI 1042 for scheduling transmission of the uplink channel 1070 is associated with the CORESET pool index 1080, or a PDCCH 1032 to which the DCI 1042 for scheduling transmission of the uplink channel 1070 is mapped is associated with the CORESET pool index 1080, the TCI state 1010 may be applied to the uplink channel 1070. For example, the TCI state 1010 may be applied to the uplink channel 1070 as the “applied TCI state” 1020. In a case that DCI 1043 for scheduling transmission of the uplink channel 1071 is associated with the CORESET pool index 1081, or a PDCCH 1033 to which the DCI 1043 for scheduling transmission of the uplink channel 1071 is mapped is associated with the CORESET pool index 1081, the TCI state 1011 may be applied to the uplink channel 1071. For example, the TCI state 1011 may be applied to the uplink channel 1071 as the “applied TCI state” 1021. In a case that the DCI 1042 for scheduling transmission of the uplink channel 1070 is associated with the CORESET pool index 1081, or the PDCCH 1032 to which the DCI 1042 for scheduling transmission of the uplink channel 1070 is mapped is associated with the CORESET pool index 1081, the TCI state 1011 may be applied to the uplink channel 1070. For example, the TCI state 1011 may be applied to the uplink channel 1070 as the “applied TCI state” 1020. In a case that the DCI 1043 for scheduling transmission of the uplink channel 1071 is associated with the CORESET pool index 1080, or the PDCCH 1033 to which the DCI 1043 for scheduling transmission of the uplink channel 1071 is mapped is associated with the CORESET pool index 1080, the TCI state 1010 may be applied to the uplink channel 1071. For example, the TCI state 1010 may be applied to the uplink channel 1071 as the “applied TCI state” 1021.

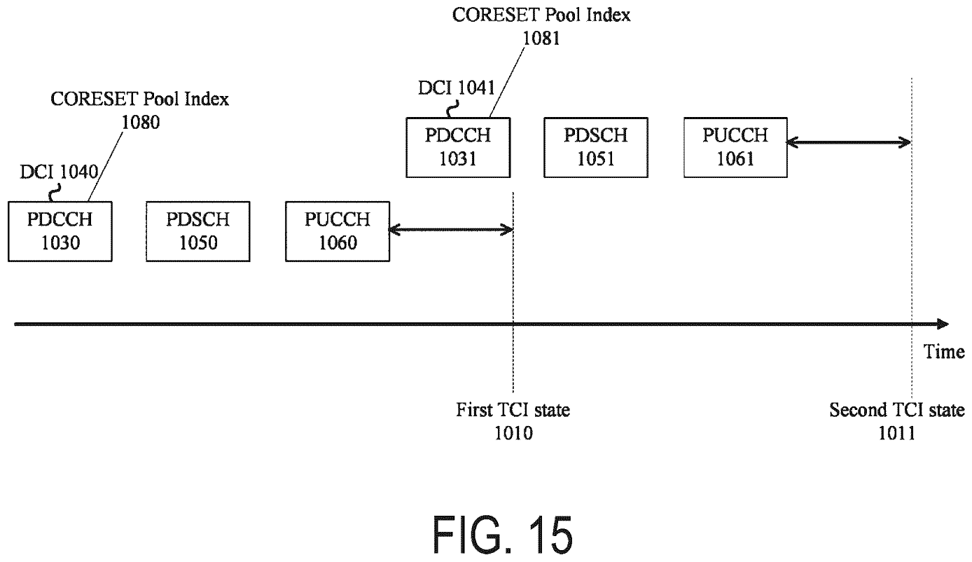

FIG. 15 is a diagram illustrating an example of a timeline management for the TCI state according to an aspect of the present embodiment. The terminal apparatus 1 may receive a PDCCH 1030. The terminal apparatus 1 may receive the PDCCH 1030 to which the DCI 1040 is mapped. The PDCCH 1030 may be received in the first CORESET. The first CORESET may correspond to the CORESET pool index 1080. In other words, the PDCCH 1030 and the DCI 1040 may be associated with the CORESET pool index 1080. The DCI 1040 in the PDCCH 1030 may include one or both of a first TCI field and the TRP indicator field. The first TCI field or the activation command for the first TCI field may correspond to the CORESET pool index 1080. The DCI 1040 may schedule a PDSCH 1050 or reception of the PDSCH 1050. The DCI 1040 may indicate reception of the PDSCH 1050. The DCI 1040 may indicate transmission of the PDSCH 1050.

The terminal apparatus 1 may receive the PDSCH 1050. For example, the terminal apparatus 1 may receive the PDSCH 1050 scheduled by the DCI 1040. The transport block conveyed by the PDSCH 1050 may include a first activation command. The first activation command may correspond to the CORESET pool index 1080.

The terminal apparatus 1 may transmit the PUCCH 1060. For example, the terminal apparatus 1 may transmit the PUCCH 1060 scheduled by the DCI 1040. The PUCCH 1060 may convey a HARQ-ACK. UCI in the PUCCH 1060 may include HARQ-ACK information. The PUCCH 1060 may correspond to the CORESET pool index 1080. The TCI state 1010 may be applied from N_{symb} after the last OFDM symbol of the PUCCH 1060. The TCI state 1010 may be one of the indicated TCI states 1002.

The terminal apparatus 1 may receive a PDCCH 1031. The terminal apparatus 1 may receive the PDCCH 1031 to which the DCI 1041 is mapped. The PDCCH 1031 may be received in a second CORESET. The second CORESET may correspond to the CORESET pool index 1081. In other words, the PDCCH 1031 and the DCI 1041 may be associated with the CORESET pool index 1081. The DCI 1041 in the PDCCH 1031 may include one or both of a second TCI field and the TRP indicator field. The second TCI field or the activation command for the second TCI field may correspond to the CORESET pool index 1081. The DCI 1041 may schedule a PDSCH 1051 or reception of the PDSCH 1051. The DCI 1041 may indicate reception of the PDSCH 1051. The DCI 1041 may indicate transmission of the PDSCH 1051.

The terminal apparatus 1 may receive the PDSCH 1051. For example, the terminal apparatus 1 may receive the PDSCH 1051 scheduled by the DCI 1041. The transport block conveyed by the PDSCH 1051 may include a second activation command. The second activation command may correspond to the CORESET pool index 1081.

The terminal apparatus 1 may transmit the PUCCH 1061. For example, the terminal apparatus 1 may transmit the PUCCH 1061 scheduled by the DCI 1041. The PUCCH 1061 may convey a HARQ-ACK. UCI in the PUCCH 1061 may include HARQ-ACK information. The PUCCH 1061 may correspond to the CORESET pool index 1081. The TCI state 1011 may be applied from N_{symb} after the last OFDM symbol of the PUCCH 1061. The TCI state 1011 may be one of the indicated TCI states 1002.

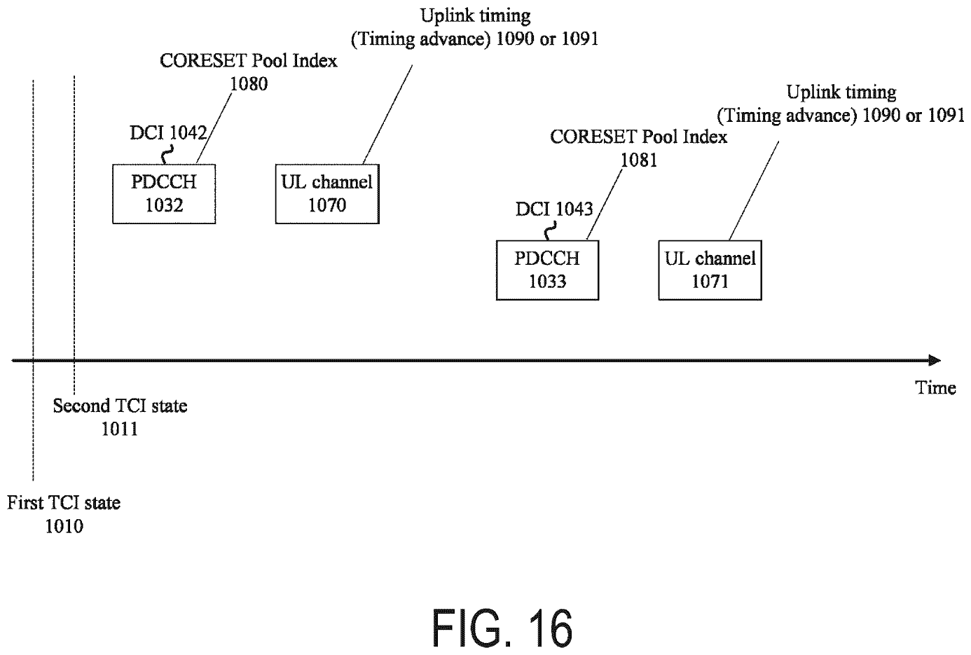

FIG. 16 is a diagram illustrating an example of uplink channel transmission according to an aspect of the present embodiment. The terminal apparatus 1 may receive the PDCCH 1032. For example, the terminal apparatus 1 may receive the PDCCH 1032 to which the DCI 1042 is mapped. The PDCCH 1032 and the DCI 1042 may be associated with the CORESET pool index 1080. For example, the PDCCH 1032 may be received in the CORESET configured with the CORESET pool index 1080.

The terminal apparatus 1 may transmit the uplink channel 1070. The uplink channel may be one of a PUSCH, a PUCCH, and an SRS. In a case that the uplink channel 1070 is a PUSCH, the applied TCI state 1020 may be determined based on a CORESET pool index (in other words, the CORESET pool index 1080) corresponding to the DCI 1042. For example, in a case that the PDCCH 1032 is received in the CORESET configured with the CORESET pool index 1080, the TCI state 1020 applied to the uplink channel 1070 may be the TCI state 1010. Unlike FIG. 16, in a case that the PDCCH 1032 is received in the CORESET configured with the CORESET pool index 1081, the TCI state 1020 applied to the uplink channel 1070 may be the TCI state 1011.

In a case that the uplink channel 1070 is a PUCCH, the applied TCI state 1020 may be determined based on a higher layer parameter (for example, a CORESET pool index) included in PUCCH resources. For example, in a case that the CORESET pool index 1080 is configured for PUCCH resources indicated by the DCI 1042, the TCI state 1020 applied to the uplink channel 1070 may be the TCI state 1010. Unlike FIG. 16, in a case that the CORESET pool index 1081 is configured for PUCCH resources indicated by the DCI 1042, the TCI state 1020 applied to the uplink channel 1070 may be the TCI state 1011.

In a case that the uplink channel 1070 is an SRS, the applied TCI state 1020 may be determined based on a higher layer parameter (for example, a CORESET pool index) included in SRS resources or an SRS resource set. For example, in a case that the PDCCH 1032 is received in the CORESET configured with the CORESET pool index 1080, the TCI state 1020 applied to the uplink channel 1070 may be the TCI state 1010. For example, in a case that the CORESET pool index 1080 is configured for SRS resources indicated by the DCI 1042, the TCI state 1020 applied to the uplink channel 1070 may be the TCI state 1010. Unlike FIG. 16, in a case that the PDCCH 1032 is received in the CORESET configured with the CORESET pool index 1081, the TCI state 1020 applied to the uplink channel 1070 may be the TCI state 1011. Unlike FIG. 16, in a case that the CORESET pool index 1081 is configured for SRS resources indicated by the DCI 1042, the TCI state 1020 applied to the uplink channel 1070 may be the TCI state 1011.

The terminal apparatus 1 may receive the PDCCH 1033. For example, the terminal apparatus 1 may receive the PDCCH 1033 to which the DCI 1043 is mapped. The PDCCH 1033 and the DCI 1043 may be associated with the CORESET pool index 1081. For example, the PDCCH 1033 may be received in the CORESET configured with the CORESET pool index 1081.

The terminal apparatus 1 may transmit the uplink channel 1071. The uplink channel may be one of a PUSCH, a PUCCH, and an SRS. In a case that the uplink channel 1071 is a PUSCH, the applied TCI state 1021 may be determined based on a CORESET pool index (in other words, the CORESET pool index 1081) corresponding to the DCI 1043. For example, in a case that the PDCCH 1033 is received in the CORESET configured with the CORESET pool index 1081, the TCI state 1021 applied to the uplink channel 1071 may be the TCI state 1011. Unlike FIG. 16, in a case that the PDCCH 1033 is received in the CORESET configured with the CORESET pool index 1080, the TCI state 1021 applied to the uplink channel 1071 may be the TCI state 1010.

In a case that the uplink channel 1071 is a PUCCH, the applied TCI state 1021 may be determined based on a higher layer parameter (for example, a CORESET pool index) included in PUCCH resources. For example, in a case that the CORESET pool index 1081 is configured for PUCCH resources indicated by the DCI 1043, the TCI state 1021 applied to the uplink channel 1071 may be the TCI state 1011. Unlike FIG. 16, in a case that the CORESET pool index 1080 is configured for PUCCH resources indicated by the DCI 1043, the TCI state 1021 applied to the uplink channel 1071 may be the TCI state 1010.

In a case that the uplink channel 1071 is an SRS, the applied TCI state 1021 may be determined based on a higher layer parameter (for example, a CORESET pool index) included in SRS resources or an SRS resource set. For example, in a case that the PDCCH 1033 is received in the CORESET configured with the CORESET pool index 1081, the TCI state 1021 applied to the uplink channel 1071 may be the TCI state 1011. For example, in a case that the CORESET pool index 1081 is configured for SRS resources indicated by the DCI 1043, the TCI state 1021 applied to the uplink channel 1071 may be the TCI state 1011. Unlike FIG. 16, in a case that the PDCCH 1033 is received in the CORESET configured with the CORESET pool index 1080, the TCI state 1021 applied to the uplink channel 1071 may be the TCI state 1010. Unlike FIG. 16, in a case that the CORESET pool index 1080 is configured for SRS resources indicated by the DCI 1043, the TCI state 1021 applied to the uplink channel 1071 may be the TCI state 1010.

The terminal apparatus 1 may adjust an uplink timing 1090 (TA 1090) for one or both of the uplink channel 1070 and the uplink channel 1071. For example, the terminal apparatus 1 may adjust the uplink timing 1090 in response to receiving a TA command 1200 for a TAG 1100. The TA command 1200 may be received by a random access response or a MAC CE. The TAG 1100 may correspond to a TAG ID 1300. In other words, the TAG ID 1300 may be an identifier of the TAG 1100. The TAG ID 1300 may be a subTAG ID. The terminal apparatus 1 may adjust an uplink timing 1091 (TA 1091) for one or both of the uplink channel 1070 and the uplink channel 1071. For example, the terminal apparatus 1 may adjust the uplink timing 1091 in response to receiving a TA command 1201 for a TAG 1101. The TA command 1201 may be received by a random access response or a MAC CE. The TAG 1101 may correspond to a TAG ID 1301. In other words, the TAG ID 1301 may be an identifier of the TAG 1101. The TAG ID 1301 may be a subTAG ID. For example, the TAG 1100 and the TAG 1101 may be provided in one serving cell. For example, the TAG ID 1300 and the TAG ID 1301 may be configured in one serving cell. For example, the uplink timing 1090 and the uplink timing 1091 may be used in one serving cell.

One of the uplink timing 1090 and the uplink timing 1091 may be applied to the uplink channel 1070. One of the TAG 1100 and the TAG 1101 may correspond to the uplink channel 1070. One of the uplink timing 1090 and the uplink timing 1091 may be applied to the uplink channel 1071. One of the TAG 1100 and the TAG 1101 may correspond to the uplink channel 1071.

A means 1, a means 2, and a means 3 may be used to determine the uplink timing, the TAG, or the TAG ID applied to the uplink channel. These means may be used properly, depending on whether the terminal apparatus 1 has terminal capability 1400. These means may be used properly, depending on whether a higher layer parameter 1500 or a higher layer parameter 1600 is configured for the terminal apparatus 1.

Which of the TAG 1100 and the TAG 1101 is applied to the uplink channel 1070 in the means 1, the means 2, and the means 3 may be determined based at least on the TCI field in one or both of the DCI 1040 and the DCI 1041.

In the means 1, one of the TAG ID 1300 and the TAG ID 1301 may be configured for each of one or multiple “configured TCI states” 1000. One of the TAG ID 1300 and the TAG ID 1301 may be configured for one TCI state. For example, one of the TAG ID 1100 and the TAG ID 1101 may be configured in the higher layer parameter UL-TCIState or DLorJoint-TCIState. Note that neither the TAG ID 1100 nor the TAG ID 1101 may be configured in the higher layer parameter TCI-State.

In the means 1, one of the TAG ID 1300 and the TAG ID 1301 may be configured for the TCI state 1020 applied to the uplink channel 1070. In a case that the TAG ID 1300 is configured for the TCI state 1020, the uplink timing 1090 and the TAG 1100 may be applied to the uplink channel 1070. In a case that the TAG ID 1301 is configured for the TCI state 1020, the uplink timing 1091 and the TAG 1101 may be applied to the uplink channel 1070.

In the means 1, in a case that the terminal apparatus 1 has the terminal capability 1400, or the terminal apparatus 1 reports the terminal capability 1400, the means 1 may be used. In a case that the terminal apparatus 1 does not have or report the terminal capability 1400, the TAG ID need not be expected to be configured for the TCI state. In a case that the terminal apparatus 1 does not have or report the terminal capability 1400, the TAG ID configured for the TCI state may be ignored.

In the means 1, in a case that the higher layer parameter 1500 is configured, or the higher layer parameter 1600 is not configured, the means 1 may be used. In a case that the higher layer parameter 1600 is configured, the TAG ID need not be expected to be configured for the TCI state. In a case that the higher layer parameter 1600 is configured, the TAG ID configured for the TCI state may be ignored.

In the means 2, one of the TAG ID 1300 and the TAG ID 1301 may be configured for one activation command. For example, the TAG ID 1300 and the TAG ID 1301 may be determined by one CORESET pool index included in one activation command. The TAG ID and the CORESET pool index may correspond on a one-to-one basis. For example, the CORESET pool index 1080 may correspond to the uplink timing 1090, the TAG 1100, and the TAG ID 1300. The CORESET pool index 1081 may correspond to the uplink timing 1091, the TAG 1101, and the TAG ID 1301.

In the means 2, in a case that the PDCCH 1032 is associated with the CORESET pool index 1080, a part or all of the uplink timing 1090, the TAG 1100, and the TAG ID 1300 may be applied to the uplink channel 1070. In the means 2, in a case that the PDCCH 1033 is associated with the CORESET pool index 1081, a part or all of the uplink timing 1091, the TAG 1101, and the TAG ID 1301 may be applied to the uplink channel 1071.

In the means 2, in a case that the terminal apparatus 1 does not have the terminal capability 1400, or the terminal apparatus 1 does not report the terminal capability 1400, the means 2 may be used. In a case that the terminal apparatus 1 has or reports the terminal capability 1400, one CORESET pool index may be associated with two TAG IDs. For example, the TCI state(s) (for example, one or multiple activated TCI states 1001) corresponding to the CORESET pool index 1080 may be associated with a part or all of two TAG IDs, two TAGs, and two uplink timings.

In the means 2, in a case that the higher layer parameter 1500 is not configured, or the higher layer parameter 1600 is configured, the means 2 may be used. In a case that the higher layer parameter 1500 is configured, or the higher layer parameter 1600 is not configured, one CORESET pool index may be associated with two TAG IDs. For example, the TCI state(s) (for example, one or multiple activated TCI states 1001) corresponding to the CORESET pool index 1080 may be associated with a part or all of two TAG IDs, two TAGs, and two uplink timings.

In the means 3, the TAG ID 1300 may correspond to SSB group 1, and the TAG ID 1301 may correspond to SSB group 2. For example, in a case that the TCI state 1020 corresponds to SSB group 1, the uplink channel 1070 to which the TCI state 1020 is applied may correspond to a part or all of the uplink timing 1090, the TAG 1100, and the TAG ID 1300. For example, in a case that the TCI state 1021 corresponds to SSB group 2, the uplink channel 1071 to which the TCI state 1021 is applied may correspond to a part or all of the uplink timing 1091, the TAG 1101, and the TAG ID 1301. The TCI state corresponding to one SSB group may mean a reference signal associated with the QCL relationship provided by the TCI state being associated with one SSB group. The TCI state corresponding to one SSB group may mean one SSB group (or an ID for identifying one SSB group) being configured for a higher layer parameter qcl-info configured for the TCI state. The SSB group may be configured by a higher layer parameter. For example, the SSB group may be configured by a dedicated higher layer parameter for one serving. Thus, based on the higher layer parameter, both of the TAG ID 1300 and the TAG ID 1301 corresponding to one SSB group and one of the TAG ID 1300 and the TAG ID 1301 corresponding to one SSB group may be determined. For example, one SSB group may include 32 SS/PBCH blocks.

In the means 3, in a case that the terminal apparatus 1 does not have or report the terminal capability 1400, the TCI state 1010 may correspond to SSB group 1, and the TCI state 1011 may correspond to SSB group 2. In a case that the terminal apparatus 1 has or reports the terminal capability 1400, both of the TCI state 1010 and the TCI state 1011 may correspond to SSB group 1 or SSB group 2.

In the means 3, in a case that the higher layer parameter 1500 is not configured, or the higher layer parameter 1600 is configured, the TCI state 1010 may correspond to SSB group 1, and the TCI state 1011 may correspond to SSB group 2. In a case that the higher layer parameter 1500 is configured, or the higher layer parameter is not configured, both of the TCI state 1010 and the TCI state 1011 may correspond to SSB group 1 or SSB group 2.

The terminal capability 1400 may be a capability for performing Dynamic Point Selection. The terminal capability 1400 may be a capability for performing TRP switching in a CORESET corresponding to one CORESET pool index. The terminal capability 1400 may be a capability for performing TRP switching in one CORESET. The terminal capability 1400 may be a capability for associating one piece of beam information and one uplink timing with each other, independently of the CORESET or the CORESET pool index.

The higher layer parameter 1500 may be configured in a case that the terminal capability 1400 is reported. The higher layer parameter 1500 may determine application of dynamic point selection. The higher layer parameter 1600 may be a parameter for determining whether the PUSCH-MTRP scheme is applied. For example, the higher layer parameter 1500 may determine whether the STxMP scheme is applied. The higher layer parameter 1500 may apply cyclicMapping to the PUSCH. The higher layer parameter 1500 may apply sequentialMapping to the PUSCH. The higher layer parameter 1500 and the higher layer parameter 1600 need not be expected to be configured.

The terminal apparatus 1 may receive a first PDCCH. The first DCI (DCI format) may be mapped to the first PDCCH. The terminal apparatus 2 may receive a second PDCCH. The second DCI (DCI format) may be mapped to the second PDCCH. The terminal apparatus 1 may receive the PDSCH. The first DCI may schedule the PDSCH or reception of the PDSCH. The first DCI may indicate reception of the PDSCH. The terminal apparatus 1 may transmit the uplink channel (uplink physical channel). The second DCI may schedule the uplink channel or transmission of the uplink channel. The second DCI may indicate transmission of the uplink channel. The terminal apparatus 1 may receive in order of the first PDCCH, the second PDCCH, and the PDSCH.

The uplink channel may be one of a PUSCH, a PUCCH, and an SRS.

The first CORESET pool index may be the first value. The second CORESET pool index may be the first value. In other words, the first CORESET pool index and the second CORESET pool index may be the same. The first CORESET pool index may be associated with a part or all of the first PDCCH, the first DCI, and the TCI field in the first DCI. The second CORESET pool index may be associated with one or both of the second PDCCH and the second DCI.

First beam information may be indicated by the first DCI. For example, the first beam information may be indicated by the TCI field in the first DCI. The first beam information may be the TCI state. For example, the first beam information may be the indicated TCI state. The first beam information may be applied to the uplink channel. The first beam information may be used to determine the uplink transmission spatial filter of the uplink channel.

The first uplink timing (first TA) may be used for the uplink channel. For example, the first uplink timing may be adjusted for the uplink channel. The first uplink timing may correspond to a first TAG. The first TAG may correspond to the first TAG ID. The first TAG ID may be determined based on the TCI field. For example, the first TAG ID may be determined or indicated based on the TCI field in the first DCI.

The second uplink timing (second TA) may correspond to a second TAG. The second TAG may correspond to the second TAG ID. The second TAG ID need not be indicated based on the TCI field in the first DCI. The first uplink timing and the second uplink timing may be provided in one serving cell. The terminal apparatus 1 may maintain both of the first TAG and the second TAG in one serving cell.

The codepoint of the TCI field may be associated with one or both of the first TAG ID and the second TAG ID. For example, multiple pieces of second beam information in the codepoint of the TCI field may be associated with one or both of the first TAG ID and the second TAG ID. The second beam information may be the TCI state. For example, the second beam information may be the activated TCI state. In other words, the first beam information may be determined from multiple pieces of second beam information.

In a case that the terminal capability is reported, as the means 1 or the means 3, each codepoint of the TCI field may be associated with one of the first TAG ID and the second TAG ID. In a case that the terminal capability is not reported, as the means 2, each codepoint of the TCI field may be associated with the first TAG ID. The terminal capability not being reported may mean the terminal apparatus 1 not having the terminal capability. The terminal capability may be the terminal capability 1400. The terminal capability may be a capability in which both of the first uplink timing and the second uplink timing are used in one or multiple CORESETs corresponding to one CORESET pool index. In a case that the first higher layer parameter is configured, or the second higher layer parameter is not configured, as the means 1 or the means 3, each codepoint of the TCI field may be associated with one of the first TAG ID and the second TAG ID. In a case that the first higher layer parameter is not configured, or the second higher layer parameter is configured, as the means 2, each codepoint of the TCI field may be associated with the first TAG ID. The first higher layer parameter may be the higher layer parameter 1500. The second higher layer parameter may be the higher layer parameter 1600.

The first TAG ID may be determined based on the first CORESET pool index with which the TCI field is associated. For example, in a case that the terminal capability is not reported, the first TAG ID may be determined based on the first CORESET pool index with which the TCI field is associated. For example, the first CORESET pool index may correspond to the first TAG ID. For example, the second CORESET pool index may correspond to the second TAG ID.

Various aspects of apparatuses according to an aspect of the present embodiment will be described below.

Each program running on the base station apparatus 3 and the terminal apparatus 1 according to an aspect of the present invention may be a program that controls a central processing unit (CPU) and the like (a program causing a computer to function) to realize the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read and perform the program recorded on the recording medium.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. A configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception unit
10a, 30a Radio transmission unit
10b, 30b Radio reception unit
11, 31 Antenna unit
12, 32 RF unit
13, 33 Baseband unit
14, 34 Higher layer processing unit
15, 35 Medium access control layer processing unit
16, 36 Radio resource control layer processing unit
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
1000 Configured TCI state
1001 Activated TCI state
1002, 1010, 1011 Indicated TCI state
1020, 1021 Applied TCI state
1030, 1031, 1032, 1033 PDCCH
1040, 1041, 1042, 1043 DCI
1050, 1051 PDSCH
1060, 1061 PUCCH
1070, 1071 Uplink channel
1080, 1081 CORESET pool index
1090, 1091 Uplink timing
1100, 1101 TAG
1200, 1201 TA command
1300, 1301 TAG ID
1400 Terminal capability
1500, 1600 Higher layer parameter

1. A terminal apparatus comprising:
a receiver configured to receive a first physical downlink control channel (PDCCH) to which first downlink control information (DCI) is mapped, a second PDCCH to which second DCI is mapped, and a physical downlink shared channel (PDSCH) scheduled by the first DCI; and
a transmitter configured to transmit an uplink channel scheduled by the second DCI, wherein:
a transmission configuration indicator (TCI) state is indicated by a TCI field in the first DCI,
the TCI state is used to determine an uplink transmission spatial filter for the uplink channel,
in a case that the first PDCCH and the second PDCCH correspond to a CORESET pool index and a the first TAG ID is configured for the TCI state, a first uplink timing is applied to the uplink channel, and
in a case that the first PDCCH and the second PDCCH correspond to the CORESET pool index and a second TAG ID is configured for the TCI state, a second uplink timing is applied to the uplink channel.

2. A base station apparatus comprising:
a transmitter configured to transmit a first physical downlink control channel (PDCCH ) to which first downlink control information (DCI) is mapped, a second PDCCH to which second DCI is mapped, and a physical downlink shared channel (PDSCH) scheduled by the first DCI; and
a receiver configured to receive an uplink channel scheduled by the second DCI, wherein:
a transmission configuration indicator (TCI) state is indicated by a TCI field in the first DCI,
the TCI state is used to determine an uplink transmission spatial filter for the uplink channel,
in a case that the first PDCCH and the second PDCCH correspond a CORESET pool index and a first TAG ID is configured for the TCI state, a first uplink timing is applied to the uplink channel, and
in a case that the first PDCCH and the second PDCCH correspond to the CORESET pool index and a second TAG ID is configured for the TCI state, a second uplink timing is applied to the uplink channel.
